(19) United States
(12) Patent Application Publication
(10) Pub. No.: US 2025/0218383 A1
(43) Pub. Date: Jul. 3, 2025

(54) DISPLAY PANEL AND DISPLAY DEVICE INCLUDING THE SAME

(71) Applicant: LG Display Co., Ltd., Seoul (KR)

(72) Inventors: Yong Woo YUN, Paju-si (KR); Ki Tae KWON, Paju-si (KR); Dae Ho PARK, Paju-si (KR)

(73) Assignee: LG Display Co., Ltd., Seoul (KR)

(21) Appl. No.: 18/953,843

(22) Filed: Nov. 20, 2024

(30) Foreign Application Priority Data
Dec. 28, 2023 (KR) 10-2023-0193983

(51) Int. Cl. G09G 3/3258; G09G 3/00; G09G 3/3266

(52) U.S. Cl. CPC G09G 3/3258; G09G 3/035; G09G 3/3266; G09G 2300/0814; G09G 2300/0819; G09G 2300/0861; G09G 2310/0286; G09G 2310/0289; G09G 2310/061; G09G 2320/0233; G09G 2340/0435

(57) ABSTRACT

A display panel and a display device including the same are discussed. The display panel includes a mode selection circuit configured to output an emission signal to a first node in response to a first mode selection signal and output the emission signal to a second node in response to a second mode selection signal, and a pixel circuit configured to drive a first light-emitting element in response to a voltage of the first node in a first mode and drive a second light-emitting element in response to a voltage of the second node in a second mode.

### CROSS-REFERENCE TO RELATED APPLICATION

This application claims priority to Korean Patent Application No. 10-2023-0193983, filed in the Republic of Korea on Dec. 28, 2023, the entire contents of which is hereby expressly incorporated by reference into the present application.

### BACKGROUND

### Field

The present disclosure relates to a display panel having a variable viewing angle on a pixel basis, and to a display device including the same.

### Discussion of the Related Art

A variable viewing angle technology can be applied to the display device. The variable viewing angle technology can display video content or visual information reproduced on the display device only to users within a narrow viewing angle range or to multiple users existing within a wide viewing angle range.

As the market for future vehicles such as electric vehicles and autonomous vehicles expands, the demand for vehicle display devices is rapidly increasing. Research is being conducted on a method of dividing the screen of a vehicle display device and controlling a part of the screen with a narrow viewing angle and another part with a wide viewing angle. This technology can display personal content or information that can only be viewed by a specific user by driving pixels having the narrow viewing angle arranged in a partial area of the screen, and at the same time, by driving pixels having the wide viewing angle arranged in another area of the screen, shared content that multiple users can see together can be displayed.

A display panel of an organic light-emitting display device is attracting attention in a vehicle display device. The organic light-emitting display device includes an organic light-emitting diode (hereinafter, referred to as “OLED”) that emits light by itself, and has advantages of fast response speed and high luminous efficiency, high luminance, and wide viewing angle. The organic light-emitting display device has a fast response speed and excellent luminous efficiency, luminance, viewing angle, and the like, and excellent contrast ratio and color reproduction rate because black gray scales can be expressed in complete black. Since the display panel of the organic light-emitting display device can be flexibly bent, a curved surface can be easily implemented. Due to these advantages, the market share of the organic light-emitting display device in a vehicle display device market is rapidly increasing.

In order to implement a variable viewing angle technology, wires, circuit elements, optical elements, or the like can be added to transmit signals for selecting a viewing angle for pixels in a display panel. Adding a lot of wires and circuit elements to the display panel not only makes the design of the display panel more difficult, but also increases the cost of a display device.

### SUMMARY OF THE DISCLOSURE

The present disclosure has been made in an effort to address aforementioned necessities and/or drawbacks and other limitations associated with the related art.

The present disclosure provides a display panel capable of changing the viewing angle of pixels and having a simplified circuit configuration of the pixel circuit, and a display device including the same.

The problems or limitations to be solved or addressed by the present disclosure are not limited to those mentioned above, and other problems or limitations not mentioned will be clearly understood by those skilled in the art from the following description.

A display panel according to an embodiment of the present disclosure includes: a mode selection circuit configured to output an emission signal to a first node in response to a first mode selection signal and output the emission signal to a second node in response to a second mode selection signal; and a pixel circuit configured to drive a first light-emitting element in response to a voltage of the first node in a first mode and drive a second light-emitting element in response to a voltage of the second node in a second mode.

The pixel circuit can include a driving element including a first electrode to which a pixel driving voltage is applied, a gate electrode to which a data voltage of pixel data is applied, and a second electrode connected to a third node; a first switch element including a first electrode connected to the third node, a gate electrode electrically connected to the first node, and a second electrode electrically connected to an anode electrode of the first light-emitting element; and a second switch element including a first electrode connected to the third node, a gate electrode electrically connected to the second node, and a second electrode connected to an anode electrode of the second light-emitting element.

The emission signal can swing between a gate-on voltage and a gate-off voltage. Each of the first switch element and the second switch element can be turned on in response to the gate-on voltage and turned off in response to the gate-off voltage. The mode selection circuit can include a first mode switch element including a first electrode to which the emission signal is applied, a gate electrode to which the first mode selection signal is applied, and a second electrode electrically connected to the first node; a second mode switch element including a first electrode to which a separate gate-off voltage is applied, a gate electrode to which the second mode selection signal is applied, and a second electrode electrically connected to the first node; a third mode switch element including a first electrode to which the emission signal is applied, a gate electrode to which the second mode selection signal is applied, and a second electrode electrically connected to the second node; and a fourth mode switch element including a first electrode to which the separate gate-off voltage is applied, a gate electrode to which the first mode selection signal is applied, and a second electrode electrically connected to the second node.

The pixel circuit can further include a capacitor connected between a fourth node and a fifth node; a third switch element including a first electrode to which the data voltage is applied, a gate electrode to which a first scan signal is applied, and a second electrode electrically connected to the fifth node; a fourth switch element including a first electrode electrically connected to the third node, a gate electrode to which a second scan signal is applied, and a second electrode connected to the fourth node; a fifth switch element including a first electrode electrically connected to a sixth node to which a reference voltage is applied, a gate electrode to which the second scan signal is applied, and a second electrode connected to a seventh node; a sixth switch element including a first electrode connected to the sixth node, a gate electrode to which the second scan signal is applied, and a second electrode electrically connected to an eighth node; and a seventh switch element including a first electrode connected to the fifth node, a gate electrode to which the emission signal is applied, and a second electrode connected to the sixth node. A gate electrode of the driving element can be electrically connected to the fourth node. The first light-emitting element can include an anode electrode connected to the seventh node and a cathode electrode to which a cathode voltage is applied. The second light-emitting element can include an anode electrode connected to the eighth node and a cathode electrode to which the cathode voltage is applied.

The emission signal can swing between a gate-on voltage and a gate-off voltage. Each of the first switch element, the second switch element, the third switch element, the fourth switch element, the fifth switch element, the sixth switch element, and the seventh switch element can be turned on in response to the gate-on voltage and turned off in response to the gate-off voltage. A voltage of the first scan signal in each of the first mode and the second mode can be the gate-off voltage during a first period, the gate-on voltage during a second period after the first period, and the gate-off voltage during a third period after the second period. A voltage of the second scan signal in each of the first mode and the second mode can be the gate-on voltage during the first period and the second period, and the gate-off voltage during the third period. A voltage of the emission signal in each of the first mode and the second mode can be the gate-on voltage during the first period, the gate-off voltage during the second period, and the gate-on voltage during the third period. A voltage of the first mode selection signal can be the gate-on voltage in the first period, the second period, and the third period of the first mode, and the gate-off voltage in the first period, the second period, and the third period of the second mode. A voltage of the second mode selection signal can be the gate-on voltage in the first period, the second period, and the third period of the second mode, and the gate-off voltage in the first period, the second period, and the third period of the first mode. In the first mode, a voltage of the first mode signal applied to the first node can be the voltage of the emission signal, and a voltage of the second mode signal applied to the second node can be the gate-off voltage. In the second mode, a voltage of the first mode signal applied to the first node can be the gate-off voltage, and a voltage of the second mode signal applied to the second node can be the voltage of the emission signal.

The pixel circuit further can include a capacitor connected between a fourth node and a fifth node; a third switch element including a first electrode to which the data voltage is applied, a gate electrode to which a first scan signal is applied, and a second electrode electrically connected to the fifth node; a fourth switch element including a first electrode electrically connected to the third node, a gate electrode to which a second scan signal is applied, and a second electrode connected to the fourth node; a fifth switch element including a first electrode electrically connected to a sixth node to which a reference voltage is applied, a gate electrode to which the second scan signal is applied, and a second electrode connected to a seventh node; a sixth switch element including a first electrode connected to the sixth node, a gate electrode to which the second scan signal is applied, and a second electrode electrically connected to an eighth node; a seventh-first switch element including a first electrode connected to the fifth node, a gate electrode connected to the first node, and a second electrode connected to the sixth node; and a seventh-second switch element including a first electrode connected to the fifth node, a gate electrode connected to the second node, and a second electrode connected to the sixth node. A gate electrode of the driving element can be electrically connected to the fourth node. The first light-emitting element can include an anode electrode connected to the seventh node and a cathode electrode to which a cathode voltage is applied. The second light-emitting element can include an anode electrode connected to the eighth node and a cathode electrode to which the cathode voltage is applied.

The emission signal can swing between a gate-on voltage and a gate-off voltage. Each of the first switch element, the second switch element, the third switch element, the fourth switch element, the fifth switch element, the sixth switch element, the seventh-first switch element, and the seventh-second switch element can be turned on in response to the gate-on voltage, and can be turned off in response to the gate-off voltage. A voltage of the first scan signal in each of the first mode and the second mode can be the gate-off voltage during a first period, the gate-on voltage during a second period after the first period, and the gate-off voltage during a third period after the second period. A voltage of the second scan signal in each of the first mode and the second mode can be the gate-on voltage during the first period and the second period, and the gate-off voltage during the third period. A voltage of the emission signal in each of the first mode and the second mode can be the gate-on voltage during the first period, the gate-off voltage during the second period, and the gate-on voltage during the third period. A voltage of the first mode selection signal can be the gate-on voltage in the first period, the second period, and the third period of the first mode, and the gate-off voltage in the first period, the second period, and the third period of the second mode. A voltage of the second mode selection signal can be the gate-on voltage in the first period, the second period, and the third period of the second mode, and is the gate-off voltage in the first period, the second period, and the third period of the first mode. In the first mode, a voltage of the first mode signal applied to the first node can be the voltage of the emission signal, and a voltage of the second mode signal applied to the second node is the gate-off voltage. In the second mode, the voltage of the first mode signal applied to the first node can be the gate-off voltage, and the voltage of the second mode signal applied to the second node is the voltage of the emission signal.

The mode selection circuit can include a first mode switch element including a first electrode to which the emission signal is applied, a gate electrode to which the first mode selection signal is applied, and a second electrode electrically connected to the first node; a second mode switch element including a first electrode to which a gate high voltage is applied, a gate electrode to which the second mode selection signal is applied, and a second electrode electrically connected to the first node; a third mode switch element including a first electrode to which the emission signal is applied, a gate electrode to which the second mode selection signal is applied, and a second electrode electrically connected to the second node; and a fourth mode switch element including a first electrode to which the gate high voltage is applied, a gate electrode to which the first mode selection signal is applied, and a second electrode electrically connected to the second node. The emission signal can swing between the gate high voltage and a gate low voltage. The first switch element can be turned on in response to the gate low voltage applied to the first node and turned off in response to the gate high voltage applied to the first node. The second switch element can be turned on in response to the gate low voltage applied to the second node and turned off in response to the gate high voltage applied to the second node.

The pixel circuit further can include a capacitor connected between a VDD node to which the pixel driving voltage is applied and a fourth node; a third switch element including a first electrode to which the data voltage is applied, a gate electrode to which a second scan signal is applied, and a second electrode electrically connected to a fifth node; a fourth switch element including a first electrode electrically connected to the third node, a gate electrode to which a first scan signal is applied, and a second electrode connected to the fourth node; a fifth switch element including a first electrode to which a second compensation voltage is applied, a gate electrode to which a third scan signal is applied, and a second electrode connected to a sixth node; a sixth switch element including a first electrode to which the second compensation voltage is applied, a gate electrode to which the third scan signal is applied, and a second electrode connected to a seventh node; a seventh switch element including a first electrode connected to an INI node to which an initialization voltage is applied, a gate electrode to which a fourth scan signal is applied, and a second electrode connected to the fourth node; an eighth switch element including a first electrode to which a first compensation voltage is applied, a gate electrode to which the third scan signal is applied, and a second electrode connected to the fifth node; and a ninth switch element including a first electrode connected to the VDD node, a gate electrode to which the emission signal is applied, and a second electrode connected to the fifth node. A gate electrode of the driving element can be electrically connected to the fourth node. The first light-emitting element can include an anode electrode connected to the sixth node and a cathode electrode to which a cathode voltage is applied. The second light-emitting element can include an anode electrode connected to the seventh node and a cathode electrode to which the cathode voltage is applied. Each of the first mode switch element, the second mode switch element, the third mode switch element, the fourth mode switch element, the first switch element, the second switch element, the third switch element, the fifth switch element, the sixth switch element, the eighth switch element, and the ninth switch element can be turned on in response to a gate low voltage applied to a corresponding gate electrode, and turned off in response to a gate high voltage applied to the corresponding gate electrode. Each of the fourth switch element and the seventh switch element can be turned on in response to a gate high voltage applied to a corresponding gate electrode and turned off in response to a gate low voltage applied to the corresponding gate electrode.

The pixel circuit further can include a capacitor connected between a VDD node to which the pixel driving voltage is applied and a fourth node; a third switch element including a first electrode to which the data voltage is applied, a gate electrode to which a second scan signal is applied, and a second electrode electrically connected to a fifth node; a fourth switch element including a first electrode electrically connected to the third node, a gate electrode to which a first scan signal is applied, and a second electrode connected to the fourth node; a fifth switch element including a first electrode to which a second compensation voltage is applied, a gate electrode to which a third scan signal is applied, and a second electrode connected to a sixth node; a sixth switch element including a first electrode to which the second compensation voltage is applied, a gate electrode to which the third scan signal is applied, and a second electrode connected to a seventh node; a seventh switch element including a first electrode connected to an INI node to which an initialization voltage is applied, a gate electrode to which a fourth scan signal is applied, and a second electrode connected to the fourth node; an eighth switch element including a first electrode to which a first compensation voltage is applied, a gate electrode to which the third scan signal is applied, and a second electrode connected to the fifth node; a ninth-first switch element including a first electrode connected to the VDD node, a gate electrode connected to the first node, and a second electrode connected to the fifth node; and a ninth-second switch element including a first electrode connected to the VDD node, a gate electrode connected to the second node, and a second electrode connected to the fifth node. A gate electrode of the driving element can be electrically connected to the fourth node. The first light-emitting element can include an anode electrode connected to the sixth node and a cathode electrode to which a cathode voltage is applied. The second light-emitting element can include an anode electrode connected to the seventh node and a cathode electrode to which the cathode voltage is applied. Each of the first mode switch element, the second mode switch element, the third mode switch element, the fourth mode switch element, the first switch element, the second switch element, the third switch element, the fifth switch element, the sixth switch element, the eighth switch element, the ninth-first switch element, and the ninth-second switch element can be turned on in response to a gate low voltage applied to a corresponding gate electrode, and turned off in response to a gate high voltage applied to the corresponding gate electrode. Each of the fourth switch element and the seventh switch element can be turned on in response to a gate high voltage applied to a corresponding gate electrode and turned off in response to a gate low voltage applied to the corresponding gate electrode.

A voltage of the first scan signal in each of the first mode and the second mode can be the gate low voltage during a first period, the gate high voltage during a second period after the first period, the gate high voltage during a third period after the second period, the gate low voltage during a fourth period after the third period, and the gate low voltage during a fifth period after the fourth period. A voltage of the second scan signal in each of the first mode and the second mode can be the gate high voltage during the first period, the second period, the fourth period, and the fifth period, and the gate low voltage during the third period. A voltage of the third scan signal in each of the first mode and the second mode can be the gate low voltage during the first period and the fourth period, and the gate high voltage during the second period, the third period and the fifth period. A voltage of the fourth scan signal in each of the first mode and the second mode can be the gate low voltage during the first period, the third period, the fourth period, and the fifth period, and the gate high voltage during the second period. A voltage of the emission signal in each of the first mode and the second mode can be the gate high voltage during the first period, the second period, the third period, and the fourth period, and the gate low voltage during the fifth period. A voltage of the first mode selection signal can be the gate low voltage during the first period, the second period, the third period, the fourth period, and the fifth period of the first mode, and the gate high voltage during the first period, the second period, the third period, the fourth period, and the fifth period of the second mode. A voltage of the second mode selection signal can be the gate low voltage during the first period, the second period, the third period, the fourth period, and the fifth period of the second mode, and the gate high voltage during the first period, the second period, the third period, the fourth period, and the fifth period of the first mode. In the first mode, a voltage of the first mode signal applied to the first node can be a voltage of the emission signal, and a voltage of the second mode signal applied to the second node is the gate high voltage. In the second mode, the voltage of the first mode signal applied to the first node can be the gate high voltage, and the voltage of the second mode signal applied to the second node can be the voltage of the emission signal.

The pixel circuit further can include a capacitor connected between a VDD node to which the pixel driving voltage is applied and a fourth node; a third switch element including a first electrode to which the data voltage is applied, a gate electrode to which an Nth (where N is a natural number) scan signal is applied, and a second electrode electrically connected to a fifth node; a fourth switch element including a first electrode electrically connected to the third node, a gate electrode to which the Nth scan signal is applied, and a second electrode connected to the fourth node; a fifth switch element including a first electrode connected to an INI node to which an initialization voltage is applied, a gate electrode to which an (N−1)th scan signal is applied, and a second electrode connected to a sixth node; a sixth switch element including a first electrode connected to the INI node, a gate electrode to which the (N−1)th scan signal is applied, and a second electrode electrically connected to a seventh node; a seventh switch element including a first electrode connected to the INI node, a gate electrode to which the (N−1)th scan signal is applied, and a second electrode connected to the fourth node; and an eighth switch element including a first electrode connected to the VDD node, a gate electrode to which the emission signal is applied, and a second electrode connected to the fifth node. A gate electrode of the driving element can be electrically connected to the fourth node. The first light-emitting element can include an anode electrode connected to the sixth node and a cathode electrode to which a cathode voltage is applied. The second light-emitting element can include an anode electrode connected to the seventh node and a cathode electrode to which the cathode voltage is applied.

The pixel circuit further can include a capacitor connected between a VDD node to which the pixel driving voltage is applied and a fourth node; a third switch element including a first electrode to which the data voltage is applied, a gate electrode to which an Nth (where N is a natural number) scan signal is applied, and a second electrode electrically connected to a fifth node; a fourth switch element including a first electrode electrically connected to the third node, a gate electrode to which the Nth scan signal is applied, and a second electrode connected to the fourth node; a fifth switch element including a first electrode connected to an INI node to which an initialization voltage is applied, a gate electrode to which an (N−1)th scan signal is applied, and a second electrode connected to a sixth node; a sixth switch element including a first electrode connected to the INI node, a gate electrode to which the (N−1)th scan signal is applied, and a second electrode electrically connected to a seventh node; a seventh switch element including a first electrode connected to the INI node, a gate electrode to which the (N−1)th scan signal is applied, and a second electrode connected to the fourth node; an eighth-first switch element including a first electrode connected to the VDD node, a gate electrode connected to the first node, and a second electrode connected to the fifth node; and an eighth-second switch element including a first electrode connected to the VDD node, a gate electrode connected to the second node, and a second electrode connected to the fifth node. A gate electrode of the driving element can be electrically connected to the fourth node. The first light-emitting element can include an anode electrode connected to the sixth node and a cathode electrode to which a cathode voltage is applied. The second light-emitting element can include an anode electrode connected to the seventh node and a cathode electrode to which the cathode voltage is applied.

The pixel circuit further can include a capacitor connected between a fourth node and an eighth node; a third switch element including a first electrode to which the data voltage is applied, a gate electrode to which an Nth (where N is a natural number) scan signal is applied, and a second electrode electrically connected to a fifth node; a fourth switch element including a first electrode electrically connected to the third node, a gate electrode to which the Nth scan signal is applied, and a second electrode connected to the fourth node; a fifth switch element including a first electrode connected to an INI node to which an initialization voltage is applied, a gate electrode to which an (N−1)th scan signal is applied, and a second electrode connected to a sixth node; a sixth switch element including a first electrode connected to the INI node, a gate electrode to which the (N−1)th scan signal is applied, and a second electrode electrically connected to a seventh node; a seventh switch element including a first electrode connected to the INI node, a gate electrode to which the (N−1)th scan signal is applied, and a second electrode connected to the fourth node; an eighth switch element including a first electrode connected to a VDD node to which the pixel driving voltage is applied, a gate electrode to which the emission signal is applied, and a second electrode connected to the eighth node; a ninth switch element including a first electrode connected to the fifth node, a gate electrode to which the emission signal is applied, and a second electrode connected to the eighth node; a tenth switch element including a first electrode connected to an REF node to which a reference voltage is applied, a gate electrode to which the (N−1)th scan signal is applied, and a second electrode connected to the eighth node; and an eleventh switch element including a first electrode connected to the REF node, a gate electrode to which the Nth scan signal is applied, and a second electrode connected to the eighth node. A gate electrode of the driving element can be electrically connected to the fourth node. The first light-emitting element can include an anode electrode connected to the sixth node and a cathode electrode to which a cathode voltage is applied. The second light-emitting element can include an anode electrode connected to the seventh node and a cathode electrode to which the cathode voltage is applied.

The pixel circuit further can include a capacitor connected between a fourth node and an eighth node; a third switch element including a first electrode to which the data voltage is applied, a gate electrode to which an Nth (where N is a natural number) scan signal is applied, and a second electrode electrically connected to a fifth node; a fourth switch element including a first electrode electrically connected to the third node, a gate electrode to which the Nth scan signal is applied, and a second electrode connected to the fourth node; a fifth switch element including a first electrode connected to an INI node to which an initialization voltage is applied, a gate electrode to which an (N−1)th scan signal is applied, and a second electrode connected to a sixth node; a sixth switch element including a first electrode connected to the INI node, a gate electrode to which the (N−1)th scan signal is applied, and a second electrode electrically connected to a seventh node; a seventh switch element including a first electrode connected to the INI node, a gate electrode to which the (N−1)th scan signal is applied, and a second electrode connected to the fourth node; an eighth-first switch element including a first electrode connected to a VDD node to which a pixel driving voltage is applied, a gate electrode connected to the first node, and a second electrode connected to the eighth node; an eighth-second switch element including a first electrode connected to the VDD node, a gate electrode connected to the second node, and a second electrode connected to the eighth node; a ninth-first switch element including a first electrode connected to the fifth node, a gate electrode connected to the first node, and a second electrode connected to the eighth node; a ninth-second switch element including a first electrode connected to the fifth node, a gate electrode connected to the second node, and a second electrode connected to the eighth node; a tenth switch element including a first electrode connected to an REF node to which a reference voltage is applied, a gate electrode to which the (N−1)th scan signal is applied, and a second electrode connected to the eighth node; and an eleventh switch element including a first electrode connected to the REF node, a gate electrode to which the Nth scan signal is applied, and a second electrode connected to the eighth node. A gate electrode of the driving element can be electrically connected to the fourth node. The first light-emitting element can include an anode electrode connected to the sixth node and a cathode electrode to which a cathode voltage is applied. The second light-emitting element can include an anode electrode connected to the seventh node and a cathode electrode to which the cathode voltage is applied.

A voltage of the (N−1)th scan signal can be the gate-on voltage during a first period, the gate-off voltage during a second period after the first period, and the gate-off voltage during a third period after the second period, in each of the first mode and the second mode. A voltage of the Nth scan signal can be the gate-off voltage during the first period and the third period, and the gate-on voltage during the second period, in each of the first mode and the second mode. A voltage of the light emission signal can be the gate-off voltage during the first period and the second period and the gate-on voltage during the third period, in each of the first mode and the second mode. A voltage of the first mode selection signal can be the gate-on voltage during the first period, the second period, and the third period of the first mode, and the gate-off voltage during the first period, the second period, and the third period of the second mode. A voltage of the second mode selection signal can be the gate-off voltage during the first period, the second period, and the third period of the first mode, and the gate-on voltage during the first period, the second period, and the third period of the second mode. In the first mode, a voltage of the first mode signal applied to the first node can be the voltage of the emission signal, and a voltage of the second mode signal applied to the second node can be the gate-off voltage. In the second mode, the voltage of the first mode signal applied to the first node can be the gate-off voltage, and the voltage of the second mode signal applied to the second node can be the voltage of the emission signal.

A display device according to an embodiment of the present disclosure includes: a display panel in which a plurality of data lines, a plurality of gate lines, a plurality of power lines, and a plurality of pixel circuits are disposed; a data driver configured to supply a data voltage to the data lines; a gate driver configured to receive a gate timing signal and supply a scan signal and an emission signal to the gate lines; a level shifter configured to output a first mode selection signal, a second mode selection signal, and the gate timing signal; and a mode selection circuit configured to output the emission signal to a first node in response to the first mode selection signal, and output the emission signal to a second node in response to the second mode selection signal. Each of the sub-pixels can be configured to drive a first light-emitting element in response to a voltage of the first node in a first mode, and drive a second light-emitting element in response to a voltage of the second node in a second mode. Each of the sub-pixels can include the pixel circuit.

The present disclosure can enable low power and process optimization, as well as changing the viewing angle of pixels with a mode selection signal.

The present disclosure can reduce the number of the switch elements for changing the viewing angle for each pixel, and can simplify the configuration of the pixel circuit capable of changing the viewing angle by reducing the number of wires connected between the pixels and the gate driver. Further, the present disclosure can reduce the number of wires in the display panel, which can optimize the process of the display panel and improve the yield.

The effects of the present disclosure are not limited to the above-mentioned effects, and other effects that are not mentioned will be apparently understood by those skilled in the art from the following description and the appended claims.

### BRIEF DESCRIPTION OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to one embodiment of the present disclosure;

FIG. 2 is a circuit diagram schematically illustrating a pixel circuit and a mode selection circuit according to one embodiment of the present disclosure;

FIG. 3 is a circuit diagram illustrating the mode selection circuit shown in FIG. 2 in detail;

FIG. 4 is a waveform diagram illustrating an example of input/output signals of the mode selection circuit shown in FIG. 2;

FIG. 5 is a diagram illustrating an example of lenses disposed over light-emitting elements;

FIG. 6 is a diagram illustrating one frame period and one horizontal period of a display device;

FIG. 7 is a block diagram schematically illustrating the gate driver;

FIG. 8 is a block diagram illustrating a plurality of gate drivers and a mode selector;

FIG. 9 is a diagram illustrating a transmission path of a mode selection signal;

FIG. 10 is a waveform diagram illustrating an example in which pixels are driven in a first mode for an nth frame period and pixels are driven in a second mode for an (n+1)^{th} frame period;

FIG. 11 is an enlarged waveform diagram of a section marked ‘A’ in FIG. 10;

FIGS. 12A to 17B are diagrams illustrating the operation of a pixel circuit and a mode selection circuit in stages according to one embodiment of the present disclosure;

FIGS. 18A to 23B are diagrams illustrating the operation of a pixel circuit and a mode selection circuit in stages according to another embodiment of the present disclosure;

FIGS. 24A to 29B are diagrams illustrating the operation of a pixel circuit and a mode selection circuit in stages according to another embodiment of the present disclosure;

FIGS. 30A and 30B are diagrams illustrating a pixel circuit and a mode selection circuit, and signals applied to these circuits according to another embodiment of the present disclosure;

FIGS. 31A to 34B are diagrams illustrating the operation of a pixel circuit and a mode selection circuit in stages according to another embodiment of the present disclosure;

FIGS. 35A and 35B are diagrams illustrating a pixel circuit and a mode selection circuit, and signals applied to these circuits, according to another embodiment of the present disclosure;

FIGS. 36A to 39B are diagrams illustrating the operation of a pixel circuit and a mode selection circuit in stages according to another embodiment of the present disclosure; and

FIGS. 40A and 40B are diagrams illustrating a pixel circuit and a mode selection circuit, and signals applied to these circuits, according to another embodiment of the present disclosure.

### DETAILED DESCRIPTION OF THE EMBODIMENTS

The advantages and features of the present disclosure and methods for accomplishing the same will be more clearly understood from embodiments described below with reference to the accompanying drawings. However, the present disclosure is not limited to the following embodiments but can be implemented in various different forms. Rather, the present embodiments will make the disclosure of the present disclosure complete and allow those skilled in the art to completely comprehend the scope of the present disclosure. The present disclosure is only defined within the scope of the accompanying claims.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present disclosure. Further, in describing the present disclosure, detailed descriptions of known related technologies can be omitted to avoid unnecessarily obscuring the subject matter of the present disclosure.

The terms such as “comprising,” “including,” “having,” and “constituting” used herein are generally intended to allow other components to be added unless the terms are used with the term “only.” Any references to singular can include plural unless expressly stated otherwise.

Components are interpreted to include an ordinary error range even if not expressly stated.

When a positional or interconnected relationship is described between two components, using terms such as “on top of,” “above,” “below,” “next to,” “connect or couple with,” “crossing,” “intersecting,” or the like, one or more other components can be interposed between them, unless “immediately” or “directly” is used.

When a temporal antecedent relationship is described, using terms such as “after”, “following”, “next to”, “before”, or the like, it may not be continuous on a time base unless “immediately” or “directly” is used.

The terms “first,” “second,” and the like can be used to distinguish components from each other and may not define order or sequence, but the functions or structures of the components are not limited by ordinal numbers or component names in front of the components.

The following embodiments can be partially or entirely bonded to or combined with each other and can be linked and operated in technically various ways. The embodiments can be carried out independently of or in association with each other.

Further, the term “can” encompasses all the meanings and coverages of the term “may.” The term “disclosure” is interchangeably used with, or encompasses all the meanings and coverages of, the term “invention.”

All the components of each display device or apparatus according to all embodiments of the present disclosure are operatively coupled and configured.

The pixel circuit of the display device can include a plurality of transistors. The transistor can be implemented as a thin film transistor (TFT). The transistors can be implemented as an oxide thin film transistor (TFT) including an oxide semiconductor, a low temperature poly silicon TFT (LTPS TFT) including a low temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons can flow from a source to a drain. The n-channel transistor has a direction of a current flowing from the drain to the source. In the case of a p-channel transistor (p-channel metal-oxide semiconductor (PMOS)), since carriers are holes, a source voltage is higher than a drain voltage such that holes can flow from a source to a drain. In the p-channel transistor, since holes flow from the source to the drain, current flows from the source to the drain. It should be noted that a source and a drain of a transistor are not fixed. For example, a source and a drain can be changed according to an applied voltage. Therefore, the disclosure is not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage can be a gate high voltage VGH, and the gate-off voltage can be a gate low voltage VGL. In the case of a p-channel transistor, the gate-on voltage can be the gate low voltage VGL, and the gate-off voltage can be the gate high voltage VGH.

Hereinafter, various embodiments of the present disclosure will be described in detail with reference to the accompanying drawings.

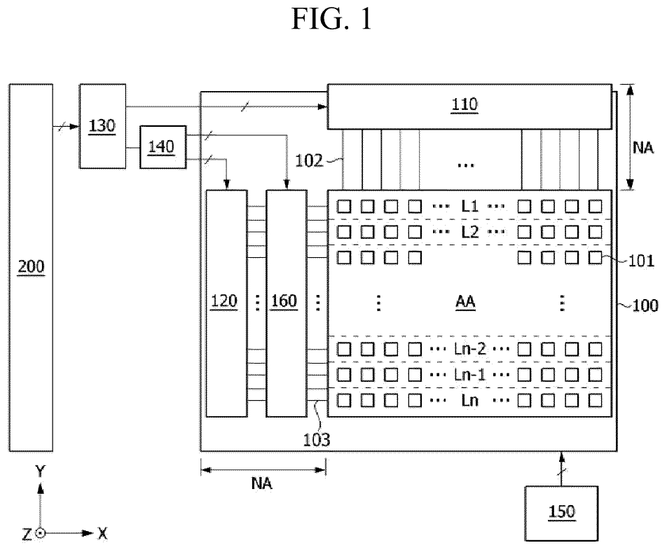

Referring to FIG. 1, a display device according to an embodiment of the present disclosure includes a display panel 100 and a display panel driving circuit for writing pixel data to pixels of the display panel 100. The display device also includes a power supply 150.

The display panel 100 can be, but is not limited to, a rectangular shaped panel having a length in the X-axis direction (or first direction), a width in the Y-axis direction (or second direction), and a thickness in the Z-axis direction (or third direction). For example, the display panel 100 can be a deformed panel that is at least partially curved or elliptical.

A display area AA of the display panel 100 includes a pixel array for displaying an input image thereon. The pixel array includes a plurality of data lines 102, a plurality of gate lines 103 intersected with the data lines 102, and the pixels arranged in a matrix form. The display panel 100 can further include power lines commonly connected to the pixels. The power lines can be commonly connected to pixel circuits and supply a voltage required for driving the pixels 101 to the pixels 101.

Each of the pixels 101 can be divided into a red sub-pixel, a green sub-pixel, and a blue sub-pixel for color implementation. Each of the pixels can further include a white sub-pixel. Each sub-pixel includes a pixel circuit for driving a light-emitting element. The light-emitting element can be implemented as an organic light-emitting element, such as an OLED, or an inorganic light-emitting element, such as a micro light-emitting diode (LED). Each of the pixel circuits can be connected to the data lines, the gate lines, and the power lines. Hereinafter, a pixel can be interpreted as having the same meaning as a sub-pixel.

Each of the pixels 101 can include a first light-emitting element that is emitted in a first mode and a second light-emitting element that is emitted in a second mode. Each of the pixels 101 emits light from a first light-emitting element in a wide viewing angle in the first mode, while emitting light from the second light-emitting element in a narrow viewing angle in the second mode.

The display array or display area AA includes a plurality of pixel lines L1 to Ln. Each of the pixel lines L1 to Ln includes one line of pixels arranged along the line direction (X-axis direction) in the pixel array of the display panel 100. The pixels arranged in one pixel line can share the gate lines 103. The sub-pixels arranged in the column direction (Y-axis direction) can share the same data line 102. One horizontal period is a time obtained by dividing one frame period by the total number of the pixel lines L1 to Ln.

The display panel 100 can be implemented with a non-transmissive display panel or a transmissive display panel. The transmissive display panel can be applied to a transparent display device in which an image is displayed on a screen and an actual object is visible beyond the display panel. The display panel 100 can be made as a flexible display panel that can be flexibly bent.

The power supply 150 receives an input voltage from a host system 200 and outputs voltages required to drive the pixels 101 of the display panel 100 and the display panel driving circuit. To this end, the power supply 150 can include a direct current to direct current converter (DC-DC converter). The DC-DC converter can include a charge pump, a regulator, a buck converter, a boost converter, and the like. The power supply 150 can output constant voltages (or direct current voltages), such as a gate high voltage, a gate low voltage, a pixel driving voltage, a cathode voltage, a reference voltage, an initialization voltage, and an IC driving voltage for the display panel driving circuit through the DC-DC converter. The gate high voltage and the gate low voltage can be supplied to a level shifter 140 and the gate driver 120. The constant voltages such as the pixel driving voltage, the cathode voltage, the reference voltage, and the initialization voltage are supplied to the pixels 101 through the power lines commonly connected to the pixels 101.

The power supply 150 can further include a gamma voltage generator. The gamma voltage generator can receive a high potential reference voltage and a low potential reference voltage and output a plurality of gamma reference voltages divided by a predetermined voltage difference interval on a preset gamma curve, for example, 2.2 gamma curve. The gamma reference voltages are supplied to the data driver 110. The gamma reference voltages are divided by a voltage division circuit and subdivided into grayscale voltages in the data driver 110. The gamma voltage generator can be implemented as a programmable gamma circuit capable of adjusting a level of each of the gamma reference voltages according to digital data. The timing controller 130 or the host system 200 or a separate external device can update the digital data stored in a register of the programmable gamma circuit through a communication interface.

The display panel driving circuit writes the pixel data of the input image to the pixels 101 of the display panel 100 under the control of the timing controller 130. The display panel driving circuit includes a data driver 110, a gate driver 120, a mode selector 160, and the timing controller 130.

The display panel driving circuit can further include a touch sensor driver for driving touch sensors. The touch sensor driver is omitted from FIG. 1. The data driver 110 and the touch sensor driver can be integrated into a source drive integrated circuit (IC).

The data driver 110 receives the pixel data of the input image received as a digital signal from the timing controller 130 and outputs the data voltage. The data driver 110 can receive the gamma reference voltages and generate gamma compensated voltages for each grayscale through the voltage division circuit. The gamma-compensated voltages are supplied to a digital to analog converter (“DAC”) disposed on each of the channels of the data driver 110.

The data driver 110 samples and latches the digital data received from the timing controller 130, and then inputs the digital data to the DAC. Here, the digital data includes pixel data of the input image. The DAC converts the pixel data to a gamma-compensated voltage and outputs the data voltage of the pixel data.

The gate driver 120 can be formed on the display panel 100 together with circuit elements of the display area AA and the wires. The gate driver 120 can be disposed in at least one of left and right non-display areas NA of the display panel 100 outside the display area AA, or at least a portion thereof can be disposed within the display area AA.

The gate driver 120 can be disposed in the non-display areas NA on both sides of the display panel 100 with the display area AA of the display panel interposed therebetween, and can supply gate pulses from the both sides of the gate lines 103 in a double feeding method. In another embodiment, the gate driver 120 can be disposed in at least one of the left and right non-display areas NA of the display panel 100 to supply gate signals to the gate lines 103 in a single feeding method. The gate driver 120 sequentially outputs pulses of the gate signals to the gate lines 103 under the control of the timing controller 130. The gate driver 120 can sequentially supply the gate signals to the gate lines 103 by shifting the pulses of the gate signals using a shift register and an edge trigger.

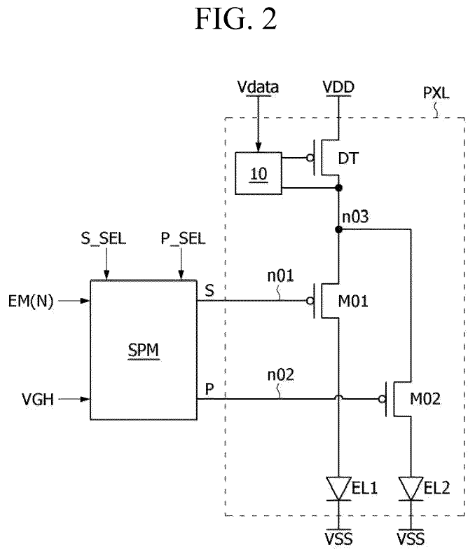

The gate signal can include a scan signal input to the pixel circuit via a plurality of gate lines, and an emission signal (hereinafter referred to as an “EM signal”). In this case, the gate driver can include a gate driver that outputs the scan signal and a gate driver that outputs the EM signal. The mode selector 160 is connected to the output terminals of the gate driver that outputs the EM signal. Each of the scan signal and the EM signal can swing between the gate high voltage and gate low voltage. The mode selector 160 can include a plurality of mode selection circuits shown in FIG. 2. The mode selection circuit can be disposed one for every line of pixels.

The timing controller 130 receives from the host system 200 digital video data of the input image and a timing signal synchronized with this data. The timing signal can include a vertical synchronization signal Vsync, a horizontal synchronization signal Hsync, and a data enable signal DE. Since a vertical period and a horizontal period can be known by counting the data enable signal DE, the vertical synchronization signal Vsync and the horizontal synchronization signal Hsync can be omitted. The horizontal synchronization signal Hsync and the data enable signal DE have a period of one horizontal period (1H).

The timing controller 130 generates a data timing control signal for controlling the operation timing of the data driver 110, a gate timing control signal for controlling the operation timing of the gate driver 120, and a mode selection signal based on the timing signals Vsync, Hsync, and DE received from the host system 200, thereby controlling the display panel driving circuit. The timing controller 130 synchronizes the data driver 110 and the gate driver 120 by controlling the operation timing of the display panel driving circuit.

The mode selection signal is a signal that selects either the first mode or the second mode as the operating mode of the pixels 101 according to its logic value. The mode selection signal can be separately output from the level shifter 140 as a first mode selection signal and a second mode selection signal.

The timing control signal output from the timing controller 130 can be input to the shift register of the gate driver 120 through the level shifter 140. The mode selection signal output from the timing controller 130 can be input to the mode selection circuits through the level shifter 140.

The level shifter 140 can convert a voltage level of the signal received from the timing controller 130 to a swing width between the gate high voltage and the gate low voltage and output the same. The level shifter 140 can decode the gate timing signal to output a start pulse and clock to drive the gate driver 120, and can decode the mode selection signal to output the first and second mode selection signal. Each of the start pulse, clock, and mode selection signals is an alternating current signal that swings between the gate-on voltage and the gate-off voltage.

The host system 200 can scale an image signal from a video source to match the resolution of the display panel 100, and can transmit it to the timing controller 130 together with the timing signal. The host system 200 can transmit a viewing angle mode signal having different logic values in the first mode and the second mode together with the image signal to the timing controller 130 at least once every frame. The timing controller 130 can output the mode selection signal in response to the viewing angle mode signal.

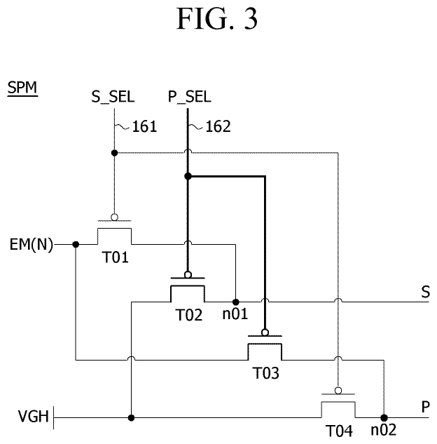

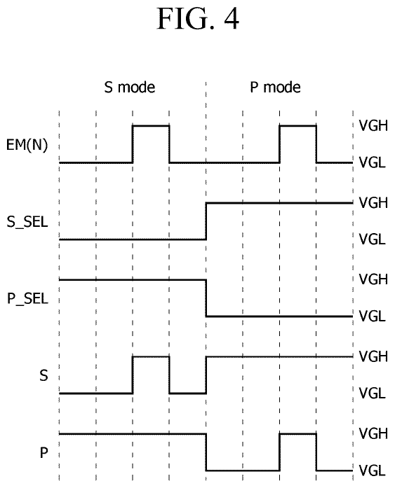

FIGS. 2 and 3 are diagrams illustrating the pixel circuit and the mode selection circuit according to one embodiment of the present disclosure. FIG. 4 is a waveform diagram illustrating an example of input/output signals of the mode selection circuit shown in FIG. 2. In FIG. 4, “S-mode” is the first mode in which the pixel is emitted in the wide viewing angle. “P-mode” is the second mode in which the pixel is emitted in narrow viewing angle.

Referring to FIGS. 2 to 4, the pixel circuit drives a first light-emitting element EL1 in response to a voltage of a first node n01 in the first mode, and drives a second light-emitting element EL2 in response to a voltage of a second node n02 in the second mode.

The pixel circuit includes the first light-emitting element EL1, the second light-emitting element EL2, a driving element DT to drive the first and second light-emitting elements EL1 and EL2, a compensation circuit 10 connected to the driving element DT, a first switch element M01 connected between the driving element DT and the first light-emitting element EL1, and a second switch element M02 connected between the driving element DT and the second light-emitting element EL2. The driving element DT and the switch elements M01 and M02 can be implemented as, but not limited to, p-channel transistors.

The first light-emitting element EL1 can be driven by a current from the driving element DT through the first switch element M01 to emit light in the first mode. The first light-emitting element EL1 includes an anode electrode connected to a second electrode of the first switch element M01, and a cathode electrode connected to a VSS node to which a cathode voltage VSS is applied.

The second light-emitting element EL2 can be driven by a current from the driving element DT through the second switch element M02 to emit light in the second mode. The second light-emitting element EL2 includes an anode electrode connected to a second electrode of the second switch element M02, and a cathode electrode connected to the VSS node to which the cathode voltage VSS is applied.

The driving element DT generates a current according to the gate-to-source voltage to drive the first and second light-emitting elements EL1 and EL2. The driving element DT includes a first electrode to which a driving voltage VDD is applied, a gate electrode, and a second electrode connected to a third node n03. The pixel driving voltage VDD can be applied to a first electrode of the driving element DT. A data voltage Vdata of the pixel data can be supplied to the gate electrode of the driving element DT. The second electrode of the driving element DT can be electrically connected to the first electrode of the first switch element M01 and the first electrode of the second switch element M02 via the third node n03.

The compensation circuit 10 can be connected to, but is not limited to, the driving element DT. The compensation circuit 10 can initialize the pixel circuit using two or more switch elements and a capacitor, sample a threshold voltage of the driving element DT, and apply the data voltage Vdata compensated by the amount of the threshold voltage to the gate electrode of the driving element DT.

The first switch element M01 is connected between the third node n03 and the anode electrode of the first light-emitting element EL1, and is turned on in response to a gate-on voltage VGL of the first mode signal S. When the first switch element M01 is turned on, the third node n03 is electrically connected to the first light-emitting element EL1 so that the first light-emitting element EL1 can be emitted. The first switch element M01 includes a first electrode electrically connected to the third node n03, a gate electrode electrically connected to the first node n01 to which the first mode signal S is applied, and a second electrode electrically connected to the anode electrode of the first light-emitting element EL1.

The second switch element M02 is connected between the third node n03 and the anode electrode of the second light-emitting element EL2, and is turned on in response to a gate-on voltage VGL of the second mode signal P. When the second switch element M02 is turned on, the third node n03 is electrically connected to the second light-emitting element EL2 so that the second light-emitting element EL2 can be emitted. The second switch element M02 includes a first electrode connected to the third node n03, a gate electrode electrically connected to the second node n02 to which the second mode signal P is applied, and a second electrode electrically connected to the anode electrode of the second light-emitting element EL2.

Each of the first and second switch elements M01 and M02 switches a current path flowing through the light-emitting elements EL1 and EL2 in response to the voltage of the corresponding mode signals S and P.

The mode selection circuit SPM receives an Nth (N is a natural number) EM signal EM(N), a first mode selection signal S_SEL, a second mode selection signal P_SEL, and a separate gate-off voltage VGH through a constant voltage node. Wires 161 and 162 for supplying the first and second mode selection signals S_SEL and P_SEL to the plurality of mode selection circuits SPM can be disposed in a non-display area NA of the display panel 100. The mode selection circuit SPM can output the EM signal EM(N) to the first node n01 in the first mode and the EM signal EM(N) to the second node n02 in the second mode.

The mode selection circuit SPM transmits a pulse of the Nth EM signal EM(N) to the pixel circuit PXL as an activation mode signal S or P in response to the gate-on voltage VGL of the first mode selection signal S_SEL and the second mode selection signal P_SEL. At the same time, the mode select circuit SPM transmits the other mode signal to the pixel circuit PXL as a deactivation mode signal P or S in response to the gate-off voltage VGH.

The mode selection circuit SPM includes a first mode switch element T01, a second mode switch element T02, a third mode switch element T03, and a fourth mode switch element T04. The mode switch elements T01, T02, T03, and T04 can be implemented as, but are not limited to, p-channel transistors. Each of the mode switch elements T01, T02, T03, and T04 can be turned on in response to the gate-on voltage VGL and turned off in response to the gate-off voltage VGH.

The first mode switch element T01 is connected between a node to which the Nth EM signal EM(N) is applied and the first node n01, and is turned on in response to the gate-on voltage VGL of the first mode selection signal S_SEL. The node to which the Nth EM signal EM(N) is applied can be connected to an output terminal of the gate driver 120 from which the Nth EM signal EM(N) is output. When the first mode switch element T01 is turned on, the Nth EM signal EM(N) is transmitted to the pixel circuit PXL as the first mode signal S. The first mode signal S controls the on/off timing of the first switch element M01 of the pixel circuit PXL. The first mode switch element T01 includes a first electrode to which the Nth EM signal EM(N) is applied, a gate electrode to which the first mode selection signal S_SEL is applied, and a second electrode electrically connected to the first node n01.

The second mode switch element T02 is connected between a VGH node to which the gate-off voltage VGH is applied and the first node n01, and is turned on in response to the gate-on voltage VGL of the second mode selection signal P_SEL. When the second mode switch element T02 is turned on, the gate-off voltage VGH is applied to the first node n01 to turn off the first switch element M01 of the pixel circuit PXL. The second mode switch element T02 includes a first electrode to which the separate gate-off voltage VGH is applied, a gate electrode to which the second mode selection signal P_SEL is applied, and a second electrode electrically connected to the first node n01.

The third mode switch element T03 is connected between a node to which the Nth EM signal EM is applied and the second node n02, and is turned on in response to the gate-on voltage VGL of the second mode selection signal P_SEL. When the third mode switch element T03 is turned on, the Nth EM signal EM(N) is transmitted to the pixel circuit PXL as the second mode signal P. The second mode signal P controls the on/off timing of the second switch element M02 of the pixel circuit PXL. The third mode switch element T03 includes a first electrode to which the Nth EM signal EM(N) is applied, a gate electrode to which the second mode selection signal P_SEL is applied, and a second electrode electrically connected to the second node n02.

The fourth mode switch element T04 is connected between a VGH node to which the gate-off voltage VGH is applied and the second node n02, and is turned on in response to the gate-on voltage VGL of the first mode selection signal S_SEL. When the fourth mode switch element T04 is turned on, the gate-off voltage VGH is applied to the second node n02 to turn off the second switch element M02 of the pixel circuit PXL. The fourth mode switch element T04 includes a first electrode to which the separate gate-off voltage VGH is applied, a gate electrode to which the first mode selection signal S_SEL is applied, and a second electrode electrically connected to the second node n02.

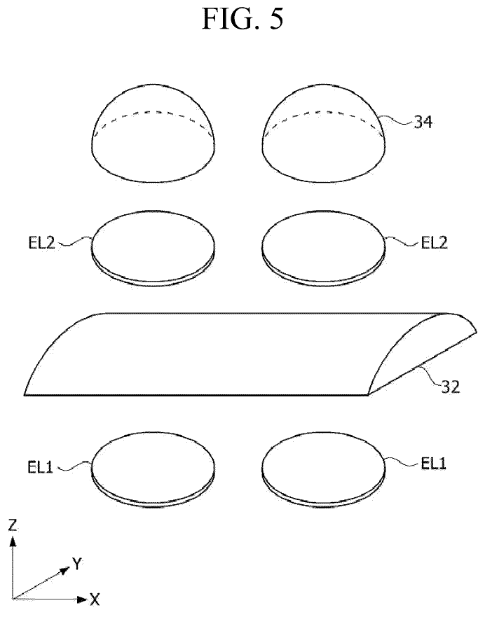

FIG. 5 is a diagram illustrating one example of lenses disposed over the light-emitting elements.

Referring to FIG. 5, a first lens 32 can be disposed over the first light-emitting element EL1. The first lens 32 can be implemented as a semi-cylindrical lens to limit the vertical viewing angle while increasing the horizontal viewing angle. The first lens 32 can be elongated in the X-axis direction parallel to the gate lines 103 of the display panel 100 and can have a narrow and convex center in the Y-axis direction parallel to the data lines 102. The first lens 32 diffuses the light of the first light-emitting element EL1, which is emitted in the first mode (the S mode), at the left and right viewing angles.

A second lens 34 can be disposed over the second light-emitting element EL2. The second lens 34 can be a hemispherical lens which is convex in the center and becomes thinner toward an edge. The second lens 34 can condense the light of the second light-emitting element EL2 emitted in the second mode (P mode) to narrow the vertical viewing angle and the horizontal viewing angle of the second light-emitting element EL2.

The first and second lenses 32 and 34 can be implemented as, but are not limited to, a transparent medium or a transparent insulating layer pattern disposed within the display panel 100.

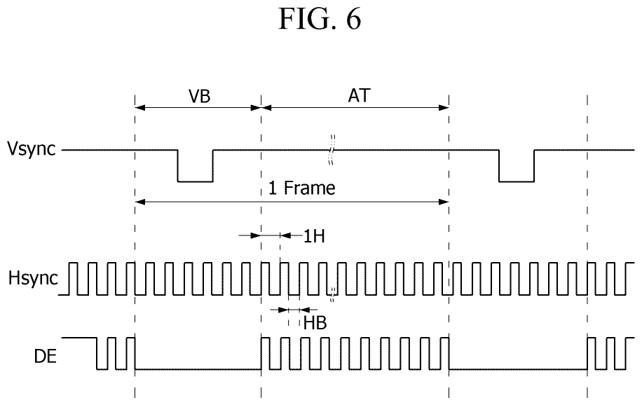

FIG. 6 is a diagram illustrating one frame period and one horizontal period of a display device.

Referring to FIG. 6, one cycle of a vertical synchronization signal Vsync defines one frame period. One cycle of a horizontal synchronization signal Hsync defines one horizontal period (1H). A clock of a data enable signal DE indicates valid data, including pixel data to be written to the pixels in one pixel line of the display panel 100. One cycle of the data enable signal DE is one horizontal period (1H).

An interval of one frame (1 Frame) is divided into an active interval AT in which the pixel data of the input image is written to the pixels 101, and a vertical blank period VB having no pixel data. Within the one horizontal period (1H), pixel data is written to the pixels present in the one pixel line of the display panel 100. The one horizontal period (1H) includes a horizontal blank period HB without pixel data between pixel lines.

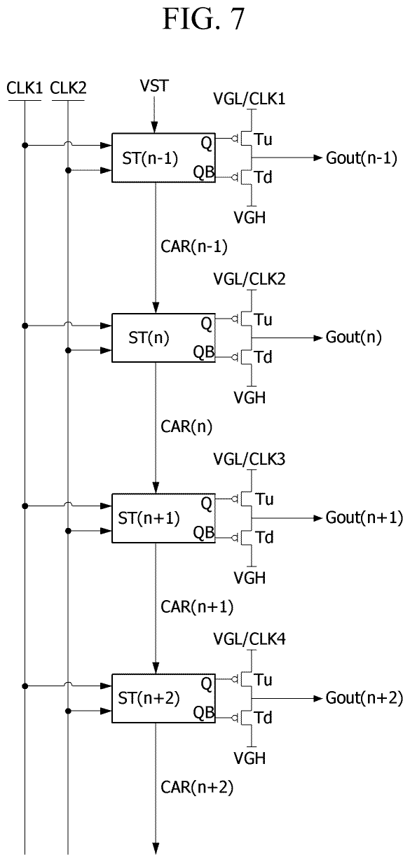

FIG. 7 is a block diagram schematically illustrating the gate driver 120.

Referring to FIG. 7, the gate driver 120 includes signal transmission parts [ST(n−1) to ST(n+2)] that are cascade-connected to each another.

The signal transmission parts [ST(n−1) to ST(n+2)] are connected to clock wires to which clocks CLK1 and CLK2 are applied. The signal transmission parts [ST(n−1) to ST(n+2)] are cascade-connected via carry signal wires to which carry pulses [CAR(n−1) to CAR(n+2)] are applied. The clocks CLK1 and CLK2 can be shown as 2-phase clocks in FIG. 6, but are not limited thereto. For example, an i-phase clock whose phase is sequentially shifted can be input to the shift register or the edge trigger in the gate driver, where i is a natural number greater than or equal to 2.

Each of the signal transmission parts [ST(n−1) to ST(n+2)] can include a VST node to which a start pulse VST is input, a CLK node to which a shift clock CLK1, CLK2 is input, a first output node from which pulses of gate signals [Gout(n−1) to Gout(n+2)] is output, and a second output node from which carry pulses [CAR(n−1) to CAR(n+2)] are output. The first output node from which the gate pulse is output is connected to the gate line of the display panel 100. The gate pulses [Gout(n−1) to Gout(n+2)] and the carry pulses [CAR(n−1) to CAR(n+2)] can be output through a common output node. In this case, the second output node and the first output node can be connected to one common output node.

The start pulse VST is generally inputted to a first signal transmission part. In the example of FIG. 7, an (n−1)^{th} signal transmission part [ST(n−1)] can be a first signal transmission part. The signal transmission parts [ST(n) to ST(n+2)] connected to the (n−1)th signal transmission part [ST(n−1)] in a cascade manner are started to be driven when receiving the carry pulses [CAR(n−1) to CAR(n+1)] as the start pulse from their respective preceding signal transmission parts. Each of the signal transmission parts [ST(n−1) to ST(n+2)] outputs a pulse of the respective gate signals [Gout(n−1) to Gout(n+2)] when the start pulse or carry signal is input and the clock is input. Therefore, the signal transmission parts [ST(n−1) to ST(n+2)] can sequentially output the pulses of the gate signal [Gout(n−1) to Gout(n+2)] while shifting the pulses. The gate signal can be, but is not limited to, a scan signal or an EM signal.

Each of the signal transmission parts [ST(n−1) to ST(n+2)] includes a first control node Q, a second control node QB, and a buffer circuit. Each of the signal transmission parts [ST(n−1) to ST(n+2)] can charge and discharge the first and second control nodes Q and QB using a plurality of transistors. A reset pulse from a next signal transmission part can be input to a reset node of the signal transmission parts [ST(n−1) to ST(n+2)]. The signal transmission parts [ST(n−1) to ST(n+2)] can discharge the first control node Q in response to the reset pulse from the next signal transmission parts.

The buffer circuit outputs a pulse of the gate signals through a pull-up transistor Tu and a pull-down transistor Td to a gate line connected to the pixel circuit through a first output node or a common output node.

When the clocks CLK1 and CLK2 are input while the first control node Q is charged, the buffer circuit can supply a gate-on voltage of the clocks CLK1 and CLK2 or a gate-on voltage applied as a constant voltage through the power line to the first output node or the common output node, so that the voltage of the gate signal is output as the gate-on voltage. The buffer circuit can discharge the first output node or the common output node when the second control node QB is charged to output the voltage of the gate signal as the gate-off voltage.

The pull-up transistor Tu includes a gate electrode connected to the first control node Q, a CLK node to which the clock CLK1, CLK2 is applied or a first electrode to which the gate-on voltage is input, and a second electrode connected to the first output node or the common output node. The pull-down transistor Td includes a gate electrode connected to the second control node QB, a first electrode connected to the first output node or the common output node, and a second electrode to which the gate-off voltage is applied.

An inverter circuit can be connected between the first control node Q and the second control node QB. The inverter circuit controls the voltages of the first control node Q and the second control node QB with voltages inverted from each other.

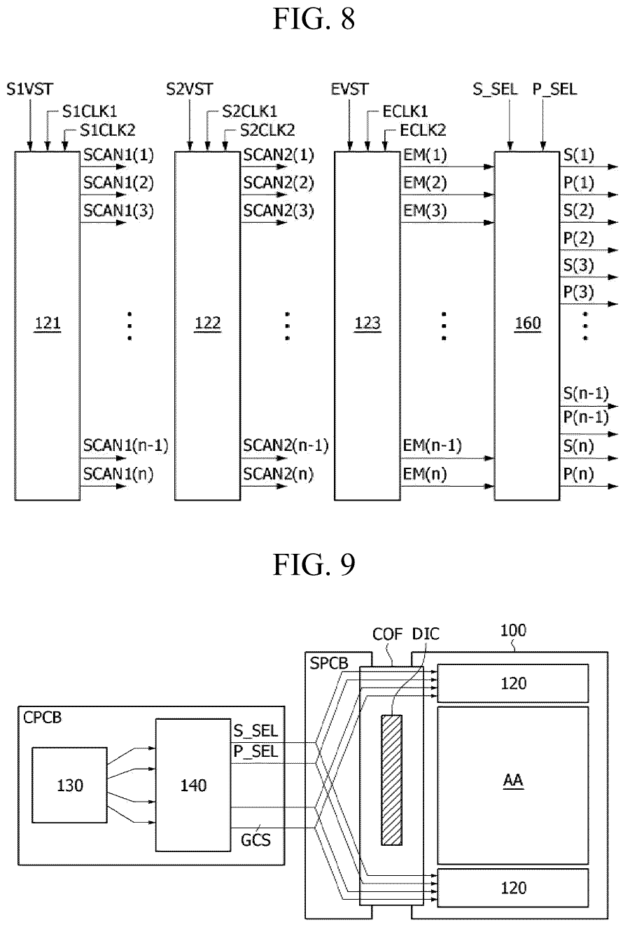

FIG. 8 is a block diagram illustrating a plurality of gate drivers and a mode selector.

Referring to FIG. 8, the gate signal, such as a pulse of the first scan signal, a pulse of the second scan signal, and a pulse of the EM signal, can be applied to each of the sub-pixels of the display panel 100. In this case, the gate driver 120 can include a first gate driver 121 that sequentially outputs pulses of the first scan signal SCAN1(1) to (n), a second gate driver 122 that sequentially outputs pulses of the second scan signal (SCAN2(1) to (n)), and a third gate driver 123 that sequentially outputs pulses of the EM signal (EM(1) to (n)). The gate drivers 121, 122, and 123 can independently receive start pulses S1VST, S2VST, and EVST corresponding to the output waveforms and clocks S1CLK1, S1CLK2, S2CLK1, S2CLK2, ECLK1, and ECLK2.

The pixels in a first pixel line can receive first gate signals SCAN1(1), SCAN(2), and EM(1) output from the gate drivers 121, 122, and 123. The pixels in an nth pixel line can receive nth gate signals SCAN1(n), SCAN2(n), and EM(n) output from the gate drivers 121, 122, and 123.

The mode selector 160 is connected to the output terminals of the third gate driver 123 and receives EM signals EM(1) to (n), and receives the first mode selection signal S_SEL and the second mode selection signal P_SEL. The mode selector 160 also receives the gate-off voltage VGH. The mode selector 160 supplies the EM signals EM(1) to (n) to the pixels as the activation mode signal in response to the mode selection signal S_SEL or P_SEL of the gate-on voltage, or supplies the EM signals EM(1) to (n) to the pixels as the deactivation mode signal in response to the mode select signal S_SEL or P_SEL of the gate-off voltage. The pixels of the first pixel line can be driven at the wide viewing angle or the narrow viewing angle in response to the activation mode signal among the first and second mode signals S(1) and P(1) input from the mode selector 160. The pixels in the n^{th} pixel line can be driven at the wide viewing angle or the narrow viewing angle in response to the activation mode signal among the first and second mode signals S(n) and P(n) input from the mode selector 160.

FIG. 9 is a diagram illustrating a transmission path of the mode selection signal.

Referring to FIG. 9, the display device can include a control board CPCB, a source board SPCB, and a chip on film COF electrically connected to the display panel 100. The source drive IC DIC in which the circuit of the data driver 110 is integrated can be mounted on a flexible film of the COF.

The control board CPCB includes the timing controller 130, the level shifter 140, a power supply 150, and the like. The control board CPCB can be electrically connected to the source board SPCB through flexible circuits such as flexible flat cables (FFC) and flexible printed circuit boards (FPCB) and connectors.

The COF is connected between the source board SPCB and the display panel 100 to electrically connect the source board SPCB to the display panel 100 and to supply the data voltage output from the source drive IC DIC to the data lines in the display panel 100.

The gate timing control signal and the mode selection signal S_SEL, P_SEL output from the timing controller 130 can be converted to signals that swing between the gate-on voltage and the gate-off voltage in the level shifter 140. The timing controller 130 can encode timing information of the gate timing control signal and the mode selection signal to transmit it to the level shifter 140, and the level shifter 140 can decode signals received from the timing controller 130 to output the gate timing control signal and the mode selection signal S_SEL, P_SEL that swing between the gate-on voltage and the gate-off voltage. The gate timing control signal include the start pulse and the clock. The gate timing control signal and the mode selection signal S_SEL, P_SEL output from the level shifter 140 can be transmitted to the display panel 100 via wires on the source board SPCB and COF, and can then be transmitted to the gate driver 120 and the mode selector 160 via wires disposed in the non-display area NA of the display panel 100.

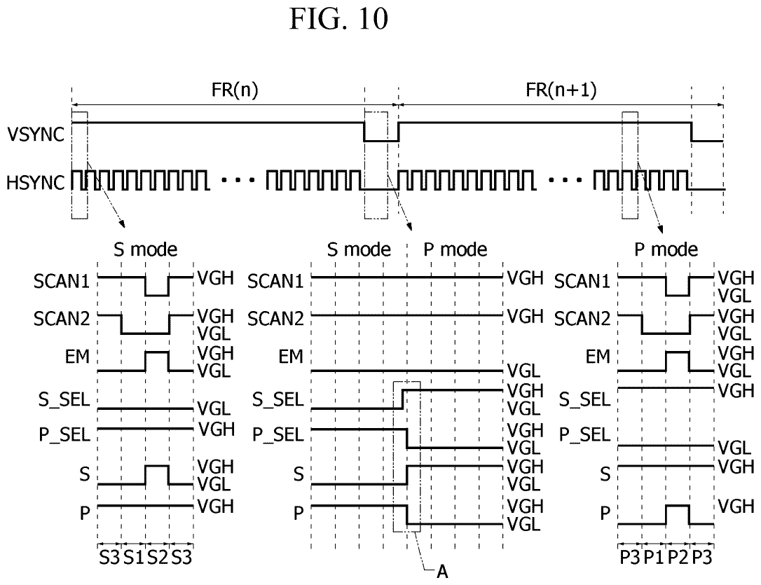

FIG. 10 is a waveform diagram illustrating an example in which pixels are driven in the first mode for an nth frame period and the pixels are driven in the second mode for an (n+1)th frame period.

Referring to FIG. 10, the viewing angle modes S and P can be selected for each frame period under the control of the timing controller 130. For example, the pixels can be driven in the first mode (S mode) for the nth frame period FR(n) and in the second mode (P mode) for (n+1)^{th} frame period FR(n+1).

During each frame, the waveforms of the gate signals SCAN1, SCAN2, and EM applied to the pixels for one horizontal period (1H) can be identical. In contrast, the mode selection signals S_SEL and P_SEL and the mode signals S and P can have different waveforms depending on the selected mode. For example, when a voltage of the first mode selection signal S_SEL generated during one horizontal period (1H) of the nth frame period FR(n) is the gate-on voltage VGL and a voltage of the second mode selection signal P_SEL is the gate-off voltage VGH, the pixels in the corresponding pixel line can be driven in the first mode (S mode) in response to the gate-on voltage VGL of the first mode signal S. Subsequently, when the voltage of the first mode selection signal S_SEL is the gate-off voltage VGH and the voltage of the second mode selection signal P_SEL is the gate-on voltage VGL at one horizontal period (1H) of the (n+1)^{th} frame period FR(n+1), the pixels in the corresponding pixel line can be driven in the second mode (P mode) in response to the gate-on voltage VGL of the second mode signal P.

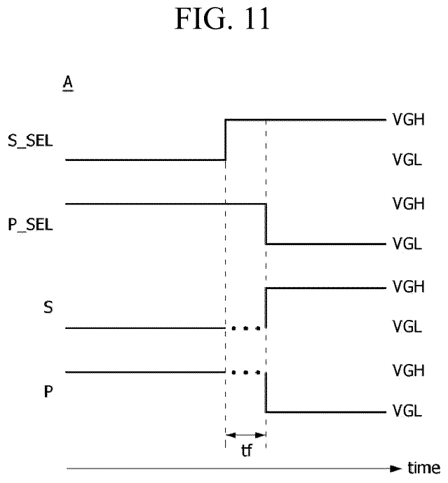

When the viewing angle mode is changed, the luminance of the pixels can fluctuate, causing the screen to appear abnormal on the display panel 100. The pixels can be controlled by waveforms in a portion marked as A in FIGS. 10 and 11 in the vertical blank period VB and/or the horizontal blank period HB so that the screen that appears abnormal is not visible when the viewing angle mode is switched.

Referring to FIGS. 2, 3, 10, and 11, when the viewing angle mode of the pixel is switched from the first mode (S mode) to the second mode (P mode), the voltage of the first mode selection signal S_SEL can be inverted to the gate-off voltage VGH during the vertical blank period VB and/or the horizontal blank period HB, and then the second mode selection signal P_SEL can be inverted to the gate-on voltage VGL. As a result, there occurs an interval tf in which both the first mode selection signal S_SEL and the second mode selection signal P_SEL are the gate-off voltage VGH, such that the first and second nodes n01 and n02 are floated. Subsequently, when the second mode selection signal P_SEL is inverted to the gate-on voltage VGL, the first node n01 can be charged to the gate-off voltage VGH and the second node n01 can be charged to the gate-on voltage VGL.

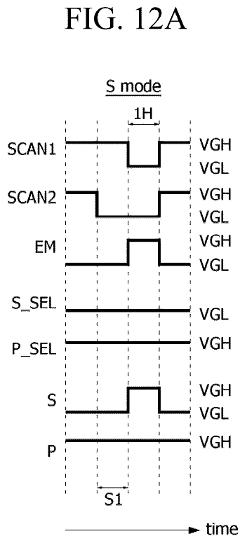

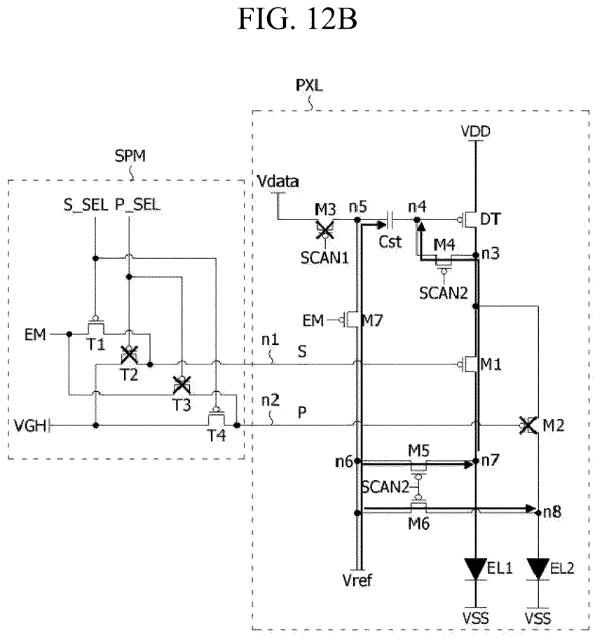

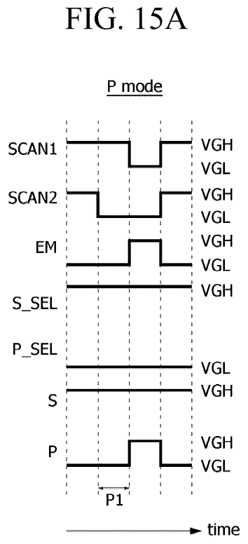

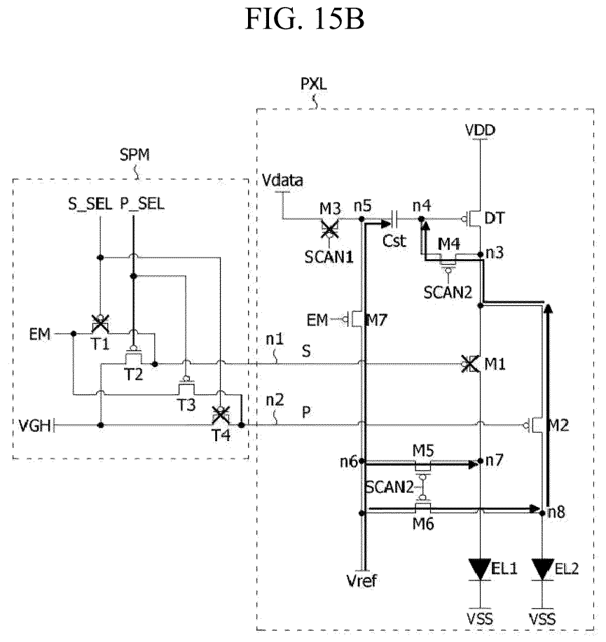

FIGS. 12A to 17B are diagrams illustrating the operation of a pixel circuit and a mode selection circuit in stages according to one embodiment of the present disclosure. In this embodiment, the pixel circuit includes a compensation circuit. FIGS. 12A to 14B illustrate an example in which the pixel circuit and the mode selection circuit operate in the first mode (S mode). FIGS. 15A to 17B illustrate an example in which the pixel circuit and the mode selection circuit operate in the second mode (P mode). In FIGS. 12A to 17B, detailed descriptions can be omitted for components that are substantially the same as the embodiments shown in FIGS. 2 and 3.

Referring to FIGS. 12A to 17B, the pixel circuit includes a first light-emitting element EL1, a second light-emitting element EL2, a driving element DT driving the light-emitting elements EL1 and EL2, a plurality of switch elements M1 to M7, and a capacitor Cst. The driving element DT and the switch elements M1 to M7 can be implemented as, but not limited to, p-channel transistors.

The pixel circuit is connected to the VDD node to which the pixel driving voltage VDD is applied, the VSS node to which the cathode voltage VSS is applied, and a REF node to which a reference voltage Vref is applied. The VDD node, the VSS node, and the REF node are connected to the corresponding power lines and thus commonly connected to all pixels. The pixel circuit can be connected to the mode selection circuit SPM through data lines to which the data voltage Vdata is applied, gate lines to which the gate signals SCAN1, SCAN2, and EM are applied, and first and second nodes n1 and n2.

The pixel driving voltage VDD can be set to a voltage that is higher than the maximum voltage of the data voltage Vdata and that enables the driving element DT to operate in a saturation region. The pixel driving voltage VDD is higher than the cathode voltage VSS. The reference voltage Vref can be set to a voltage that is lower than the minimum voltage of the data voltage Vdata and that is higher than the cathode voltage VSS. For example, but not limited to, the reference voltage Vref can be set to a voltage that is higher by one to two volts than the cathode voltage VSS. The gate-off voltage VGH can be set to a voltage higher than the pixel driving voltage VDD, and the gate-on voltages VGL can be set to a voltage lower than the cathode voltage VSS. For example, but not limited to, it can be set as VDD=15[V], VSS=3[V], Vref=3[V], VGH=16[V], and VGL=−9[V]. The data voltage Vdata of the pixel data can have a dynamic range between 2V and 7V. The higher the gray scale value of the pixel data, the lower the voltage level of the data voltage Vdata can be selected. The higher the grayscale value of the pixel data, the higher the luminance of the light-emitting elements EL1 and EL2 can be.

The first light-emitting element EL1 includes an anode electrode connected to a seventh node n7, and a cathode electrode to which the cathode voltage VSS is applied. The second light-emitting element EL2 includes an anode electrode connected to an eighth node n8, and a cathode electrode to which the cathode voltage VSS is applied. The first light-emitting element EL1 can be driven by a current from the driving element DT to emit light in the first mode (S mode). The second light-emitting element EL2 can be driven by a current from the driving element DT to emit light in the second mode (P mode).

The driving element DT includes a first electrode to which the pixel driving voltage VDD is applied, a gate electrode connected to a fourth node n4, and a second electrode connected to a third node n3. The driving element DT generates a current according to the gate-to-source voltage so that the first light-emitting element EL1 is driven in the first mode (S mode) and the second light-emitting element EL2 is driven in the second mode (P mode). The capacitor Cst is connected between the fourth node n4 and a fifth node n5.

A first switch element M1 is connected between the third node n3 and the seventh node n7, and is turned on in response to the gate-on voltage VGL of the first mode signal S applied through the first node n1. When the first switch element M1 is turned on, the third node n3 can be electrically connected to the seventh node n7. The first switch element M1 includes a first electrode connected to the third node n3, a gate electrode connected to the first node n1 to which the first mode signal S is applied, and a second electrode connected to the seventh node n7.

A second switch element M2 is connected between the third node n3 and the eighth node n8, and is turned on in response to the gate-on voltage VGL of the second mode signal P applied through the second node n2. When the second switch element M2 is turned on, the third node n3 can be electrically connected to the eighth node n8. The second switch element M2 includes a first electrode connected to the third node n3, a gate electrode connected to the second node n2 to which the second mode signal P is applied, and a second electrode connected to the eighth node n8.

A third switch element M3 is connected between a data line to which the data voltage Vdata of pixel data is applied and the fifth node n5, and is turned on in response to the gate-on voltage VGL of a first scan signal SCAN1. When the third switch element M3 is turned on, the data voltage Vdata can be applied to the fifth node n5. The third switch element M3 includes a first electrode to which the data voltage Vdata is applied, a gate electrode to which the first scan signal SCAN1 is applied, and a second electrode connected to the fifth node n5.

A fourth switch element M4 is connected between the third node n3 and the fourth node n4, and is turned on in response to the gate-on voltage VGL of a second scan signal SCAN2. When the fourth switch element M4 is turned on, the third node n3 can be electrically connected to the fourth node n4. The fourth switch element M4 includes a first electrode connected to the third node n3, a gate electrode to which the second scan signal SCAN2 is applied, and a second electrode connected to the fourth node n4.

A fifth switch element M5 is connected between the sixth node n6, to which the reference voltage Vref is applied, and the seventh node n7, and is turned on in response to the gate-on voltage VGL of the second scan signal SCAN2. When the fifth switch element M5 is turned on, the sixth node n6 can be electrically connected to the seventh node n7. The fifth switch element M5 includes a first electrode connected to the sixth node n6, a gate electrode to which the second scan signal SCAN2 is applied, and a second electrode connected to the seventh node n7.

A sixth switch element M6 is connected between the sixth node n6 and the eighth node n8, and is turned on in response to the gate-on voltage VGL of the second scan signal SCAN2. When the sixth switch element M6 is turned on, the sixth node n6 can be electrically connected to the eighth node n8. The sixth switch element M6 includes a first electrode connected to the sixth node n6, a gate electrode to which the second scan signal SCAN2 is applied, and a second electrode connected to the eighth node n8.

A seventh switch element M7 is connected between the fifth node n5 and the sixth node n6, and is turned on in response to the gate-on voltage VGL of an EM signal EM. When the seventh switch element M7 is turned on, the fifth node n5 can be electrically connected to the sixth node n6. The seventh switch element M7 includes a first electrode connected to the fifth node n5, a gate electrode to which the EM signal EM is applied, and a second electrode connected to the sixth node n6.

The mode selection circuit SPM includes a first mode switch element T1, a second mode switch element T2, a third mode switch element T3, and a fourth mode switch element T4. The mode switch elements T1, T2 to T3, and T4 can be implemented as, but are not limited to, p-channel transistors.

The first mode switch element T1 is connected between a node to which the EM signal is applied and the first node n1, and is turned on in response to the gate-on voltage VGL of the first mode selection signal S_SEL. The node to which the EM signal EM is applied can be connected to the output terminal of the third gate driver 123. When the first mode switch element T1 is turned on, the EM signal EM is applied to the first node n1 as the first mode signal S. The first mode switch element T1 includes a first electrode to which the EM signal EM is applied, a gate electrode to which the first mode selection signal S_SEL is applied, and a second electrode connected to the first node n1.

The second mode switch element T2 is connected between a VGH node to which the gate-off voltage VGH is applied and the first node n1, and is turned on in response to the gate-on voltage VGL of the second mode selection signal P_SEL. When the second mode switch element T2 is turned on, the gate-off voltage VGH is applied to the first node n1. The second mode switch element T2 includes a first electrode to which the gate-off voltage VGH is applied, a gate electrode to which the second mode selection signal P_SEL is applied, and a second electrode connected to the first node n1.

The third mode switch element T3 is connected between a node to which the EM signal is applied and the second node n2, and is turned on in response to the gate-on voltage VGL of the second mode selection signal P_SEL. When the third mode switch element T3 is turned on, the EM signal EM is applied to the second node n2 as the second mode signal P. The third mode switch element T3 includes a first electrode to which the EM signal EM is applied, a gate electrode to which the second mode selection signal P_SEL is applied, and a second electrode connected to the second node n2.

The fourth mode switch element T4 is connected between a VGH node, to which the gate-off voltage VGH is applied, and the second node n2, and is turned on in response to the gate-on voltage VGL of the first mode selection signal S_SEL. When the fourth mode switch element T4 is turned on, the gate-off voltage VGH is applied to the second node n2. The fourth mode switch element T4 includes a first electrode to which the gate-off voltage VGH is applied, a gate electrode to which the first mode selection signal S_SEL is applied, and a second electrode connected to the second node n2.

The pixel circuit can be driven in an initialization stage, a data writing and threshold voltage sampling stage, and a light emission stage. FIGS. 12A to 14B are diagrams illustrating the initialization stage, the data writing and threshold voltage sampling stage, and the light emission stage of the pixel circuit in stages in the first mode (S mode).

In the first mode (S mode), the voltage of the first mode selection signal S_SEL is the gate-on voltage VGL, while the voltage of the second mode selection signal P_SEL is the gate-off voltage VGH. Therefore, in the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate-off voltage VGH. The first mode signal S is an EM signal EM transmitted to the first node n1 in the first mode (S mode). The second mode signal P is the gate-off voltage VGH applied to the second node n2 in the first mode (S mode).

FIGS. 12A and 12B are a waveform and a circuit diagram, respectively, illustrating the initialization stage of the pixel circuit in the first mode (S mode). In the first mode (S mode), the initialization stage of the pixel circuit is performed during a first period S1.

Referring to FIGS. 12A and 12B, during the first period S1 of the first mode (S mode), a voltage of the first scan signal SCAN1 is the gate-off voltage VGH, and voltages of the second scan signal SCAN2 and the EM signal EM are the gate-on voltage VGL. During the first period S1 of the first mode (S mode), the fourth switch element M4, the fifth switch element M5, the sixth switch element M6, and the seventh switch element M7 of the pixel circuit PXL are turned on. During the first period S1 of the first mode (S mode), the third switch element M3 is turned off. In the first period S1 of the first mode (S mode), the driving element DT is turned on.

During the first period S1 of the first mode (S mode), the first switch element M1 of the pixel circuit PXL is turned on in response to the gate-on voltage VGL of the first mode signal S, and the second switch element M2 is turned off in response to the gate-off voltage VGH of the second mode signal P.

At the end of the first period S1 of the first mode (S mode), the reference voltage Vref is applied to fourth to eighth nodes n4, n5, n6, n7, and n8 to initialize the capacitor Cst and the light-emitting elements EL1 and EL2. During the first period S1 of the first mode (S mode), the light-emitting elements EL1 and EL2 are in the off state, not emitting light.

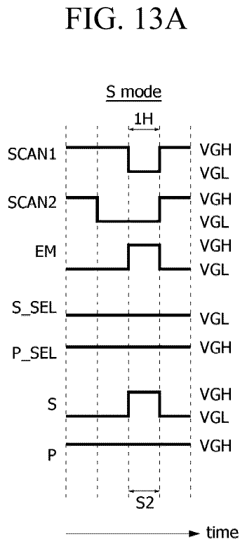

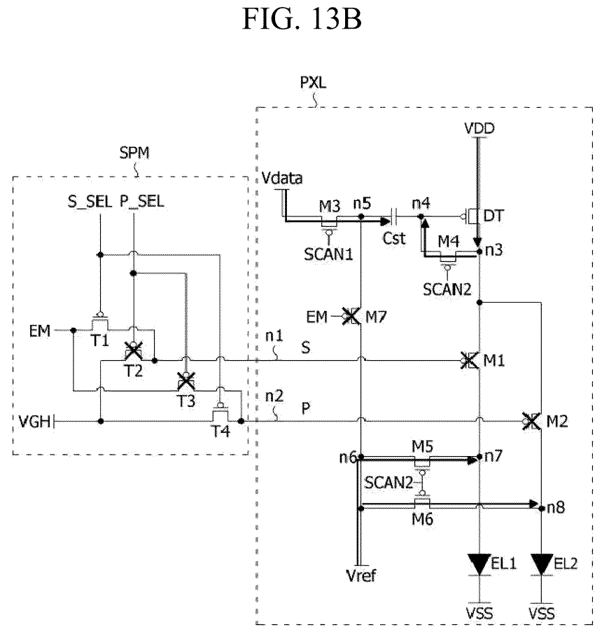

FIGS. 13A and 13B are a waveform and a circuit diagram, respectively, illustrating the data writing and threshold voltage sampling stage of the pixel circuit in the first mode (S mode). In the first mode (S mode), the data writing and threshold voltage sampling stage of the pixel circuit is performed during a second period S2. In the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate-off voltage VGH.

Referring to FIGS. 13A and 13B, during the second period S2 of the first mode (S mode), the voltages of the first scan signal SCAN1 and the second scan signal SCAN2 are the gate-on voltage VGL, and the voltage of the EM signal EM is the gate-off voltage VGH. During the second period S2 of the first mode (S mode), the third switch element M3, the fourth switch element M4, the fifth switch element M5, and the sixth switch element M6 of the pixel circuit PXL are turned on, and the seventh switch element M7 is turned off. In the second period S2 of the first mode (S mode), the data voltage Vdata of the pixel data is applied to the fifth node n5. At the end of the second period S2 of the first mode (S mode), the voltage of the fifth node n5 is the data voltage Vdata, and the voltage of the fourth node n4 is a voltage of VDD+Vth. Here, Vth is the threshold voltage of the driving element DT.

During the second period S2 of the first mode (S mode), the first switch element M1 of the pixel circuit PXL is turned off in response to the gate-off voltage VGH of the first mode signal S, and the second switch element M2 is in the off state according to the gate-off voltage VGH of the second mode signal P. During the second period S2 of the first mode (S mode), the light-emitting elements EL1 and EL2 are in the off state.

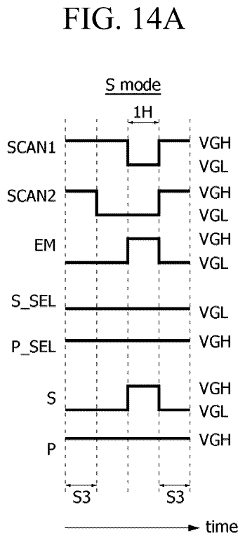

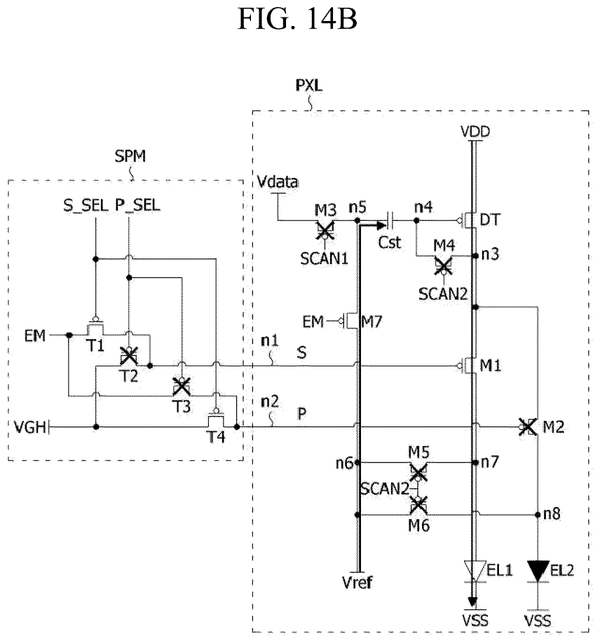

FIGS. 14A and 14B are a waveform and a circuit diagram, respectively, illustrating the light emission stage of the pixel circuit in the first mode (S mode). In the first mode (S mode), the light emission stage of the pixel circuit is performed during third periods S3. In the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate-off voltage VGH.

Referring to FIG. 14A and FIG. 14B, during the third periods S3 of the first mode (S mode), the voltages of the first scan signal SCAN1 and the second scan signal SCAN2 are the gate-off voltage VGH, and the voltage of the EM signal EM is the gate-on voltage VGL. During the third periods S3 of the first mode (S mode), the seventh switch element M7 of the pixel circuit PXL is turned on, while the third switch element M3, the fourth switch element M4, the fifth switch element M5, and the sixth switch element M6 are turned off. At the end of the third periods S3 of the first mode (S mode), the voltage of the fifth node n5 is the reference voltage Vref, and the voltage of the fourth node n4 is a voltage of Vref-Vdata+VDD+Vth.

During the third periods S3 of the first mode (S mode), the first switch element M1 of the pixel circuit PXL is turned on in response to the gate-on voltage VGL of the first mode signal S, and the second switch element M2 is in the off state according to the gate-off voltage VGH of the second mode signal P. During the third periods S3 of the first mode (S mode), a current generated according to the gate-to-source voltage of the driving element DT is supplied to the first light-emitting element EL1 through the first switch element M1. Therefore, during the third periods S3 of the first mode (S mode), the first light-emitting element EL1 can be lit by emitting light. During the third periods S3 of the first mode (S mode), the second light-emitting element EL2 is the off state.

FIGS. 15A to 17B are diagrams illustrating an initialization stage, a data writing and threshold voltage sampling stage, and a light emission stage of the pixel circuit in stages in the second mode (P mode). In the second mode (P mode), the voltage of the first mode selection signal S_SEL is the gate-off voltage VGH, while the voltage of the second mode selection signal P_SEL is the gate-on voltage VGL. Therefore, in the second mode (P mode), the first and fourth mode switch elements T1 and T4 are turned off, while the second and third mode switch elements T2 and T3 are turned on. As a result, in the second mode (P mode), the voltage of the EM signal EM is transmitted to the second node n2, while the first node n1 is held at the gate-off voltage VGH.

FIGS. 15A and 15B are a waveform and a circuit diagram, respectively, illustrating the initialization stage of the pixel circuit in the second mode (P mode). In the second mode (P mode), the initialization stage of the pixel circuit is performed during a first period P1.

Referring to FIG. 15A and FIG. 15B, during the first period P1 of the second mode (P mode), the voltage of the first scan signal SCAN1 is the gate-off voltage VGH, and the voltages of the second scan signal SCAN2 and the EM signal EM are the gate-on voltage VGL. During the first period P1 of the second mode (P mode), the fourth switch element M4, the fifth switch element M5, the sixth switch element M6, and the seventh switch element M7 of the pixel circuit PXL are turned on. During the first period P1 of the second mode (P mode), the third switch element M3 is turned off. In the first period P1 of the second mode (P mode), the driving element DT is turned on.

During the first period P1 of the second mode (P mode), the second switch element M2 of the pixel circuit PXL is turned on in response to the gate-on voltage VGL of the second mode signal P, and the first switch element M1 is turned off in response to the gate-off voltage VGH of the first mode signal S. Accordingly, at the end of the first period P1 of the second mode (P mode), the reference voltage Vref is applied to the fourth to eighth nodes n4, n5, n6, n7, and n8 to initialize the capacitor Cst and the light-emitting elements EL1 and EL2. During the first period P1 of the second mode (P mode), the light-emitting elements EL1 and EL2 are in the off state, not emitting light.

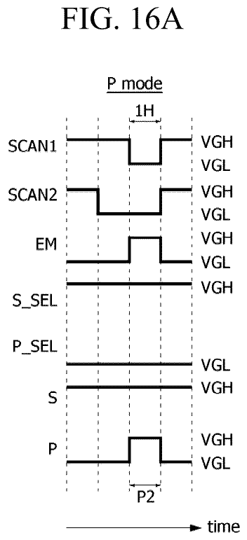

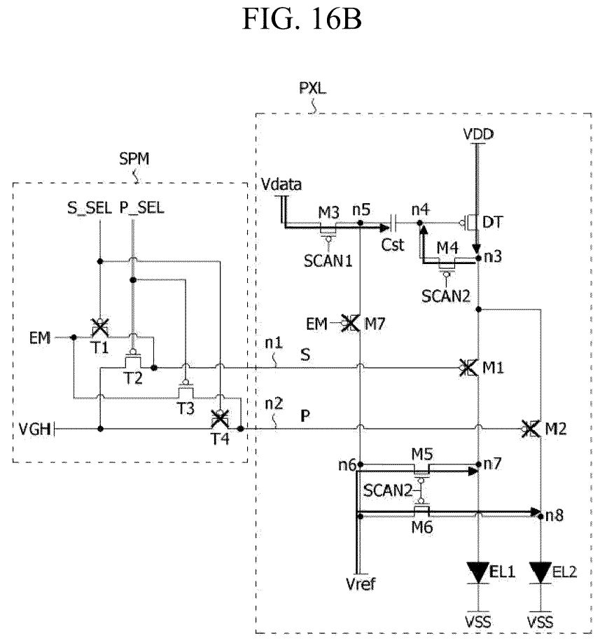

FIGS. 16A and 16B are a waveform and a circuit diagram, respectively, illustrating the data writing and threshold voltage sampling stage of the pixel circuit in the second mode (P mode). In the second mode (P mode), the data writing and threshold voltage sampling stage of the pixel circuit is performed during a second period P2. In the second mode (P mode), the first and fourth mode switch elements T1 and T4 are turned off, while the second and third mode switch elements T2 and T3 are turned on. As a result, in the second mode (P mode), the voltage of the EM signal EM is delivered to the second node n2, while the first node n1 is held at the gate-off voltage VGH.

Referring to FIGS. 16A and 16B, during the second period P2 of the second mode (P mode), the voltages of the first scan signal SCAN1 and the second scan signal SCAN2 are the gate-on voltage VGL, and the voltage of the EM signal EM is the gate-off voltage VGH. During the second period P2 of the second mode (P mode), the third switch element M3, the fourth switch element M4, the fifth switch element M5, and the sixth switch element M6 of the pixel circuit PXL are turned on, and the seventh switch element M7 is turned off. In the second period P2 of the second mode (P mode), the data voltage Vdata of pixel data is applied to the fifth node n5. At the end of the second period P2 of the second mode (P mode), the voltage of the fifth node n5 is the data voltage Vdata, and the voltage of the fourth node n4 is a voltage of VDD+Vth. Here, Vth is the threshold voltage of the driving element DT.

During the second period P2 of the second mode (P mode), the first switch element M1 of the pixel circuit PXL is turned off in response to the gate-off voltage VGH of the first mode signal S, and the second switch element M2 is in the off state according to the gate-off voltage VGH of the second mode signal P. During the second period P2 of the second mode (P mode), the light-emitting elements EL1 and EL2 are in the off state.

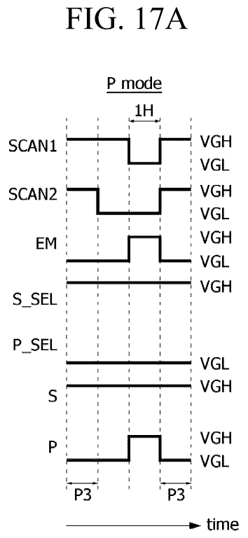

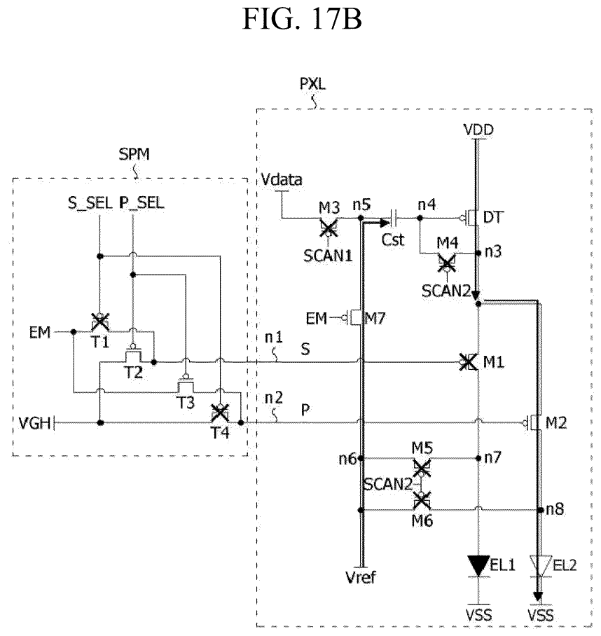

FIGS. 17A and 17B are a waveform and a circuit diagram, respectively, illustrating the light emission stage of the pixel circuit in the second mode (P mode). In the second mode (P mode), the light emission stage of the pixel circuit is performed during third periods P3. In the second mode (P mode), the first and fourth mode switch elements T1 and T4 are turned off, while the second and third mode switch elements T2 and T3 are turned on. As a result, in the second mode (P mode), the voltage of the EM signal EM is delivered to the second node n2, while the first node n1 is held at the gate-off voltage VGH.

Referring to FIG. 17A and FIG. 17B, during the third periods P3 of the second mode (P mode), the voltages of the first scan signal SCAN1 and the second scan signal SCAN2 are the gate-off voltage VGH, and the voltage of the EM signal EM is the gate-on voltage VGL. During the third periods P3 of the second mode (P mode), the seventh switch element M7 of the pixel circuit PXL is turned on, while the third switch element M3, the fourth switch element M4, the fifth switch element M5, and the sixth switch element M6 are turned off. At the end of the third periods P3 of the second mode (P mode), the voltage of the fifth node n5 is the reference voltage Vref, and the voltage of the fourth node n4 is a voltage of Vref-Vdata+VDD+Vth.

During the first periods P3 of the second mode (P mode), the second switch element M2 of the pixel circuit PXL is turned on in response to the gate-on voltage VGL of the second mode signal P, and the first switch element M1 is in the off state according to the gate-off voltage VGH of the first mode signal S. During the third periods P3 of the second mode (P mode), a current generated according to the gate-to-source voltage of the driving element DT is supplied to the second light-emitting element EL2 through the second switch element M2. Therefore, during the third periods P3 of the second mode (P mode), the second light-emitting element EL2 is lit by emitting light, while the first light-emitting element EL1 is in the off state.

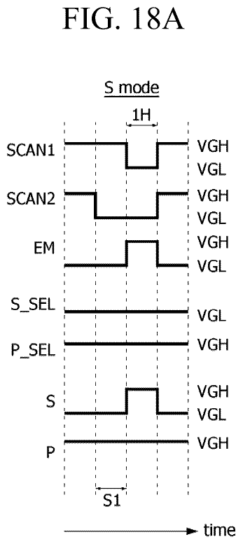

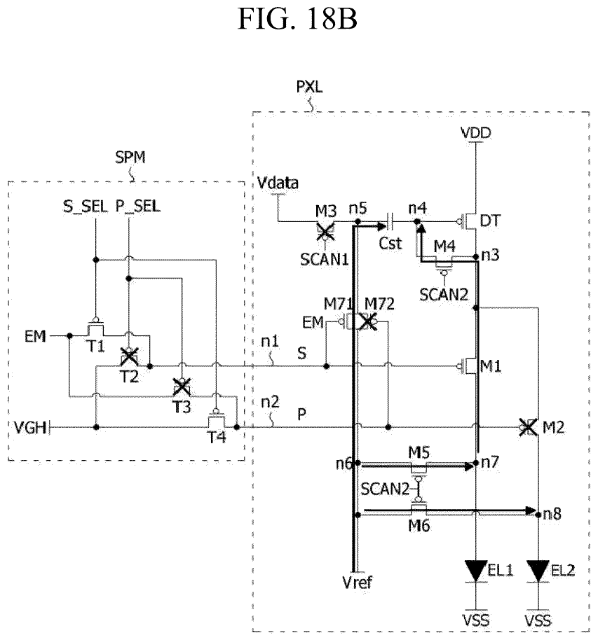

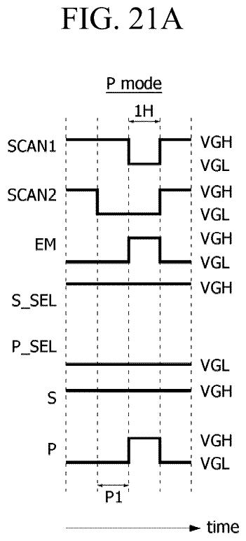

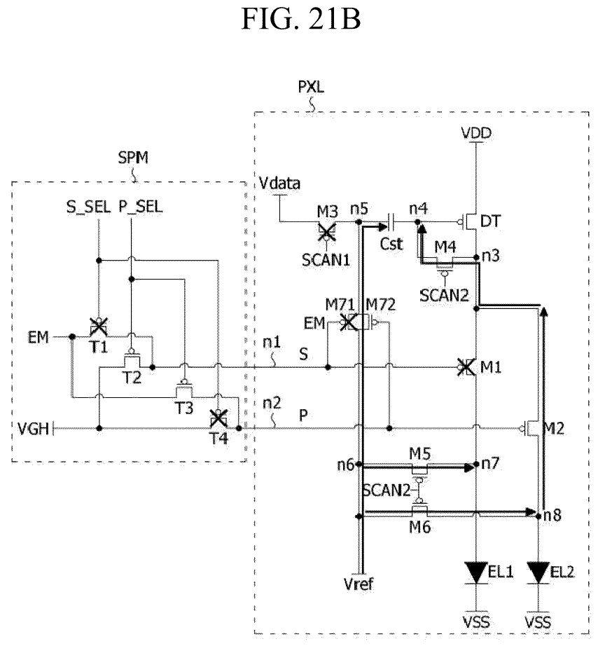

FIG. 18A to FIG. 23B are diagrams illustrating the operation of a pixel circuit and a mode selection circuit in stages according to another embodiment of the present disclosure. FIGS. 18A to 20B illustrate an example in which the pixel circuit and the mode selection circuit operate in the first mode (S mode). FIGS. 21A to 23B illustrate an example in which the pixel circuit and the mode selection circuit operate in the second mode (P mode). In FIGS. 18A to 23B, detailed descriptions can be omitted for components that are substantially the same as those of the above-described embodiments.

Referring to FIGS. 18A to 23B, the pixel circuit includes the first light-emitting element EL1, the second light-emitting element EL2, the driving element DT, the capacitor Cst, and a plurality of switch elements M1 to M72. The driving element DT and the switch elements M1 to M72 can be implemented as, but not limited to, p-channel transistors.

The first light-emitting element EL1 includes an anode electrode connected to a seventh electrode n7, and a cathode electrode to which the cathode voltage VSS is applied. The second light-emitting element EL2 includes an anode electrode connected to an eighth node n8, and a cathode electrode to which the cathode voltage VSS is applied. The first light-emitting element EL1 can be driven by a current from the driving element DT to emit light in the first mode (S mode). The second light-emitting element EL2 can be driven by a current from the driving element DT to emit light in the second mode (P mode). The driving element DT includes a first electrode to which the pixel driving voltage VDD is applied, a gate electrode connected to a fourth node n4, and a second electrode connected to a third node n3.

The first switch element M1 includes a first electrode connected to the third node n3, a gate electrode connected to the first node n1 to which the first mode signal S is applied, and a second electrode connected to the seventh node n7. The second switch element M2 includes a first electrode connected to the third node n3, a gate electrode connected to the second node n2 to which the second mode signal P is applied, and a second electrode connected to the eighth node n8.

The third switch element M3 includes a first electrode to which the data voltage Vdata is applied, a gate electrode to which the first scan signal SCAN1 is applied, and a second electrode connected to the fifth node n5. The fourth switch element M4 includes a first electrode connected to the third node n3, a gate electrode to which the second scan signal SCAN2 is applied, and a second electrode connected to the fourth node n4.

The fifth switch element M5 includes a first electrode connected to the sixth node n6, a gate electrode to which the second scan signal SCAN2 is applied, and a second electrode connected to the seventh node n7. The sixth switch element M6 includes a first electrode connected to the sixth node n6, a gate electrode to which the second scan signal SCAN2 is applied, and a second electrode connected to the eighth node n8.

A seventh-first switch element M71 is connected between the fifth node n5 and the sixth node n6, and is turned on in response to the gate-on voltage VGL of the first mode signal S. When the seventh-first switch element M71 is turned on, the fifth node n5 can be electrically connected to the sixth node n6. The seventh-first switch element M71 includes a first electrode electrically connected to the fifth node n5, a gate electrode electrically connected to the first node n1 to which the first mode signal S is applied, and a second electrode electrically connected to the sixth node n6.

A seventh-second switch element M72 is connected between the fifth node n5 and the sixth node n6, and is turned on in response to the gate-on voltage VGL of the second mode signal P. When the seventh-second switch element M72 is turned on, the fifth node n5 can be electrically connected to the sixth node n6. The seventh-second switch element M72 includes a first electrode electrically connected to the fifth node n5, a gate electrode electrically connected to the second node n2 to which the second mode signal P is applied, and a second electrode electrically connected to the sixth node n6.

The mode selection circuit SPM includes a first mode switch element T1, a second mode switch element T2, a third mode switch element T3, and a fourth mode switch element T4. The mode switch elements T1, T2 to T3, and T4 can be implemented as, but are not limited to, p-channel transistors.

The first mode switch element T1 includes a first electrode to which the EM signal EM is applied, a gate electrode to which the first mode selection signal S_SEL is applied, and a second electrode connected to the first node n1. The second mode switch element T2 includes a first electrode to which the gate-off voltage VGH is applied, a gate electrode to which the second mode selection signal P_SEL is applied, and a second electrode connected to the first node n1.

The third mode switch element T3 includes a first electrode to which the EM signal EM is applied, a gate electrode to which the second mode selection signal P_SEL is applied, and a second electrode connected to the second node n2. The fourth mode switch element T4 includes a first electrode to which the gate-off voltage VGH is applied, a gate electrode to which the first mode selection signal S_SEL is applied, and a second electrode connected to the second node n2.

The pixel circuit can be driven in an initialization stage, a data writing and threshold voltage sampling stage, and a light emission stage. FIGS. 18A to 20B are diagrams illustrating the initialization stage, the data writing and threshold voltage sampling stage, and the light emission stage of the pixel circuit in stages in the first mode (S mode).

In the first mode (S mode), the voltage of the first mode selection signal S_SEL is the gate-on voltage VGL, while the voltage of the second mode selection signal P_SEL is the gate-off voltage VGH. Therefore, in the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate-off voltage VGH. The first mode signal S is an EM signal EM transmitted to the first node n1 in the first mode (S mode). The second mode signal P is the gate-off voltage VGH applied to the second node n2 in the first mode (S mode).

FIGS. 18A and 18B are a waveform and a circuit diagram, respectively, illustrating the initialization stage of the pixel circuit in the first mode (S mode). In the first mode (S mode), the initialization stage of the pixel circuit is performed during a first period S1.

Referring to FIGS. 18A and 18B, during the first period S1 of the first mode (S mode), the voltage of the first scan signal SCAN1 is the gate-off voltage VGH, and the voltages of the second scan signal SCAN2 and the EM signal EM are the gate-on voltage VGL. During the first period S1 of the first mode (S mode), the fourth switch element M4, the fifth switch element M5, the sixth switch element M6, and the seventh-first switch element M71 of the pixel circuit PXL are turned on. The seventh-first switch element M71 is turned on in response to the gate-on voltage VGL of the first mode signal S during the first period S1 of the first mode (S mode). During the first period S1 of the first mode (S mode), the third switch element M3 and the seventh-second switch element M72 are turned off. The seventh-second switch element M72 is turned off in response to the gate-off voltage VGH of the second mode signal P during the first period S1 of the first mode (S mode). In the first period S1 of the first mode (S mode), the driving element DT is turned on.

During the first period S1 of the first mode (S mode), the first switch element M1 of the pixel circuit PXL is turned on in response to the gate-on voltage VGL of the first mode signal S, and the second switch element M2 is turned off in response to the gate-off voltage VGH of the second mode signal P.

At the end of the first period S1 of the first mode (S mode), the reference voltage Vref is applied to fourth to eighth nodes n4, n5, n6, n7, and n8 to initialize the capacitor Cst and the light-emitting elements EL1 and EL2. During the first period S1 of the first mode (S mode), the light-emitting elements EL1 and EL2 are in the off state, not emitting light.

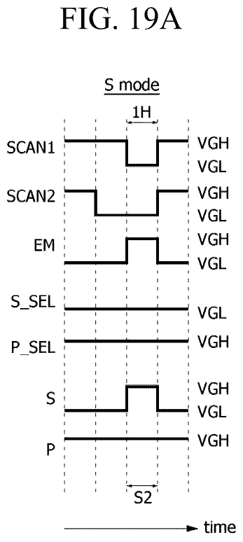

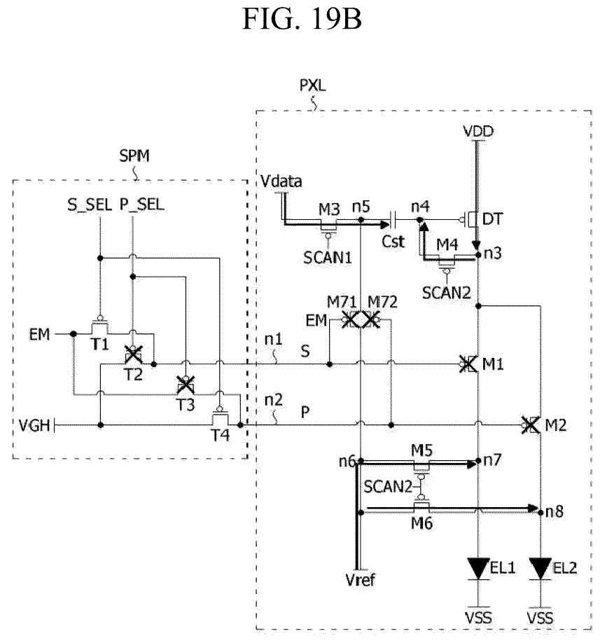

FIGS. 19A and 19B are a waveform and a circuit diagram, respectively, illustrating the data writing and threshold voltage sampling stage of the pixel circuit in the first mode (S mode). In the first mode (S mode), the data writing and threshold voltage sampling stage of the pixel circuit is performed during a second period S2. In the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate-off voltage VGH.

Referring to FIGS. 19A and 19B, during the second period S2 of the first mode (S mode), the voltages of the first scan signal SCAN1 and the second scan signal SCAN2 are the gate-on voltage VGL, and the voltage of the EM signal EM is the gate-off voltage VGH. During the second period S2 of the first mode (S mode), the third switch element M3, the fourth switch element M4, the fifth switch element M5, and the sixth switch element M6 of the pixel circuit PXL are turned on, and the seventh-first switch element M71 and the seventh-second switch element M72 are turned off. The seventh-first switch element M71 is turned off in response to the gate-off voltage VGH of the first mode signal S during the second period S2 of the first mode (S mode). The seventh-second switch element M72 is turned off in response to the gate-off voltage VGH of the second mode signal P during the second period S2 of the first mode (S mode).

In the second period S2 of the first mode (S mode), the data voltage Vdata of the pixel data is applied to the fifth node n5. At the end of the second period S2 of the first mode (S mode), the voltage of the fifth node n5 is the data voltage Vdata, and the voltage of the fourth node n4 is a voltage of VDD+Vth. Here, Vth is the threshold voltage of the driving element DT.

During the second period S2 of the first mode (S mode), the first switch element M1 of the pixel circuit PXL is turned off in response to the gate-off voltage VGH of the first mode signal S, and the second switch element M2 is in the off state according to the gate-off voltage VGH of the second mode signal P. During the second period S2 of the first mode (S mode), the light-emitting elements EL1 and EL2 are in the off state.

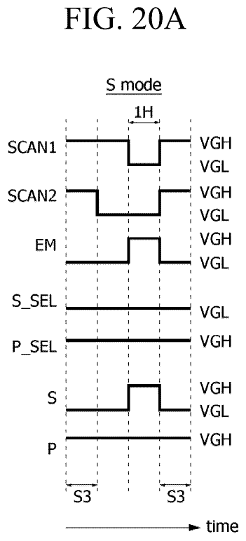

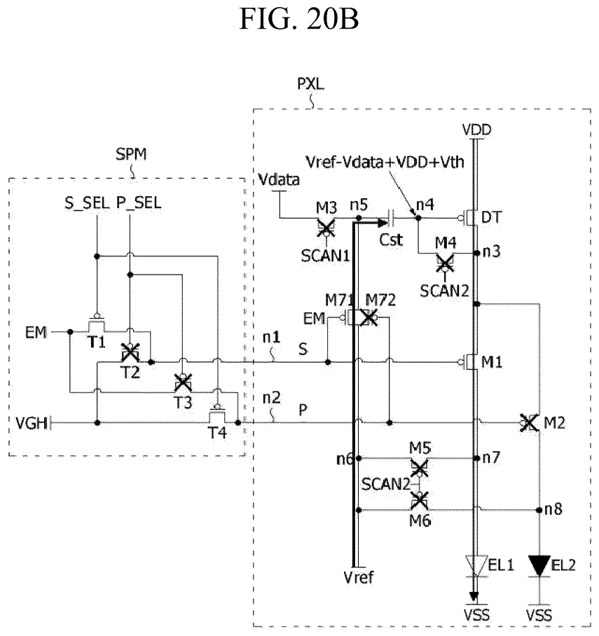

FIGS. 20A and 20B are a waveform and a circuit diagram, respectively, illustrating the light emission stage of the pixel circuit in the first mode (S mode). In the first mode (S mode), the light emission stage of the pixel circuit is performed during third periods S3. In the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate-off voltage VGH.

Referring to FIG. 20A and FIG. 20B, during the third periods S3 of the first mode (S mode), the voltages of the first scan signal SCAN1 and the second scan signal SCAN2 are the gate-off voltage VGH, and the voltage of the EM signal EM is the gate-on voltage VGL. During the third periods S3 of the first mode (S mode), the seventh-first switch element M71 of the pixel circuit PXL is turned on in response to the gate-on voltage VGL of the first mode signal S, while the third switch element M3, the fourth switch element M4, the fifth switch element M5, and the sixth switch element M6 are turned off. The seventh-second switch element M72 is turned off in response to the gate-off voltage VGH of the second mode signal P during the third periods S3 of the first mode (S mode). At the end of the third periods S3 of the first mode (S mode), the voltage of the fifth node n5 is the reference voltage Vref, and the voltage of the fourth node n4 is a voltage of Vref-Vdata+VDD+Vth.

During the third periods S3 of the first mode (S mode), the first switch element M1 of the pixel circuit PXL is turned on in response to the gate-on voltage VGL of the first mode signal S, and the second switch element M2 is in the off state according to the gate-off voltage VGH of the second mode signal P. During the third periods S3 of the first mode (S mode), a current generated according to the gate-to-source voltage of the driving element DT is supplied to the first light-emitting element EL1 through the first switch element M1. Therefore, during the third periods S3 of the first mode (S mode), the first light-emitting element EL1 can be lit by emitting light. During the third periods S3 of the first mode (S mode), the second light-emitting element EL2 is the off state.

FIGS. 21A to 23B are diagrams illustrating the initialization stage, the data writing and threshold voltage sampling stage, and the light emission stage of the pixel circuit in stages in the second mode (P mode).

In the second mode (P mode), the voltage of the first mode selection signal S_SEL is the gate-off voltage VGH, while the voltage of the second mode selection signal P_SEL is the gate-on voltage VGL. Therefore, in the second period (P mode), the second and third mode switch elements T2 and T3 are turned on, while the first and fourth mode switch elements T1 and T4 are turned off. As a result, in the second mode (P mode), the voltage of the EM signal EM is transmitted to the second node n2, while the first node n1 is held at the gate-off voltage VGH. The second mode signal P is the EM signal EM transmitted to the second node n2 in the second mode (P mode). The first mode signal S is the gate-off voltage VGH applied to the first node n1 in the second mode (P mode).

FIGS. 21A and 21B are a waveform and a circuit diagram, respectively, illustrating the initialization stage of the pixel circuit in the second mode (P mode). In the second mode (P mode), the initialization stage of the pixel circuit is performed during a first period P1.

Referring to FIGS. 21A and 21B, during the first period P1 of the second mode (P mode), the voltage of the first scan signal SCAN1 is the gate-off voltage VGH, and the voltages of the second scan signal SCAN2 and the EM signal EM are the gate-on voltage VGL. During the first period P1 of the second mode (P mode), the fourth switch element M4, the fifth switch element M5, the sixth switch element M6, and the seventh-second switch element M72 of the pixel circuit PXL are turned on. The seventh-second switch element M72 is turned on in response to the gate-on voltage VGL of the second mode signal P during the first period P1 of the second mode (P mode). During the first period P1 of the second mode (P mode), the third switch element M3 and the seventh-first switch element M71 are turned off. The seventh-first switch element M71 is turned off in response to the gate-off voltage VGH of the first mode signal S during the first period P1 of the second mode (P). In the first period P1 of the second mode (P mode), the driving element DT is turned on.

During the first period P1 of the second mode (P mode), the second switch element M2 of the pixel circuit PXL is turned on in response to the gate-on voltage VGL of the second mode signal P, and the first switch element M1 is turned off in response to the gate-off voltage VGH of the first mode signal S.

At the end of the first period P1 of the second mode (P mode), the reference voltage Vref is applied to the fourth to eighth nodes n4, n5, n6, n7, and n8 to initialize the capacitor Cst and the light-emitting elements EL1 and EL2. During the first period P1 of the second mode (P mode), the light-emitting elements EL1 and EL2 are in the off state, not emitting light.

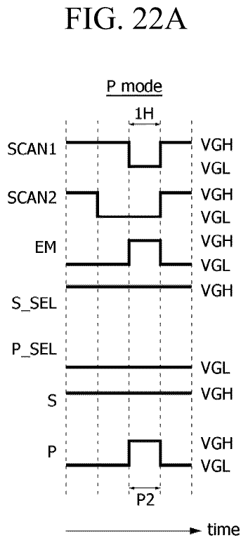

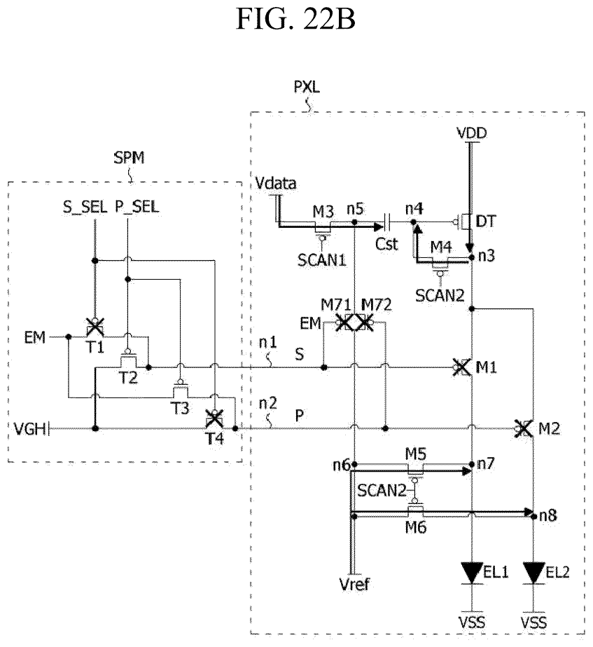

FIGS. 22A and 22B are a waveform and a circuit diagram, respectively, illustrating the data writing and threshold voltage sampling stage of the pixel circuit in the second mode (P mode). In the second mode (P mode), the data writing and threshold voltage sampling stage of the pixel circuit is performed during a second period P2. In the second mode (P mode), the second and third mode switch elements T2 and T3 are turned on, while the first and fourth mode switch elements T1 and T4 are turned off. As a result, in the second mode (P mode), the voltage of the EM signal EM is transmitted to the second node n2, while the first node n1 is held at the gate-off voltage VGH.

Referring to FIGS. 22A and 22B, during the second period P2 of the second mode (P mode), the voltages of the first scan signal SCAN1 and the second scan signal SCAN2 are the gate-on voltage VGL, and the voltage of the EM signal EM is the gate-off voltage VGH. During the second period P2 of the second mode (P mode), the third switch element M3, the fourth switch element M4, the fifth switch element M5, and the sixth switch element M6 of the pixel circuit PXL are turned on, and the seventh-first switch element M71 and the seventh-second switch element M72 are turned off. The seventh-first switch element M71 is turned off in response to the gate-off voltage VGH of the first mode signal S during the second period P2 of the second mode (P mode). The seventh-second switch element M72 is turned off in response to the gate-off voltage VGH of the second mode signal P during the second period P2 of the second mode (P mode).

In the second period P2 of the second mode (P mode), the data voltage Vdata of pixel data is applied to the fifth node n5. At the end of the second period P2 of the second mode (P mode), the voltage of the fifth node n5 is the data voltage Vdata, and the voltage of the fourth node n4 is a voltage of VDD+Vth. Here, Vth is the threshold voltage of the driving element DT.

During the second period P2 of the second mode (P mode), the first switch element M1 of the pixel circuit PXL is turned off in response to the gate-off voltage VGH of the first mode signal S, and the second switch element M2 is in the off state according to the gate-off voltage VGH of the second mode signal P. During the second period P2 of the second mode (P mode), the light-emitting elements EL1 and EL2 are in the off state.

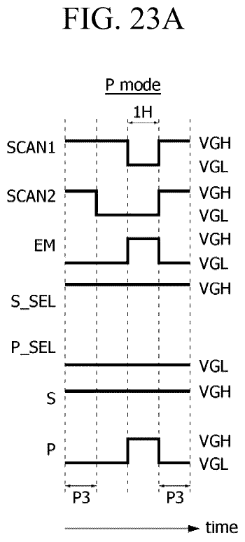

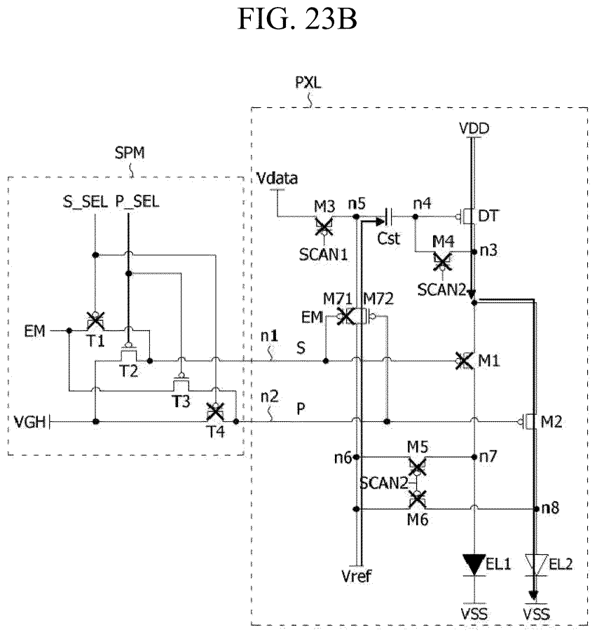

FIGS. 23A and 23B are a waveform and a circuit diagram, respectively, illustrating the light emission stage of the pixel circuit in the second mode (P mode). In the second mode (P mode), the light emission stage of the pixel circuit is performed during third periods P3. In the second mode (P mode), the second and third mode switch elements T2 and T3 are turned on, while the first and fourth mode switch elements T1 and T4 are turned off. As a result, in the second mode (P mode), the voltage of the EM signal EM is transmitted to the second node n2, while the first node n1 is held at the gate-off voltage VGH.

Referring to FIGS. 23A and 23B, during the third periods P3 of the second mode (P mode), the voltages of the first scan signal SCAN1 and the second scan signal SCAN2 are the gate-off voltage VGH, and the voltage of the EM signal EM is the gate-on voltage VGL. During the third periods P3 of the second mode (P mode), the seventh-second switch element M72 of the pixel circuit PXL is turned on in response to the gate-on voltage VGL of the second mode signal P, while the third switch element M3, the fourth switch element M4, the fifth switch element M5, and the sixth switch element M6 are turned off. The seventh-first switch element M71 is turned off according to the gate-off voltage VGH of the first mode signal S during the second periods P3 of the second mode (P mode). At the end of the third periods P3 of the second mode (P mode), the voltage of the fifth node n5 is the reference voltage Vref, and the voltage of the fourth node n4 is a voltage of Vref-Vdata+VDD+Vth.

During the third periods P3 of the second mode (P mode), the second switch element M2 of the pixel circuit PXL is turned on in response to the gate-on voltage VGL of the second mode signal P, and the first switch element M1 is in the off state according to the gate-off voltage VGH of the first mode signal S. During the third periods P3 of the second mode (P mode), a current generated according to the gate-to-source voltage of the driving element DT is supplied to the second light-emitting element EL2 through the second switch element M2. Therefore, during the third periods P3 of the second mode (P mode), the second light-emitting element EL2 is lit and the first light-emitting element EL1 is in the off state.

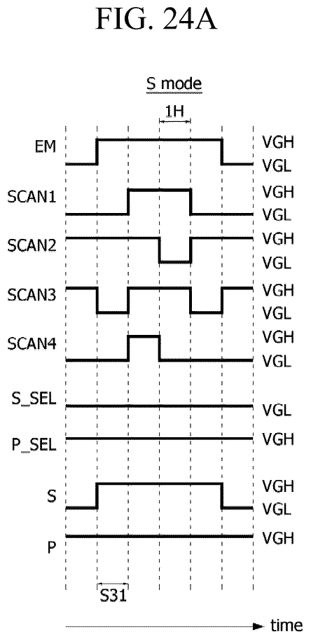

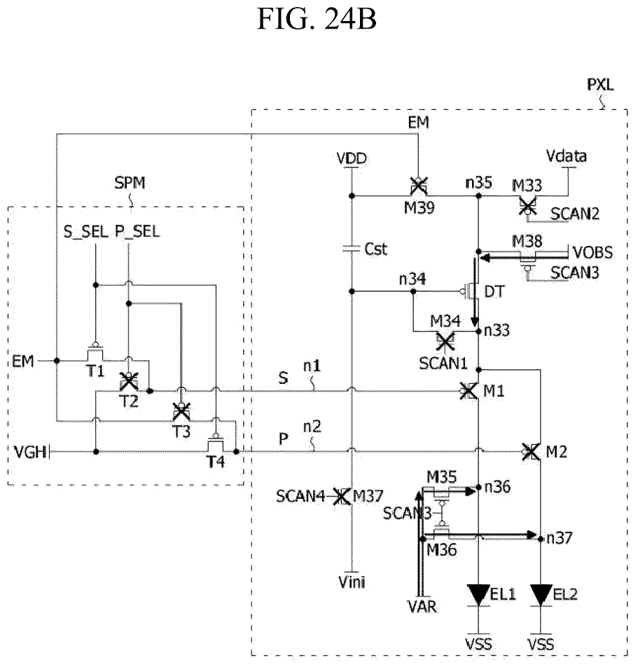

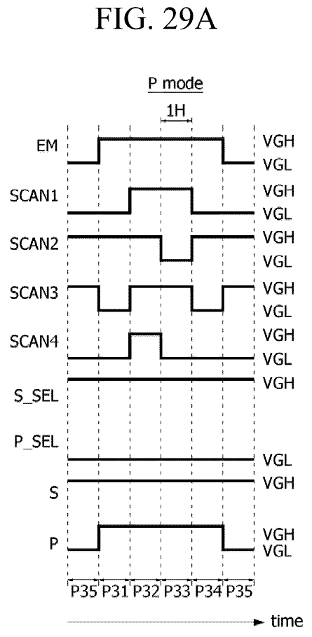

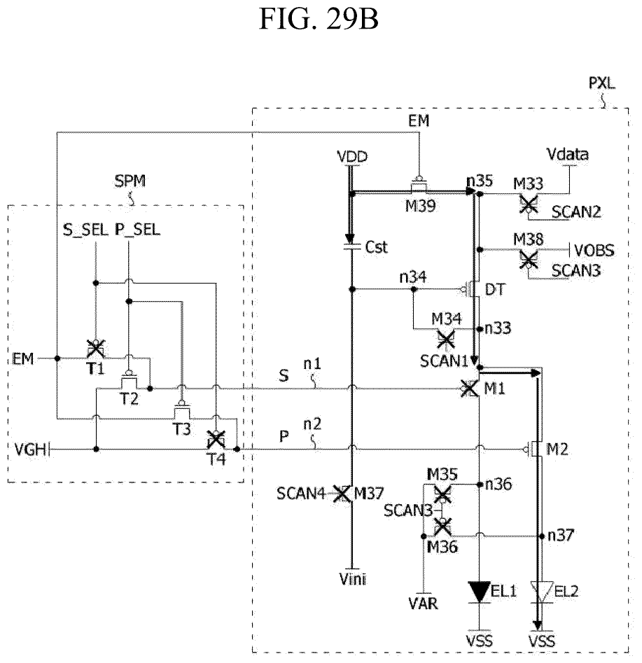

FIGS. 24A to 29B are diagrams illustrating the operation of a pixel circuit and a mode selection circuit in stages according to another embodiment of the present disclosure. FIGS. 24A to 28B illustrate an example in which the pixel circuit and mode selection circuit operate in the first mode (S mode). FIGS. 29A to 29B illustrate an example in which the pixel circuit and the mode selection circuit operate in the light emission stage of the second mode (P mode). The pixel circuit according to this embodiment can be driven at a variable refresh rate (VRR) under the control of the timing controller 130. The timing controller 130 can reduce power consumption of the display device by analyzing the input image and lowering the refresh rate when the input image does not change by a preset amount of time. The timing controller 130 can lower the refresh rate of the pixels when the display device is in a standby mode or in response to a user command. The refresh rate can be lowered on an always on display (AOD) screen. The AOD screen is a small area of pixels in the display area AA in which preset information, for example, brief information such as remaining battery power, time, and the like are displayed in the standby mode.

Referring to FIGS. 24A to 29B, the pixel circuit includes a first light-emitting element EL1, a second light-emitting element EL2, a driving element DT, a capacitor Cst, and a plurality of switch elements M1, M2, M33 to M39. The driving element DT and the switch elements M1, M2, M33, M35, M36, M38, and M39 can be implemented as an p-channel transistor. Fourth and seventh transistors M34 and M37 can be implemented as an n-channel transistor. The switch elements M1, M2, M33, M35, M36, M38, and M39, implemented as p-channel transistors, can be turned on in response to a gate low voltage VGL and turned off in response to a gate high voltage VGH.

The switch elements M34 and M37, implemented as n-channel transistors, can be turned on in response to the gate high voltage VGH and turned off in response to the gate low voltage VGL. In FIGS. 24A to 29B, the gate on/off voltage is described as the gate high/low voltage in consideration of a channel type of the transistor.

The pixel circuit can be connected to a VDD node to which a pixel driving voltage VDD is applied, a VSS node to which a cathode voltage VSS is applied, an REF node to which a reference voltage Vref is applied, an INI node to which an initialization voltage Vini is applied, an OBS node to which a first compensation voltage VOBS is applied, and an VAR node to which a second compensation voltage VAR is applied. The VDD, VSS, REF, INI, OBS, and VAR nodes can be connected to the corresponding power lines and can be commonly connected to all pixels. The pixel circuit can be connected to a mode selection circuit SPM via data lines to which a data voltage Vdata is applied, gate lines to which gate signals SCAN1, SCAN2, SCAN3, SCAN4, and EM are applied, and first and second nodes n1 and n2. The compensation voltages VOBS and VAR can prevent luminance fluctuations when the refresh rate of the pixels is varied.

A first light-emitting element EL1 includes an anode electrode connected to a sixth electrode n36, and a cathode electrode to which the cathode voltage VSS is applied. A second light-emitting element EL2 includes an anode electrode connected to a seventh node n37, and a cathode electrode to which the cathode voltage VSS is applied. The first light-emitting element EL1 can be driven by a current from the driving element DT to emit light in the first mode (S mode). The second light-emitting element EL2 can be driven by a current from the driving element DT to emit light in the second mode (P mode).

The driving element DT includes a first electrode connected to a fifth node n35, a second electrode connected to a third node n33, and a gate electrode connected to a fourth node n34. The driving element DT generates a current according to the gate-to-source voltage so that the first light-emitting element EL1 is driven in the first mode (S mode) and the second light-emitting element EL2 is driven in the second mode (P mode). The capacitor Cst is connected between the VDD node, to which the pixel driving voltage VDD is applied, and the fourth node n34.

A first switch element M1 is connected between the third node n33 and the sixth node n36, and is turned on in response to the gate low voltage VGL of a first mode signal S applied through the first node n1. When the first switch element M1 is turned on, the third node n33 can be electrically connected to the sixth node n36. The first switch element M1 includes a first electrode connected to the third node n33, a gate electrode connected to the first node n1 to which the first mode signal S is applied, and a second electrode connected to the sixth node n36.

A second switch element M2 is connected between the third node n33 and the seventh node n37, and is turned on in response to the gate low voltage VGL of the second mode signal P applied through the second node n2. When the second switch element M2 is turned on, the third node n33 can be electrically connected to the seventh node n37. The second switch element M2 includes a first electrode connected to the third node n33, a gate electrode connected to the second node n2 to which the second mode signal P is applied, and a second electrode connected to the seventh node n37.

A third switch element M33 is connected between the data line, to which the data voltage Vdata of pixel data is applied, and the fifth node n35, and is turned on in response to the gate low voltage VGL of a second scan signal SCAN2. When the third switch element M33 is turned on, the data voltage Vdata can be applied to the fifth node n35. The third switch element M33 includes a first electrode to which the data voltage Vdata is applied, a gate electrode to which the second scan signal SCAN2 is applied, and a second electrode connected to the fifth node n35.

A fourth switch element M34 is connected between the third node n33 and the fourth node n34, and is turned on in response to the gate high voltage VGH of the first scan signal SCAN1. When the fourth switch element M34 is turned on, the third node n33 can be electrically connected to the fourth node n34. The fourth switch element M34 includes a first electrode connected to the third node n33, a gate electrode to which the first scan signal SCAN1 is applied, and a second electrode connected to the fourth node n34.

A fifth switch element M35 is connected between the VAR node to which the second compensation voltage VAR is applied and the sixth node n36, and is turned on in response to the gate low voltage VGL of a third scan signal SCAN3. When the fifth switch element M35 is turned on, the second compensation voltage VAR can be applied to the sixth node n36. The fifth switch element M35 includes a first electrode electrically connected to the VAR node to which the second compensation voltage VAR is applied, a gate electrode to which the third scan signal SCAN3 is applied, and a second electrode connected to the sixth node n36.

A sixth switch element M36 is connected between the VAR node, to which the second compensation voltage VAR is applied, and the seventh node n37, and is turned on in response to the gate low voltage VGL of the third scan signal SCAN3. When the sixth switch element M36 is turned on, the second compensation voltage VAR can be applied to the seventh node n37. The sixth switch element M36 includes a first electrode to which the second compensation voltage VAR is applied, a gate electrode to which the third scan signal SCAN3 is applied, and a second electrode connected to the seventh node n37.

A seventh switch element M37 is connected between the INI node, to which the initialization voltage Vini is applied, and the fourth node n34, and is turned on in response to the gate high voltage VGH of a fourth scan signal SCAN4. When the seventh switch element M37 is turned on, the initialization voltage Vini can be applied to the fourth node n34. The seventh switch element M37 includes a first electrode to which the initialization voltage Vini is applied, a gate electrode to which the fourth scan signal SCAN4 is applied, and a second electrode connected to the fourth node n34.

An eighth switch element M38 is connected between an OBS node, to which the first compensation voltage VOBS is applied, and the fifth node n35, and is turned on in response to the gate low voltage VGL of the third scan signal SCAN3. When the eighth switch element M38 is turned on, the first compensation voltage VOBS can be applied to the fifth node n35. The eighth switch element M38 includes a first electrode to which the first compensation voltage VOBS is applied, a gate electrode to which the third scan signal SCAN3 is applied, and a second electrode connected to the fifth node n35.

A ninth switch element M39 is connected between the VDD node to which the pixel driving voltage VDD is applied and the fifth node n35, and is turned on in response to the gate low voltage VGL of the EM signal EM. When the ninth switch element M39 is turned on, the pixel driving voltage VDD can be applied to the fifth node n35. The ninth switch element M39 includes a first electrode connected to the VDD node to which the pixel driving voltage VDD is applied, a gate electrode to which the EM signal EM is applied, and a second electrode connected to the fifth node n35.

The mode selection circuit SPM includes a first mode switch element T1, a second mode switch element T2, a third mode switch element T3, and a fourth mode switch element T4. The mode switch elements T1, T2 to T3, and T4 can be implemented as, but are not limited to, p-channel transistors.

The first mode switch element T1 is connected between a node to which the EM signal is applied and the first node n1, and is turned on in response to the gate low voltage VGL of the first mode selection signal S_SEL. The node to which the EM signal EM is applied can be connected to the output terminal of the third gate driver 123. When the first mode switch element T1 is turned on, the EM signal EM is applied to the first node n1 as the first mode signal S. The first mode switch element T1 includes a first electrode to which the EM signal EM is applied, a gate electrode to which the first mode selection signal S_SEL is applied, and a second electrode connected to the first node n1.

The second mode switch element T2 is connected between a VGH node to which the gate high voltage VGH is applied and the first node n1, and is turned on in response to the gate low voltage VGL of the second mode selection signal P_SEL. When the second mode switch element T2 is turned on, the gate high voltage VGH can be applied to the first node n1 such that the first switch element M1 is turned off. The second mode switch element T2 includes a first electrode to which the gate high voltage VGH is applied, a gate electrode to which the second mode selection signal P_SEL is applied, and a second electrode connected to the first node n1.

The third mode switch element T3 is connected between a node to which the EM signal is applied and the second node n2, and is turned on in response to the gate low voltage VGL of the second mode selection signal S_SEL. When the third mode switch element T3 is turned on, the EM signal EM is applied to the second node n2 as the second mode signal P. The third mode switch element T3 includes a first electrode to which the EM signal EM is applied, a gate electrode to which the second mode selection signal P_SEL is applied, and a second electrode connected to the second node n2.

The fourth mode switch element T4 is connected between a VGH node to which the gate high voltage VGH is applied and the second node n2, and is turned on in response to the gate low voltage VGL of the first mode selection signal S_SEL. When the fourth mode switch element T4 is turned on, the gate high voltage VGH can applied to the second node n2 so that the second switch element M2 is turned off. The fourth mode switch element T4 includes a first electrode to which the gate high voltage VGH is applied, a gate electrode to which the first mode selection signal S_SEL is applied, and a second electrode connected to the second node n2.

The pixel circuit illustrated in FIGS. 24A to 29B can be driven in a first reset stage, an initialization stage, a data writing and threshold voltage sampling stage, a second reset stage, and a light emitting stage. FIGS. 24A to 28B are diagrams illustrating the operation of the pixel circuit in stages in the first mode (S mode). In the light emission stage of the first mode (S mode), the first light-emitting element EL1 is emitted. FIGS. 29A and 29B are diagrams illustrating the light emission stage of the pixel circuit in the second mode (P mode).

In the first mode (S mode), the voltage of the first mode selection signal S_SEL is the gate low voltage VGL, while the voltage of the second mode selection signal P_SEL is the gate high voltage VGH. Therefore, in the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate high voltage VGH. The first mode signal S is an EM signal EM transmitted to the first node n1 in the first mode (S mode). The second mode signal P is the gate high voltage VGH applied to the second node n2 in the first mode (S mode).

FIGS. 24A and 24B are a waveform and a circuit diagram, respectively, illustrating the first reset stage of the pixel circuit in the first mode (S mode). The first reset stage of the first mode (S mode) is performed during a first period S31.

Referring to FIGS. 24A and 24B, during the first period S31 of the first mode (S mode), the voltages of first, three and fourth scan signals SCAN1, SCAN3, and SCAN4 are the gate low voltage VGL, and the voltages of the second scan signal SCAN2 and the EM signal EM are the gate high voltage VGH. During the first period S31 of the first mode (S mode), the voltages of the first and second mode signals S and P are the gate high voltage VGH.

During the first period S31 of the first mode (S mode), the fifth switch element M35, the sixth switch element M36, and the eighth switch element M38 of the pixel circuit PXL are turned on, and the other switch elements M1, M2, M33, M34, M37, and M39 are turned off. During the first period S31 of the first mode (S mode), the first compensation voltage VOBS is applied to the fifth node n35 to turn on the driving element DT. During the first period S31 of the first mode (S mode), the second compensation voltage VAR is applied to the sixth and seventh nodes n36 and n37 through the turned-on fifth and sixth switch elements M35 and M36. During the first period S31 of the first mode (S mode), the light-emitting elements EL1 and EL2 are in the off state.

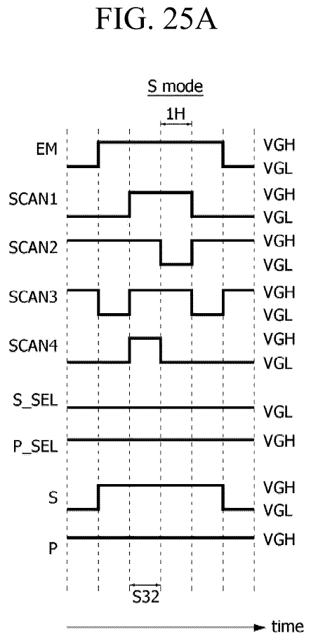

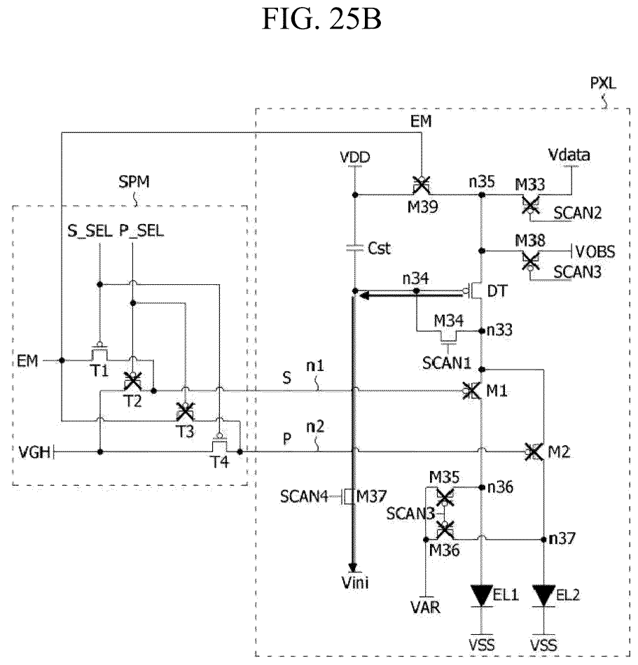

FIGS. 25A and 25B are a waveform and a circuit diagram, respectively, illustrating the initialization stage of the pixel circuit in the first mode (S mode). The initialization stage of the first mode (S mode) is performed during a second period S32. In the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate high voltage VGH.

Referring to FIGS. 25A and 25B, the voltages of the first, second, third, and fourth scan signals SCAN1, SCAN2, SCAN3, and SCAN4 and the EM signal EM are the gate high voltage VGH during the second period S32 of the first mode (S mode). During the second period S32 of the first mode (S mode), the voltages of the first and second mode signals S and P are the gate high voltage VGH.

During the second period S32 of the first mode (S mode), the fourth and seventh switch elements M34 and M37 of the pixel circuit PXL are turned on, and the other switch elements M1, M2, M33, M35, M36, M38, and M39 are turned off. During the second period S32 of the first mode (S mode), the initialization voltage Vini is applied to the fourth node n34 to initialize the capacitor Cst. During the second period S32 of the first mode (S mode), the light-emitting elements EL1 and EL2 are in the off state.

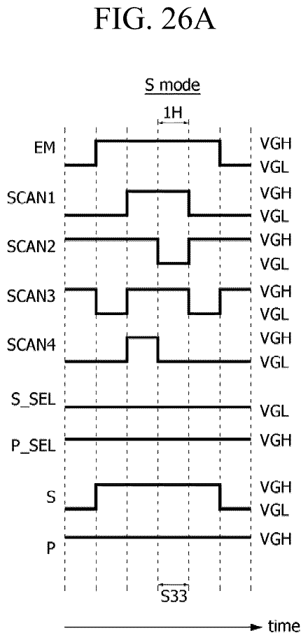

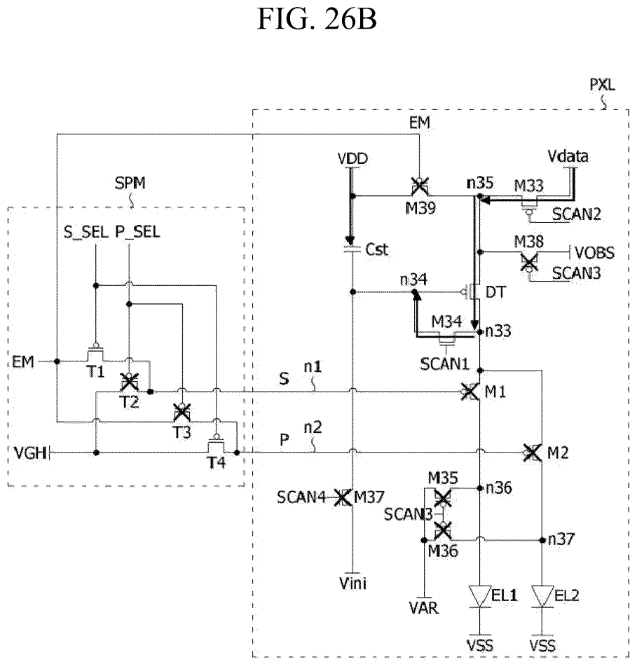

FIGS. 26A and 26B are a waveform and a circuit diagram, respectively, illustrating the data writing and threshold voltage sampling stage of the pixel circuit first mode (S mode). The data writing and threshold voltage sampling stage of the first mode (S mode) is performed during a third period S33. In the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate high voltage VGH.

Referring to FIG. 26A and FIG. 26B, during the third period S33 of the first mode (S mode), the voltages of the first and third scan signals SCAN1 and SCAN3 are the gate high voltage VGH and the voltages of the second and fourth scan signals SCAN2 and SCAN4 are the gate low voltage VGL. During the third period S33 of the first mode (S mode), the voltage of the EM signal EM is the gate high voltage VGH. During the third period S33 of the first mode (S mode), the voltages of the first and second mode signals S and P are the gate high voltage VGH.

During the third period S33 of the first mode (S mode), the third and fourth switch elements M33 and M34 of the pixel circuit PXL are turned on, while the other switch elements M1, M2, M35, M36, M37, M38, and M39 are turned off. At the end of the third period S33 of the first mode (S mode), the voltage of the third and fifth nodes n33 and n35 is the data voltage Vdata, and the voltage of the fourth node n34 is a voltage of Vdata+Vth. During the third period S33 of the first mode (S mode), the light-emitting elements EL1 and EL2 are off.

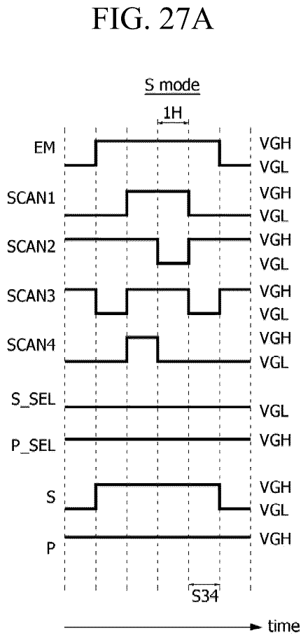

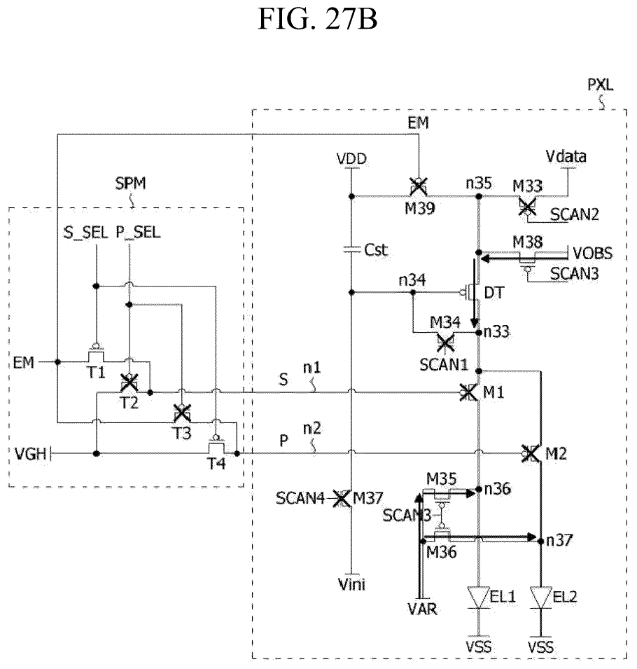

FIGS. 27A and 27B are a waveform and a circuit diagram, respectively, illustrating the second reset stage of the pixel circuit in the first mode (S mode). The second reset stage of the first mode (S mode) is performed during a fourth period S34.

Referring to FIGS. 27A and 27B, during the fourth period S34 of the first mode (S mode), the voltages of the first, three and fourth scan signals SCAN1, SCAN3, and SCAN4 are the gate low voltage VGL, and the voltages of the second scan signal SCAN2 and the EM signal EM are the gate high voltage VGH. During the fourth period S34 of the first mode (S mode), the voltage of the first and second mode signals S and P is the gate high voltage VGH.

During the fourth period S34 of the first mode (S mode), the fifth switch element M35, the sixth switch element M36, and the eighth switch element M38 of the pixel circuit PXL are turned on, and the other switch elements M1, M2, M33, M34, M37, and M39 are turned off. In the fourth period S34 of the first mode (S mode), the first compensation voltage VOBS is applied to the fifth node n35 to turn on the driving element DT. During the fourth period S34 of the first mode (S mode), the second compensation voltage VAR is applied to the sixth and seventh nodes n36 and n37. During the fourth period S34 of the first mode (S mode), the light-emitting elements EL1 and EL2 are in the off state.

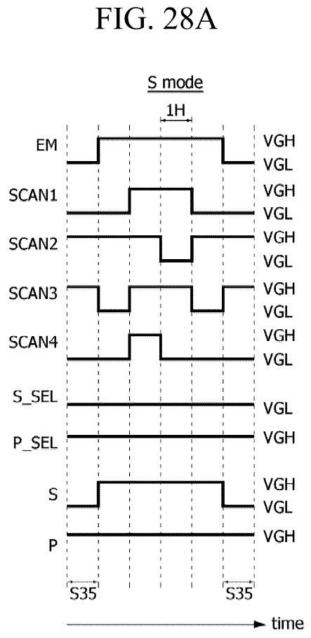

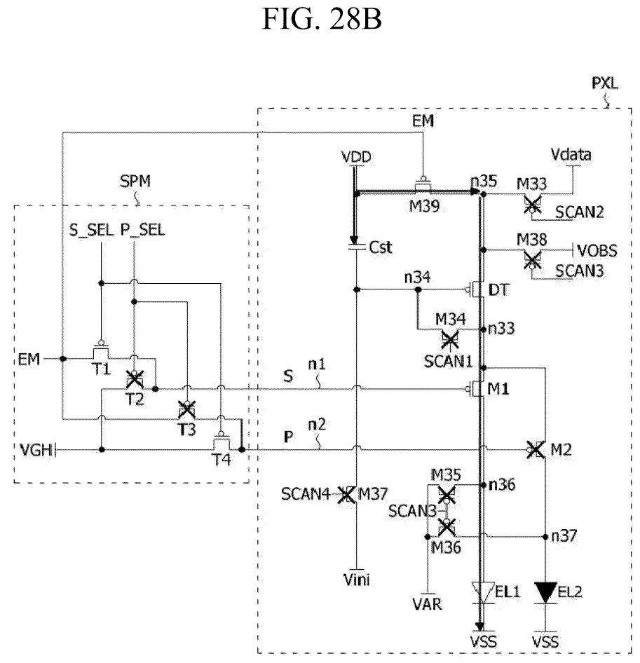

FIGS. 28A and 28B are a waveform and a circuit diagram, respectively, illustrating the light emission stage of the pixel circuit in the first mode (S mode). In the first mode (S mode), the light emission stage of the pixel circuit is performed during fifth periods S35. In the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate high voltage VGH.

Referring to FIG. 28A and FIG. 28B, during the fifth periods S35 of the first mode (S mode), the voltages of the first and fourth scan signals SCAN1 and SCAN4 are the gate low voltage VGL, and the voltages of the second and third scan signals SCAN2 and SCAN3 are the gate high voltage VGH. During the fifth periods S35, the voltage of the EM signal EM is the gate low voltage VGL.

During the fifth periods S35 of the first mode (S mode), the first switch element M1 and the ninth switch element M39 of the pixel circuit PXL are turned on, while the other switch elements M2, M33, M34, M35, M36, M37, and M38 are turned off. During the fifth periods S35 of the first mode (S mode), the voltage of the fourth node n34 is a voltage of Vdata+Vth. During the fifth periods S35 of the first mode (S mode), the first light-emitting element EL1 is lit and the second light-emitting element EL2 is in the off state.

In the second mode (P mode), the method of internal compensation before the pixel circuit emits light can be the same method as in the first mode (S mode). In the second mode (P mode), as shown in FIG. 29A, the pixel circuit can be driven in a first reset stage P31, an initialization stage P32, a data writing and threshold voltage sampling stage P33, and a second reset stage P34, before emitting light. In a light emission stage P35 of the second mode (P mode), the second light-emitting element EL2 is emitted.

FIGS. 29A and 29B are a waveform and a circuit diagram, respectively, illustrating the light emission stage of the pixel circuit in the second mode (P mode). In the second mode (P mode), the light emission stage of the pixel circuit is performed during the fifth periods P35. In the second mode (P mode), the first and fourth mode switch elements T1 and T4 are turned off, while the second and third mode switch elements T2 and T3 are turned on. As a result, in the second mode (P mode), the voltage of the EM signal EM is transmitted to the second node n2, while the first node n1 is held at the gate high voltage VGH.

Referring to FIG. 29A and FIG. 29B, during fifth periods P35 of the second mode (P mode), the voltage of the first and fourth scan signals SCAN1 and SCAN4 is the gate low voltage VGL, and the voltage of the second and third scan signals SCAN2 and SCAN3 is the gate high voltage VGH. During fifth periods P35, the voltage of the EM signal EM is the gate low voltage VGL.

During the fifth periods P35 of the second mode (P mode), the second switch element M2 and the ninth switch element M39 of the pixel circuit PXL are turned on, while the other switch elements M1, M33, M34, M35, M36, M37, and M38 are turned off. During the fifth periods P35 of the second mode (P mode), the voltage of the fourth node n34 is a voltage of Vdata+Vth. During the fifth periods P35 of the second mode (P mode), the second light-emitting element EL2 is lit and the first light-emitting element EL1 is in the off state.

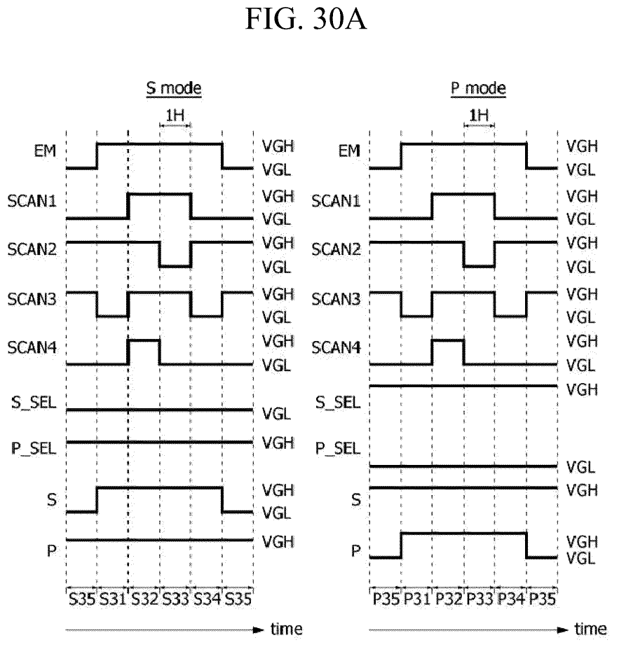

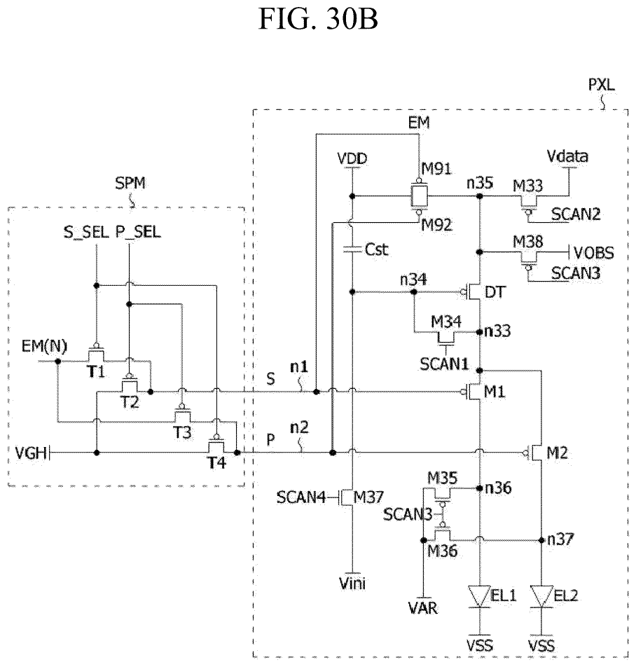

FIGS. 30A and 30B are diagrams illustrating a pixel circuit and a mode selection circuit, and signals applied to these circuits, in accordance with another embodiment of the present disclosure. The pixel circuit and the mode selection circuit according to this embodiment are driven in a first reset stage S31, P31, an initialization stage S32, P32, a data writing and threshold voltage sampling stage S33, P33, a second reset stage S34, P34, and a light emission stage S35, P35 in each of the first and second modes (S mode and P mode), similar to the pixel circuits shown in FIGS. 24A to 29B. In the pixel circuit and the mode selection circuit according to this embodiment, the components that are substantially the same as those of the embodiment shown in FIGS. 24A to 29B are designated by the same reference numerals and are not described in detail.

Referring to FIGS. 30A and 30B, the pixel circuit includes a ninth-first switch element M91 and a ninth-second switch element M92 connected between the VDD node and the fifth node n35.

The ninth-first switch element M91 is turned on in response to the gate low voltage VGL of the first mode signal S to apply the pixel driving voltage VDD to the fifth node n35. The ninth-first switch element M91 includes a first electrode connected to the VDD node to which the pixel driving voltage VDD is applied, a gate electrode connected to the first node n1 to which the first mode signal S is applied, and a second electrode connected to the fifth node n35.

The ninth-second switch element M92 is turned on in response to the gate low voltage VGL of the second mode signal P to apply the pixel driving voltage VDD to the fifth node n35. The ninth-second switch element M92 includes a first electrode connected to the VDD node to which the pixel driving voltage VDD is applied, a gate electrode connected to the second node n2 to which the second mode signal P is applied, and a second electrode connected to the fifth node n35.

In the first mode (S mode), the EM signal EM at the first node n1 is transmitted to a gate electrode of the ninth-first switch element M91 as the first mode signal S, and the second node n2 is held at the gate high voltage VGH. In the second mode (P mode), the EM signal EM at the second node n2 is transmitted to a gate electrode of the ninth-second switch element M92 as the second mode signal P, and the first node n1 is held at the gate high voltage VGH. Accordingly, the ninth-first and ninth-second switch elements M91 and M92 can form a current path between the VDD node and the driving element DT in response to the gate low voltage VGL of the EM signal EM in the light emission stages S35 and P35.

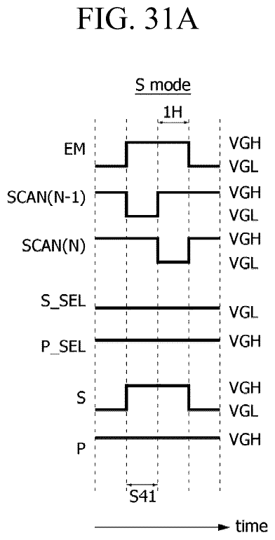

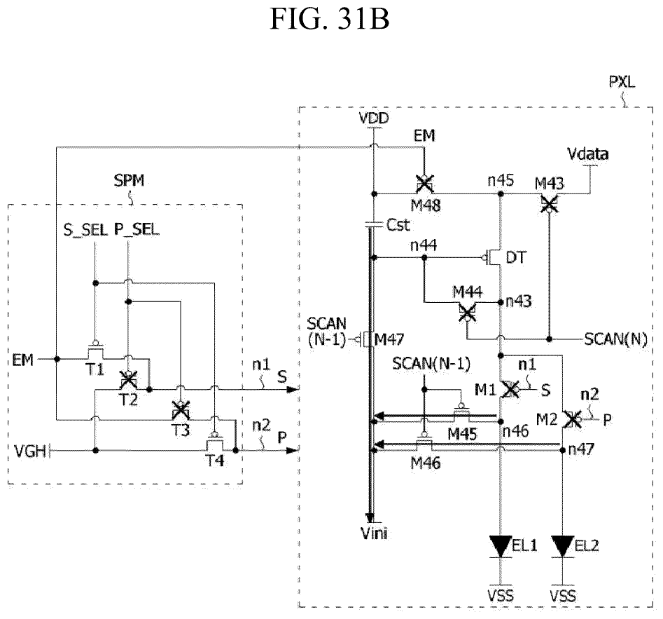

FIGS. 31A to 34B are diagrams illustrating the operation of a pixel circuit and a mode selection circuit in stages according to another embodiment of the present disclosure.

Referring to FIGS. 31A to 34B, the pixel circuit includes a first light-emitting element EL1, a second light-emitting element EL2, a driving element DT, a capacitor Cst, and a plurality of switch elements M1, M2, M43 to M48. The driving element DT and the switch elements M1, M2, M43 to M48 can be implemented as, but not limited to, p-channel transistors.

A first light-emitting element EL1 includes an anode electrode connected to a sixth electrode n46, and a cathode electrode to which the cathode voltage VSS is applied. A second light-emitting element EL2 includes an anode electrode connected to a seventh node n47, and a cathode electrode to which the cathode voltage VSS is applied. The first light-emitting element EL1 can be driven by a current from the driving element DT to emit light in the first mode (S mode). The second light-emitting element EL2 can be driven by a current from the driving element DT to emit light in the second mode (P mode).

The driving element DT includes a first electrode connected to a fifth node n45, a second electrode connected to a third node n43, and a gate electrode connected to a fourth node n44. The driving element DT generates a current according to the gate-to-source voltage so that the first light-emitting element EL1 is driven in the first mode (S mode) and the second light-emitting element EL2 is driven in the second mode (P mode). The capacitor Cst is connected between the VDD node to which the pixel driving voltage VDD is applied and the fourth node n44.

A first switch element M1 is connected between a third node n43 and a sixth node n46, and is turned on in response to the gate-on voltage VGL of the first mode signal S applied through a first node n1. When the first switch element M1 is turned on, the third node n43 can be electrically connected to the sixth node n46. The first switch element M1 includes a first electrode connected to the third node n43, a gate electrode connected to the first node n1 to which the first mode signal S is applied, and a second electrode connected to the sixth node n46.

A second switch element M2 is connected between the third node n43 and a seventh node n47, and is turned on in response to the gate-on voltage VGL of the second mode signal P applied through a second node n2. When the second switch element M2 is turned on, the third node n43 can be electrically connected to the seventh node n47. The second switch element M2 includes a first electrode connected to the third node n43, a gate electrode connected to the second node n2 to which the second mode signal P is applied, and a second electrode connected to the seventh node n47.

A third switch element M43 is connected between the data line to which the data voltage Vdata of pixel data is applied and a fifth node n45, and is turned on in response to a gate-on voltage VGL of an Nth scan signal SCAN(N). When the third switch element M43 is turned on, the data voltage Vdata can be applied to the fifth node n45. The third switch element M43 includes a first electrode to which the data voltage Vdata is applied, a gate electrode to which the Nth scan signal SCAN(N) is applied, and a second electrode connected to the fifth node n45.

A fourth switch element M44 is connected between the third node n43 and the fourth node n44, and is turned on in response to the gate-on voltage VGL of the Nth scan signal SCAN(N). When the fourth switch element M44 is turned on, the third node n43 can be electrically connected to the fourth node n44. The fourth switch element M44 includes a first electrode connected to the third node n43, a gate electrode to which the Nth scan signal SCAN(N) is applied, and a second electrode connected to the fourth node n44.

A fifth switch element M45 is connected between the INT node to which the initialization voltage Vini is applied and the sixth node n46, and is turned on in response to the gate-on voltage VGL of an (N−1)^{th} scan signal SCAN(N−1). When the fifth switch element M45 is turned on, the sixth node n46 can be initialized to the initialization voltage Vini. The fifth switch element M45 includes a first electrode connected to the INI node to which the initialization voltage Vini is applied, a gate electrode to which the (N−1)th scan signal SCAN(N−1) is applied, and a second electrode connected to the sixth node n46.

A sixth switch element M46 is connected between the INI node to which the initialization voltage Vini is applied and the seventh node n47, and is turned on in response to the gate-on voltage VGL of the (N−1)^{th} scan signal SCAN(N−1). When the sixth switch element M46 is turned on, the seventh node n47 can be initialized to the initialization voltage Vini. The sixth switch element M46 includes a first electrode connected to the INI node to which the initialization voltage Vini is applied, a gate electrode to which the (N−1)th scan signal SCAN(N−1) is applied, and a second electrode connected to the seventh node n47.

A seventh switch element M47 is connected between the INI node to which the initialization voltage Vini is applied and the fourth node n44, and is turned on in response to the gate-on voltage VGL of the (N−1)^{th} scan signal SCAN(N−1). When the seventh pixel switch element M47 is turned on, the capacitor Cst can be initialized. The seventh switch element M47 includes a first electrode connected to the INI node to which the initialization voltage Vini is applied, a gate electrode to which the (N−1)th scan signal SCAN(N−1) is applied, and a second electrode connected to the fourth node n44.

An eighth switch element M48 is connected between the VDD node to which the pixel driving voltage is applied and the fifth node n45, and is turned on in response to the gate-on voltage VGL of the EM signal EM. When the eighth pixel switch element M48 is turned on, a current path is formed between the VDD node and the driving element DT. The eighth switch element M48 includes a first electrode connected to the VDD node to which the pixel driving voltage VDD is applied, a gate electrode to which the EM signal EM is applied, and a second electrode connected to the fifth node n45.

The mode selection circuit SPM includes a first mode switch element T1, a second mode switch element T2, a third mode switch element T3, and a fourth mode switch element T4. The mode switch elements T1, T2 to T3, and T4 can be implemented as, but are not limited to, p-channel transistors.

When the first mode switch element T1 is turned on, the EM signal EM is applied to the first node n1 as the first mode signal S. The first mode switch element T1 includes a first electrode to which the EM signal EM is applied, a gate electrode to which the first mode selection signal S_SEL is applied, and a second electrode connected to the first node n1.

When the second mode switch element T2 is turned on, the gate-off voltage VGH is applied to the first node n1. The second mode switch element T2 includes a first electrode to which the gate-off voltage VGH is applied, a gate electrode to which the second mode selection signal P_SEL is applied, and a second electrode connected to the first node n1.

When the third mode switch element T3 is turned on, the EM signal EM is applied to the second node n2 as the second mode signal P. The third mode switch element T3 includes a first electrode to which the EM signal EM is applied, a gate electrode to which the second mode selection signal P_SEL is applied, and a second electrode connected to the second node n2.

When the fourth mode switch element T4 is turned on, the gate-off voltage VGH is applied to the second node n2. The fourth mode switch element T4 includes a first electrode to which the gate-off voltage VGH is applied, a gate electrode to which the first mode selection signal S_SEL is applied, and a second electrode connected to the second node n2.

The pixel circuit can be driven in an initialization stage, a data writing and threshold voltage sampling stage, and a light emission stage. FIGS. 31A to 33B are diagrams illustrating an initialization stage, a data writing and threshold voltage sampling stage, and a light emission stage of the pixel circuit in stages in the first mode (S mode). In the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate-off voltage VGH.

FIGS. 31A and 31B are a waveform and a circuit diagram, respectively, illustrating the initialization stage of the pixel circuit in the first mode (S mode). In the first mode (S mode), the initialization stage of the pixel circuit is performed during a first period S41.

Referring to FIGS. 31A and 31B, during the first period S41 of the first mode (S mode), the voltage of the (N−1)^{th} scan signal SCAN(N−1) is the gate-on voltage VGL, and the voltages of the Nth scan signal SCAN(N) and the EM signal EM are the gate-off voltage VGH.

During the first period S41 of the first mode (S mode), the fifth switch element M45, the sixth switch element M46, and the seventh switch element M47 of the pixel circuit PXL are turned on, and the other switch elements M1, M2, M43, M44, and M48 are turned off. In the first period S41 of the first mode (S mode), the driving element DT is turned on.

During the first period S41 of the first mode (S mode), the first switch element M1 of the pixel circuit PXL is turned off in response to the gate-off voltage VGH of the first mode signal S, and the second switch element M2 is turned off in response to the gate-off voltage VGH of the second mode signal P.

At the end of the first period S41 of the first mode (S mode), the capacitor Cst and the light-emitting elements EL1 and EL2 are initialized. During the first period S41 of the first mode (S mode), the light-emitting elements EL1 and EL2 are in the off state, not emitting light.

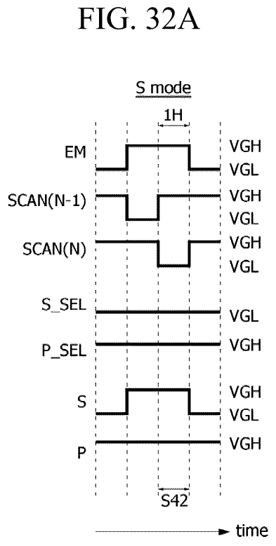

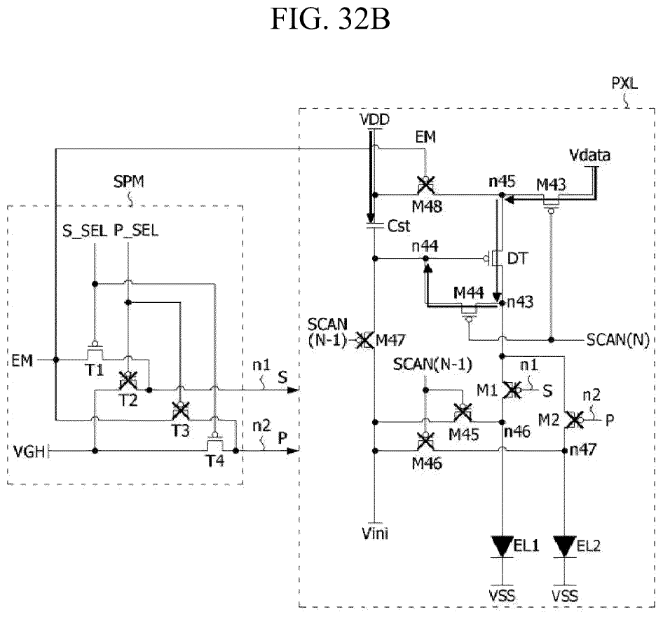

FIGS. 32A and 32B are a waveform and a circuit diagram, respectively, illustrating the data writing and threshold voltage sampling stage of the pixel circuit in the first mode (S mode). In the first mode (S mode), the data writing and threshold voltage sampling stage of the pixel circuit is performed during a second period S42. In the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate-off voltage VGH.

Referring to FIGS. 32A and 32B, during the second period S42 of the first mode (S mode), the voltage of the Nth scan signal SCAN(N) is the gate-on voltage VGL, and the voltages of the (N−1)th scan signal SCAN(N−1) and the EM signal EM are the gate-off voltage VGH. During the second period S42 of the first mode (S mode), the third and fourth switch elements M43 and M44 of the pixel circuit PXL are turned on, and the other switch elements M1, M2, M45, M46, M47, and M48 are turned off. In the second period S42 of the first mode (S mode), the data voltage Vdata of the pixel data is applied to the fifth node n45.

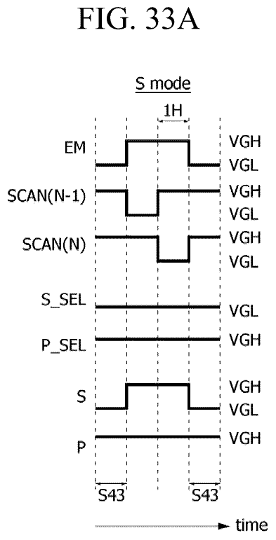

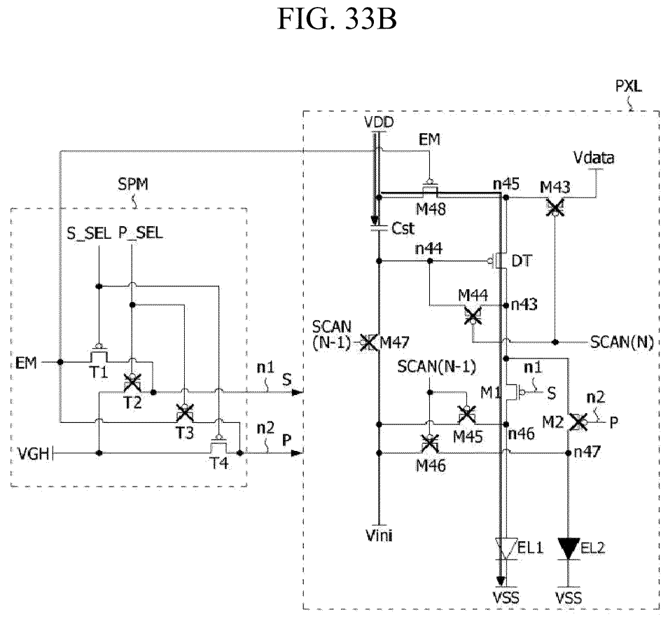

FIGS. 33A and 33B are a waveform and a circuit diagram, respectively, illustrating the light emission stage of the pixel circuit in the first mode (S mode). In the first mode (S mode), the light emission stage of the pixel circuit is performed during third periods S43. In the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate-off voltage VGH.

Referring to FIGS. 33A and 33B, during the third periods S43 of the first mode (S mode), the voltages of the scan signals SCAN(N−1) and SCAN(N) are the gate-off voltage VGH, and the voltage of the EM signal EM is the gate-on voltage VGL. During the third period S43 of the first mode (S mode), the first and eighth switch elements M1 and M48 of the pixel circuit PXL are turned on, while the other switch elements M2, M43, M44, M45, M46, and M47 are turned off.

During the third periods S43 of the first mode (S mode), a current generated according to the gate-to-source voltage of the driving element DT is supplied to the first light-emitting element EL1 through the first switch element M1. Therefore, during the third period S43 of the first mode (S mode), the first light-emitting element EL1 can be lit. During the third periods S43 of the first mode (S mode), the second light-emitting element EL2 is the off state.

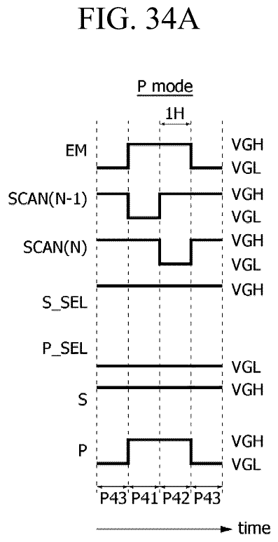

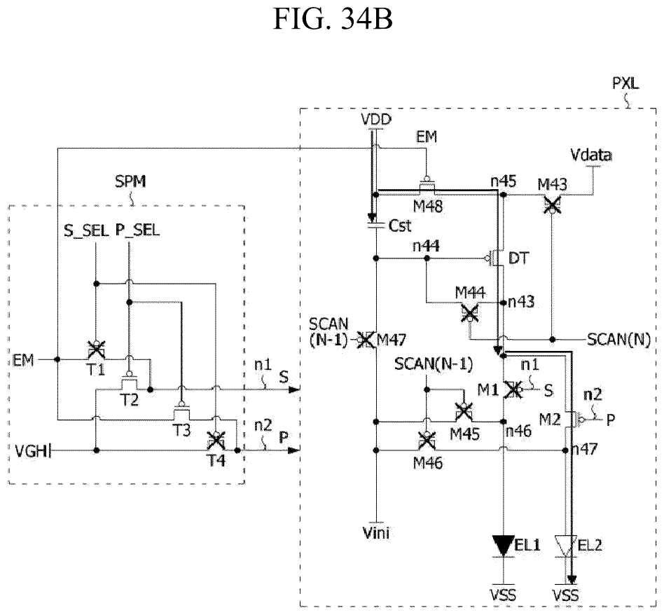

In the second mode (P mode), the method of internal compensation before light emission of the pixel circuit can be the same method as in the first mode (S mode). In the second mode (P mode), as shown in FIG. 34A, the pixel circuit can be driven in an initialization stage P41 and a data writing and threshold voltage sampling stage P42, before emitting light. In a light emission stage P43 of the second mode (P mode), the second light-emitting element EL2 is emitted.

FIGS. 34A and 34B are a waveform and a circuit diagram, respectively, illustrating the light emission stage of the pixel circuit in the second mode (P mode). In the second mode (P mode), the light emission stage of the pixel circuit is performed during third periods P43. In the second mode (P mode), the first and fourth mode switch elements T1 and T4 are turned off, while the second and third mode switch elements T2 and T3 are turned on. As a result, in the second mode (P mode), the voltage of the EM signal EM is transmitted to the second node n2, while the first node n1 is held at the gate-off voltage VGH.

Referring to FIGS. 34A and 34B, during the third period P43 of the second mode (P mode), the voltages of the scan signals SCAN(N−1) and SCAN(N) are the gate-off voltage VGH, and the voltage of the EM signal EM is the gate-on voltage VGL. During the third period P43 of the second mode (P mode), the second and eighth switch elements M2 and M48 of the pixel circuit PXL are turned on, while the other switch elements M1, M43, M44, M45, M46, and M47 are turned off.

During the third period P43 of the second mode (P mode), a current generated according to the gate-to-source voltage of the driving element DT is supplied to the second light-emitting element EL2 through the second switch element M2. Therefore, during the third period P43 of the second mode (P mode), the second light-emitting element EL2 can be lit. During the third period P43 of the second mode (P mode), the first light-emitting element EL1 is in the off state.

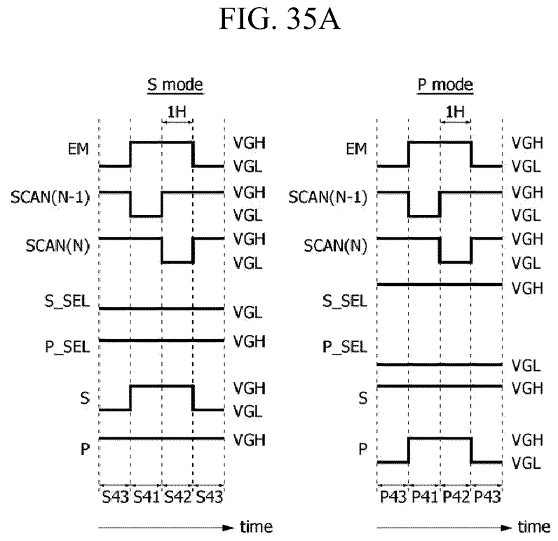

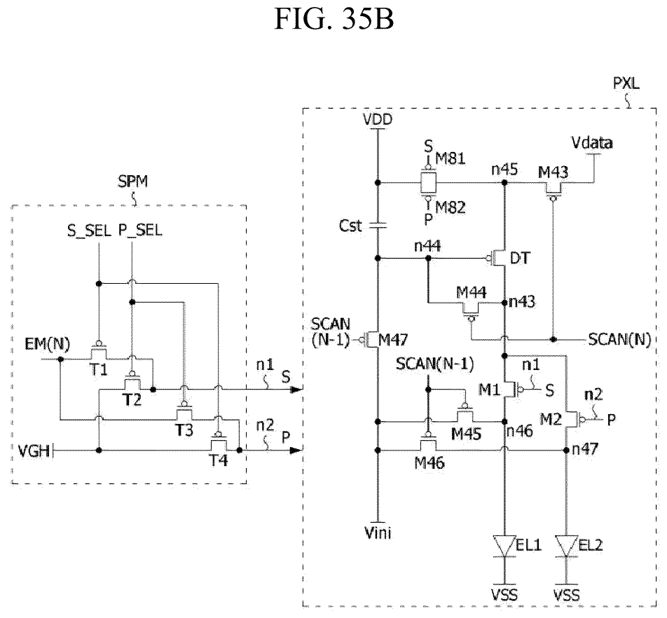

FIGS. 35A and 35B are diagrams illustrating a pixel circuit and a mode selection circuit, and signals applied to these circuits, according to another embodiment of the present disclosure. The pixel circuit and the mode selection circuit according to this embodiment are driven in an initialization stages S41, P41, a data writing and threshold voltage sampling stage S42, P42, and a light emission stage S43, P43 in each of the first and second modes (S mode and P mode), similar to the pixel circuits shown in FIGS. 31A to 34B. In the pixel circuit and the mode selection circuit according to this embodiment, the components that are substantially the same as those of the embodiment shown in FIGS. 31A to 34B are designated by the same reference numerals and are not described in detail.

Referring to FIG. 35A and FIG. 35B, the pixel circuit includes eighth-first and eighth-second switch elements M81 and M82 connected between the VDD node and the fifth node n45.

The eighth-first switch element M81 is turned on in response to the gate-on voltage VGL of the first mode signal S to apply the pixel driving voltage VDD to the fifth node n45. The eighth-first switch element M81 includes a first electrode connected to the VDD node to which the pixel driving voltage VDD is applied, a gate electrode connected to the first node n1 to which the first mode signal S is applied, and a second electrode connected to the fifth node n45.

The eighth-second switch element M82 is turned on in response to the gate-on voltage VGL of the second mode signal P to apply the pixel driving voltage VDD to the fifth node n45. The eighth-second switch element M82 includes a first electrode connected to the VDD node to which the pixel driving voltage VDD is applied, a gate electrode connected to the second node n2 to which the second mode signal P is applied, and a second electrode connected to the fifth node n45.

In the first mode (S mode), the EM signal EM at the first node n1 is delivered as the first mode signal S to the gate electrode of the eighth-first switch element M81, and the second node n2 is held at the gate-off voltage VGH. In the second mode (P mode), the EM signal EM at the second node n2 is transmitted as the second mode signal P to the gate electrode of the eighth-second switch element M82, and the first node n1 is held at the gate-off voltage VGH. Therefore, the eighth-first and eighth-second switch elements M81 and M82 can form a current path between the VDD node and the driving element DT in the light emission stages S43 and P43 in response to the gate-on voltage VGL of the EM signal EM.

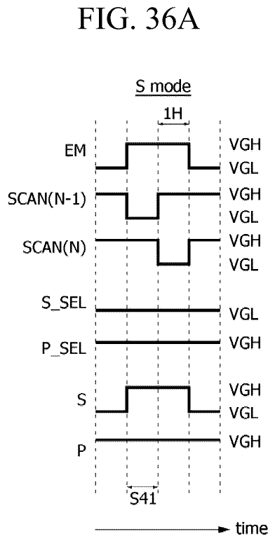

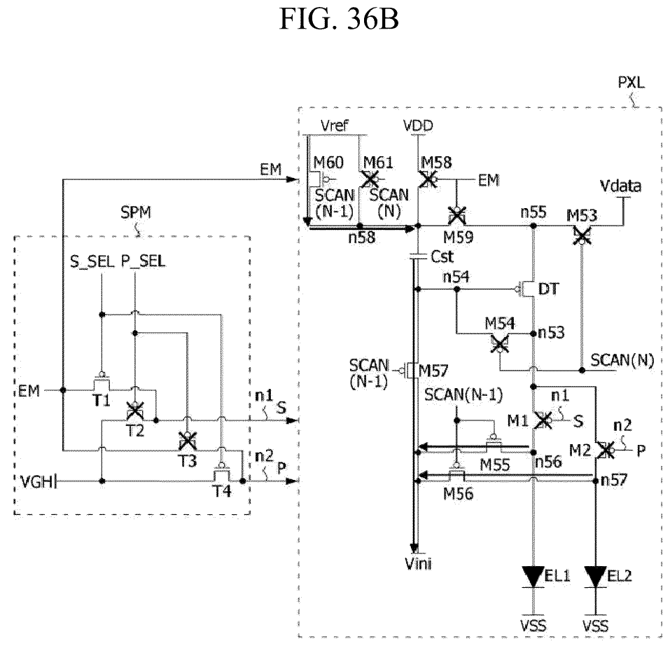

FIGS. 36A to 39B are diagrams illustrating the operation of a pixel circuit and a mode selection circuit in stages according to another embodiment of the present disclosure. The gate signals SCAN(N−1), SCAN(N), and EM and the mode selection signals S_SEL and P_SEL input to the pixel circuit and the mode selection circuit are substantially the same as the signals shown in FIGS. 31Ato 35B.

Referring to FIGS. 36A to 39B, the pixel circuit includes a first light-emitting element EL1, a second light-emitting element EL2, a driving element DT, a capacitor Cst, and a plurality of switch elements M1, M2, M53 to M61. The driving element DT and the switch elements M1, M2, M53 to M61 can be implemented as, but not limited to, p-channel transistors.

A first light-emitting element EL1 includes an anode electrode connected to a sixth electrode n56, and a cathode electrode to which the cathode voltage VSS is applied. A second light-emitting element EL2 includes an anode electrode connected to a seventh node n57, and a cathode electrode to which the cathode voltage VSS is applied. The first light-emitting element EL1 can be driven by a current from the driving element DT to emit light in the first mode (S mode). The second light-emitting element EL2 can be driven by a current from the driving element DT to emit light in the second mode (P mode).

The driving element DT includes a first electrode connected to a fifth node n55, a second electrode connected to a third node n53, and a gate electrode connected to a fourth node n54. The driving element DT generates a current according to the gate-to-source voltage so that the first light-emitting element EL1 is driven in the first mode (S mode) and the second light-emitting element EL2 is driven in the second mode (P mode). The capacitor Cst is connected between the fourth node n54 and an eighth node n58.

A first switch element M1 is connected between the third node n53 and the sixth node n56, and is turned on in response to the gate-on voltage VGL of the first mode signal S applied through a first node n1. When the first switch element M1 is turned on, the third node n53 can be electrically connected to the sixth node n56. The first switch element M1 includes a first electrode connected to the third node n53, a gate electrode connected to the first node n1 to which the first mode signal S is applied, and a second electrode connected to the sixth node n56.

A second switch element M2 is connected between the third node n53 and the seventh node n57, and is turned on in response to the gate-on voltage VGL of the second mode signal P applied through a second node n2. When the second switch element M2 is turned on, the third node n53 can be electrically connected to the seventh node n57. The second switch element M2 includes a first electrode connected to the third node n53, a gate electrode connected to the second node n2 to which the second mode signal P is applied, and a second electrode connected to the seventh node n57.

A third switch element M53 is connected between the data line to which the data voltage Vdata of pixel data is applied and the fifth node n55, and is turned on in response to a gate-on voltage VGL of an Nth scan signal SCAN(N). When the third switch element M53 is turned on, the data voltage Vdata can be applied to the fifth node n55. The third switch element M53 includes a first electrode to which the data voltage Vdata is applied, a gate electrode to which the N^{th} scan signal SCAN(N) is applied, and a second electrode connected to the fifth node n55.

A fourth switch element M54 is connected between the third node n53 and the fourth node n54, and is turned on in response to the gate-on voltage VGL of the Nth scan signal SCAN(N). When the fourth switch element M54 is turned on, the third node n53 can be electrically connected to the fourth node n54. The fourth switch element M54 includes a first electrode connected to the third node n53, a gate electrode to which the Nth scan signal SCAN(N) is applied, and a second electrode connected to the fourth node n54.

A fifth switch element M55 is connected between the INI node to which the initialization voltage Vini is applied and the sixth node n56, and is turned on in response to the gate-on voltage VGL of an (N−1)^{th} scan signal SCAN(N−1). When the fifth switch element M55 is turned on, the sixth node n56 can be initialized to the initialization voltage Vini. The fifth switch element M55 includes a first electrode to which the initialization voltage Vini is applied, a gate electrode to which the (N−1)^{th} can signal SCAN(N−1) is applied, and a second electrode connected to the sixth node n56.

A sixth switch element M56 is connected between the INI node to which the initialization voltage Vini is applied and the seventh node n57, and is turned on in response to the gate-on voltage VGL of the (N−1)^{th} scan signal SCAN(N−1). When the sixth switch element M56 is turned on, the seventh node n57 can be initialized to the initialization voltage Vini. The sixth switch element M56 includes a first electrode to which the initialization voltage Vini is applied, a gate electrode to which the (N−1)th scan signal SCAN(N−1) is applied, and a second electrode connected to the seventh node n57.

A seventh switch element M57 is connected between the INI node to which the initialization voltage Vini is applied and the fourth node n54, and is turned on in response to the gate-on voltage VGL of the (N−1)^{th} scan signal SCAN(N−1). When the seventh pixel switch element M57 is turned on, the capacitor Cst can be initialized. The seventh switch element M57 includes a first electrode to which the initialization voltage Vini is applied, a gate electrode to which the (N−1)th scan signal SCAN(N−1) is applied, and a second electrode connected to the fourth node n54.

An eighth switch element M58 is connected between the VDD node to which the pixel driving voltage is applied and the eighth node n58, and is turned on in response to the gate-on voltage VGL of the EM signal EM. When the eighth switch element M58 is turned on, the VDD node can be electrically connected to the eighth node n58. The eighth switch element M58 includes a first electrode connected to the VDD node to which the pixel driving voltage VDD is applied, a gate electrode to which the EM signal EM is applied, and a second electrode connected to the eighth node n58.

A ninth switch element M59 is connected between the fifth node n55 and the eighth node n58, and is turned on in response to the gate-on voltage VGL of the EM signal EM. When the ninth switch element M59 is turned on, the fifth node n55 can be electrically connected to the eighth node n58. The ninth switch element M59 includes a first electrode connected to the fifth node n55, a gate electrode to which the EM signal EM is applied, and a second electrode connected to the eighth node n58.

A tenth switch element M60 is connected between the REF node to which the reference voltage Vref is applied and the eighth node n58, and is turned on in response to the gate-on voltage VGL of the (N−1)^{th} scan signal SCAN(N−1). When the tenth switch element M60 is turned on, the reference voltage Vref is applied to the eighth node n58. The tenth pixel switch element M60 includes a first electrode connected to the REF node to which the reference voltage Vref is applied, a gate electrode to which the (N−1)th scan signal SCAN(N−1) is applied, and a second electrode connected to the eighth node n58.

An eleventh switch element M61 is connected between the REF node to which the reference voltage Vref is applied and the eighth node n58, and is turned on in response to the gate-on voltage VGL of the Nth scan signal SCAN(N). When the eleventh switch element M61 is turned on, the reference voltage Vref is applied to the eighth node n58. The eleventh switch element M61 includes a first electrode connected to the REF node to which the reference voltage Vref is applied, a gate electrode to which the Nth scan signal SCAN(N) is applied, and a second electrode connected to the eighth node n58.

The mode selection circuit SPM includes a first mode switch element T1, a second mode switch element T2, a third mode switch element T3, and a fourth mode switch element T4. The mode switch elements T1, T2 to T3, and T4 can be implemented as, but are not limited to, p-channel transistors.

When the first mode switch element T1 is turned on, the EM signal EM is applied to the first node n1 as the first mode signal S. The first mode switch element T1 includes a first electrode to which the EM signal EM is applied, a gate electrode to which the first mode selection signal S_SEL is applied, and a second electrode connected to the first node n1.

When the second mode switch element T2 is turned on, the gate-off voltage VGH is applied to the first node n1. The second mode switch element T2 includes a first electrode to which the gate-off voltage VGH is applied, a gate electrode to which the second mode selection signal P_SEL is applied, and a second electrode connected to the first node n1.

When the third mode switch element T3 is turned on, the EM signal EM is applied to the second node n2 as the second mode signal S. The third mode switch element T3 includes a first electrode to which the EM signal EM is applied, a gate electrode to which the second mode selection signal P_SEL is applied, and a second electrode connected to the second node n2.

When the fourth mode switch element T4 is turned on, the gate-off voltage VGH is applied to the second node n2. The fourth mode switch element T4 includes a first electrode to which the gate-off voltage VGH is applied, a gate electrode to which the first mode selection signal S_SEL is applied, and a second electrode connected to the second node n2.

The pixel circuit can be driven in an initialization stage, a data writing and threshold voltage sampling stage, and a light emission stage. FIGS. 36Ato 38B are diagrams illustrating an initialization stage, a data writing and threshold voltage sampling stage, and a light emission stage of the pixel circuit in stages in the first mode (S mode). In the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate-off voltage VGH.

FIGS. 36A and 36B are a waveform and a circuit diagram, respectively, illustrating the initialization stage of the pixel circuit in the first mode (S mode). In the first mode (S mode), the initialization stage of the pixel circuit is performed during the first period S41.

Referring to FIGS. 36A and 36B, during the first period S41 of the first mode (S mode), the voltage of the (N−1)^{th} scan signal SCAN(N−1) is the gate-on voltage VGL, and the voltage of the Nth scan signal SCAN(N) and the EM signal EM is the gate-off voltage VGH.

During the first period S41 of the first mode (S mode), the fifth, sixth, seventh, and tenth switch elements M55, M56, M57, and M60 of the pixel circuit PXL are turned on, and the other switch elements M1, M2, M53, M54, M58, M59, and M61 are turned off. In the first period S41 of the first mode (S mode), the driving element DT is turned on. In the first period S41 of the first mode (S mode), the initialization voltage Vini is applied to the fifth and sixth nodes n55 and n56 and the reference voltage Vref is applied to the eighth node n58. At the end of the first period S41 of the first mode (S mode), the capacitor Cst and the light-emitting elements EL1 and EL2 are initialized. During the first period S41 of the first mode (S mode), the light-emitting elements EL1 and EL2 are in the off state.

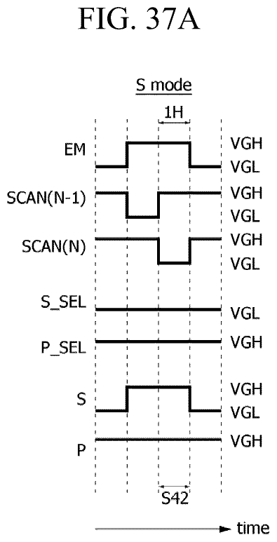

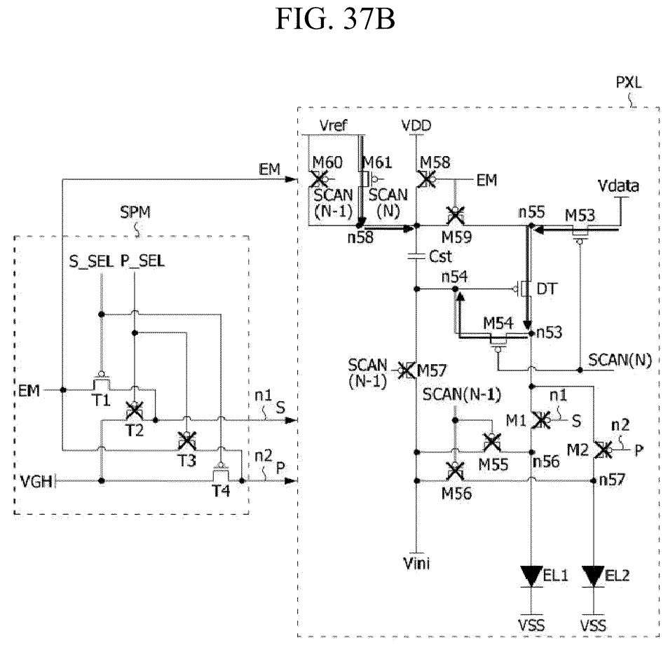

FIGS. 37A and 37B are a waveform and a circuit diagram, respectively, illustrating the data writing and threshold voltage sampling stage of the pixel circuit in the first mode (S mode). In the first mode (S mode), the data writing and threshold voltage sampling stage of the pixel circuit is performed during the second period S42. In the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate-off voltage VGH.

Referring to FIGS. 37A and 37B, during the second period S42 of the first mode (S mode), the voltage of the Nth scan signal SCAN(N) is the gate-on voltage VGL, and the voltages of the (N−1)th scan signal SCAN(N−1) and the EM signal EM are the gate-off voltage VGH. During the second period S42 of the first mode (S mode), the third, fourth, and eleventh switch elements M53, M54, and M61 of the pixel circuit PXL are turned on, and the other switch elements M1, M2, M55, M56, M57, M58, M59, and M60 are turned off. In the second period S42 of the first mode (S mode), the data voltage Vdata of the pixel data is applied to the fifth node n55. In the second period S42 of the first mode (S mode), the reference voltage Vref is applied to the eighth node n58.

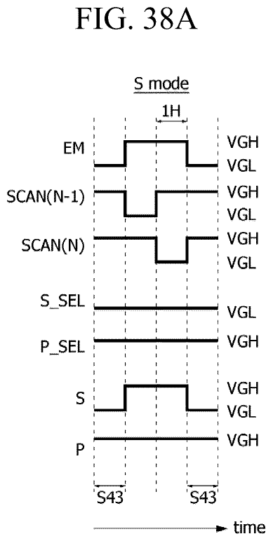

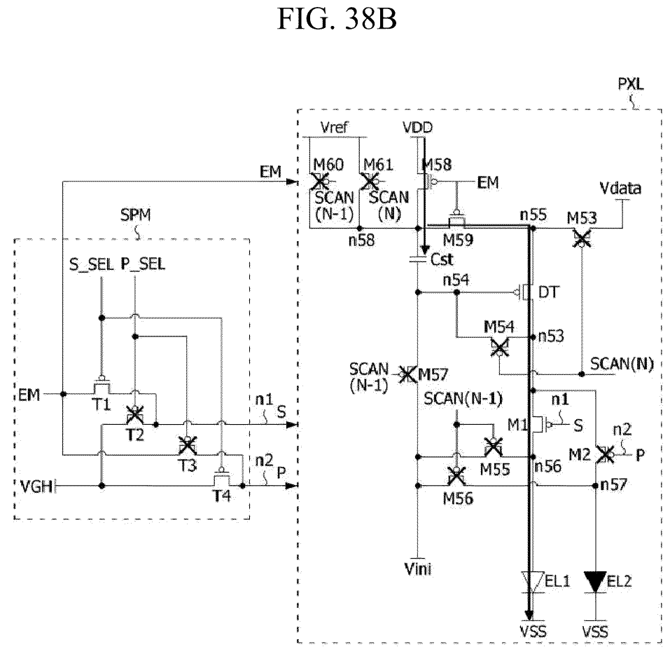

FIGS. 38A and 38B are a waveform and a circuit diagram, respectively, illustrating the light emission stage of the pixel circuit in the first mode (S mode). In the first mode (S mode), the light emission stage of the pixel circuit is performed during the third periods S43. In the first mode (S mode), the first and fourth mode switch elements T1 and T4 are turned on, while the second and third mode switch elements T2 and T3 are turned off. As a result, in the first mode (S mode), the voltage of the EM signal EM is transmitted to the first node n1, while the second node n2 is held at the gate-off voltage VGH.

Referring to FIGS. 38A and 38B, during the third periods S43 of the first mode (S mode), the voltages of the scan signals SCAN(N−1) and SCAN(N) are the gate-off voltage VGH, and the voltage of the EM signal EM is the gate-on voltage VGL. During the third period S43 of the first mode (S mode), the first, eighth, and ninth switch elements M1, M58, and M59 of the pixel circuit PXL are turned on, while the other switch elements M2, M53, M54, M55, M56, M57, M60, and M61 are turned off.

During the third periods S43 of the first mode (S mode), a current generated according to the gate-to-source voltage of the driving element DT is supplied to the first light-emitting element EL1 through the first switch element M1. Therefore, during the third period S43 of the first mode (S mode), the first light-emitting element EL1 can be lit. During the third periods S43 of the first mode (S mode), the second light-emitting element EL2 is the off state.

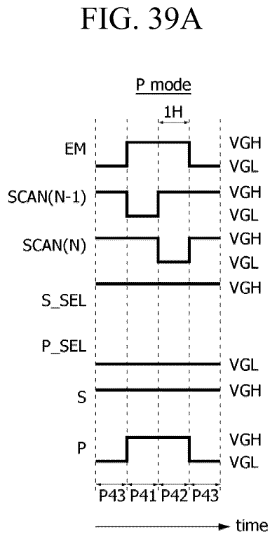

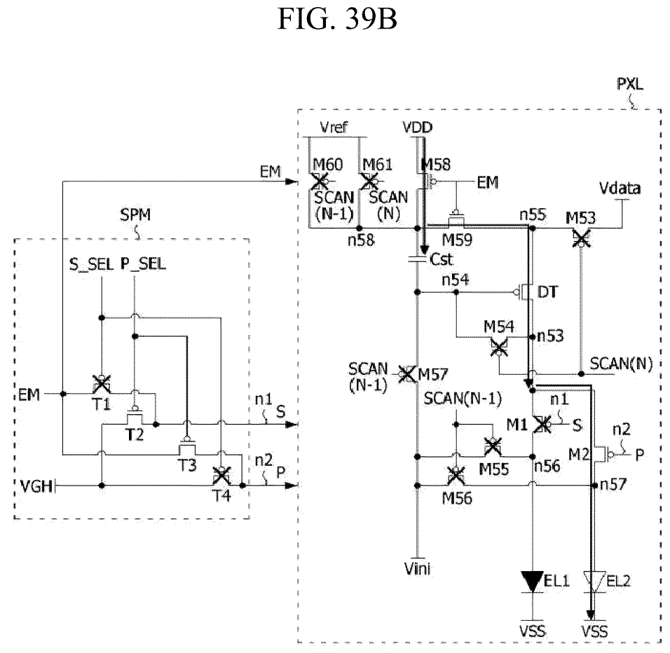

In the second mode (P mode), the method of internal compensation before light emission of the pixel circuit can be the same method as in the first mode (S mode). In the second mode (P mode), as shown in FIG. 39A, the pixel circuit can be driven in the initialization stage P41 and the data writing and threshold voltage sampling stage P42, before emitting light. In the light emission stage P43 of the second mode (P mode), the second light-emitting element EL2 is emitted.

FIGS. 39A and 39B are a waveform and a circuit diagram, respectively, illustrating the light emission stage of the pixel circuit in the second mode (P mode). In the second mode (P mode), the light emission stage of the pixel circuit is performed during the third periods P43. In the second mode (P mode), the first and fourth mode switch elements T1 and T4 are turned off, while the second and third mode switch elements T2 and T3 are turned on. As a result, in the second mode (P mode), the voltage of the EM signal EM is transmitted to the second node n2, while the first node n1 is held at the gate-off voltage VGH.

Referring to FIGS. 39A and 39B, during the third period P43 of the second mode (P mode), the voltages of the scan signals SCAN(N−1) and SCAN(N) are the gate-off voltage VGH, and the voltage of the EM signal EM is the gate-on voltage VGL. During the third period P43 of the second mode (P mode), the second, eighth, and ninth switch elements M2, M58, and M59 of the pixel circuit PXL are turned on, while the other switch elements M1, M53, M54, M55, M56, M57, M60, and M61 are turned off.

During the third period P43 of the second mode (P mode), a current generated according to the gate-to-source voltage of the driving element DT is supplied to the second light-emitting element EL2 through the second switch element M2. Therefore, during the third period P43 of the second mode (P mode), the second light-emitting element EL2 can be lit. During the third period P43 of the second mode (P mode), the first light-emitting element EL1 is in the off state.

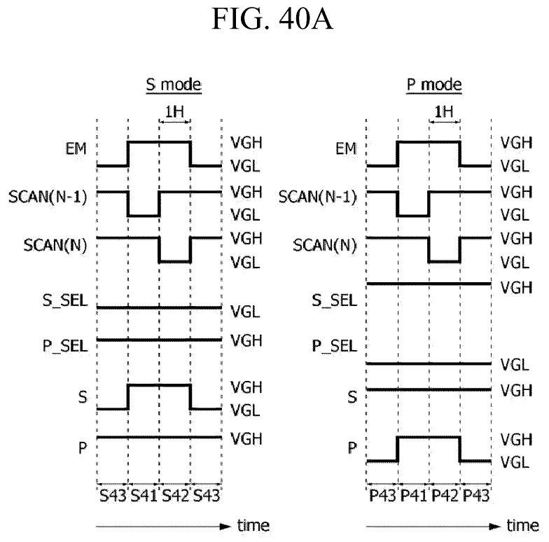

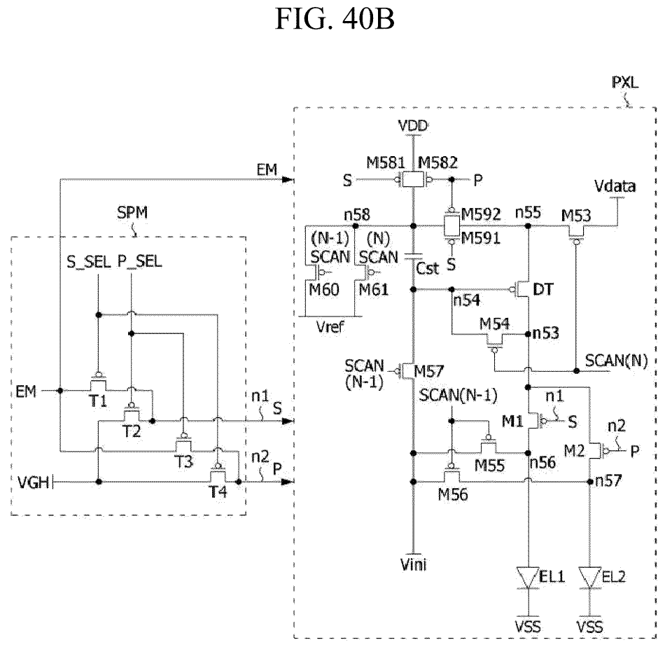

FIGS. 40A and 40B are diagrams illustrating a pixel circuit and a mode selection circuit, and signals applied to these circuits, according to another embodiment of the present disclosure. The pixel circuit and the mode selection circuit according to this embodiment are driven in an initialization stage S41, P41, a data writing and threshold voltage sampling stage S42, P42, and a light emission stage S43, P43 in each of the first and second modes (S mode and P mode), similar to the pixel circuits shown in FIGS. 36A to 39B. In the pixel circuit and the mode selection circuit according to this embodiment, the components that are substantially the same as those of the embodiment shown in FIGS. 36A to 39B are designated by the same reference numerals and are not described in detail.

Referring to FIGS. 40A and 40B, the pixel circuit includes eighth-first and eighth-second switch elements M581 and M582 connected between the VDD node and the eighth node n58, and ninth-first and ninth-second switch elements M591 and M592 connected between the fifth node n55 and the eighth node n58.

The eighth-first switch element M581 is turned on in response to the gate-on voltage VGL of the first mode signal S to apply the pixel driving voltage VDD to the eighth node n58. The eighth-first switch element M581 includes a first electrode connected to the VDD node to which the pixel driving voltage VDD is applied, a gate electrode connected to the first node n1 to which the first mode signal S is applied, and a second electrode connected to the eighth node n58.

The eighth-second switch element M582 is turned on in response to the gate-on voltage VGL of the second mode signal P to apply the pixel driving voltage VDD to the eighth node n58. The eighth-second switch element M582 includes a first electrode connected to the VDD node to which the pixel driving voltage VDD is applied, a gate electrode connected to the second node n2 to which the second mode signal P is applied, and a second electrode connected to the eighth node n58.

The ninth-first switch element M591 is turned on in response to the gate-on voltage VGL of the first mode signal S to electrically connect the fifth node n55 to the eighth node n58. The ninth-first switch element M591 includes a first electrode connected to the fifth node n55, a gate electrode connected to the first node n1 to which the first mode signal S is applied, and a second electrode connected to the eighth node n58.

The ninth-second switch element M592 is turned on in response to the gate-on voltage VGL of the second mode signal P to electrically connect the fifth voltage node n55 to the fourth node n58. The ninth-second switch element M592 includes a first electrode connected to the fifth node n55, a gate electrode connected to the second node n2 to which the second mode signal P is applied, and a second electrode connected to the eighth node n58.

In the first mode (S mode), the EM signal EM at the first node n1 is applied as a first mode signal S to the gate electrodes of the eighth-first and ninth-first switch elements M581 and M591, and the second node n2 is held at the gate-off voltage VGH. In the second mode (P mode), the EM signal EM at the second node n2 is transmitted as a second mode signal P to the gate electrodes of the eighth-second and ninth-second switch elements M582 and M592, and the first node n1 is held at the gate-off voltage VGH. Accordingly, the eighth-first to ninth-second switch elements M581, M582, M591, and M592 can form a current path between the VDD node and the driving element DT in the light emission stages S43 and P43 in response to the gate-on voltage VGL of the EM signal EM.

According to one or more embodiments of the present disclosure, the display device can be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the present disclosure can be applied to organic light emitting lighting devices or inorganic light emitting lighting devices.

The objects to be achieved by the present disclosure, the means for achieving the objects, and effects of the present disclosure described above do not specify essential features of the claims, and thus, the scope of the claims is not limited to the detailed description of the present disclosure.

Although the embodiments of the present disclosure have been described in more detail with reference to the accompanying drawings, the present disclosure is not limited thereto and can be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A display panel comprising:
a mode selection circuit configured to output an emission signal to a first node in response to a first mode selection signal, and output the emission signal to a second node in response to a second mode selection signal; and
a pixel circuit configured to drive a first light-emitting element in response to a voltage of the first node in a first mode, and drive a second light-emitting element in response to a voltage of the second node in a second mode.

2. The display panel of claim 1, wherein the pixel circuit includes:
a driving element including a first electrode to which a pixel driving voltage is applied, a gate electrode to which a data voltage of pixel data is applied, and a second electrode connected to a third node;
a first switch element including a first electrode connected to the third node, a gate electrode electrically connected to the first node, and a second electrode electrically connected to an anode electrode of the first light-emitting element; and
a second switch element including a first electrode connected to the third node, a gate electrode electrically connected to the second node, and a second electrode connected to an anode electrode of the second light-emitting element.

3. The display panel of claim 2, wherein the emission signal swings between a gate-on voltage and a gate-off voltage,
wherein each of the first switch element and the second switch element is turned on in response to the gate-on voltage and turned off in response to the gate-off voltage, and
wherein the mode selection circuit includes:
a first mode switch element including a first electrode to which the emission signal is applied, a gate electrode to which the first mode selection signal is applied, and a second electrode electrically connected to the first node;
a second mode switch element including a first electrode to which a separate gate-off voltage is applied, a gate electrode to which the second mode selection signal is applied, and a second electrode electrically connected to the first node;
a third mode switch element including a first electrode to which the emission signal is applied, a gate electrode to which the second mode selection signal is applied, and a second electrode electrically connected to the second node; and
a fourth mode switch element including a first electrode to which the separate gate-off voltage is applied, a gate electrode to which the first mode selection signal is applied, and a second electrode electrically connected to the second node.

4. The display panel of claim 2, wherein the pixel circuit further includes:
a capacitor connected between a fourth node and a fifth node;
a third switch element including a first electrode to which the data voltage is applied, a gate electrode to which a first scan signal is applied, and a second electrode electrically connected to the fifth node;
a fourth switch element including a first electrode electrically connected to the third node, a gate electrode to which a second scan signal is applied, and a second electrode connected to the fourth node;
a fifth switch element including a first electrode electrically connected to a sixth node to which a reference voltage is applied, a gate electrode to which the second scan signal is applied, and a second electrode connected to a seventh node;
a sixth switch element including a first electrode connected to the sixth node, a gate electrode to which the second scan signal is applied, and a second electrode electrically connected to an eighth node; and
a seventh switch element including a first electrode connected to the fifth node, a gate electrode to which the emission signal is applied, and a second electrode connected to the sixth node,
wherein a gate electrode of the driving element is electrically connected to the fourth node,
wherein the first light-emitting element includes an anode electrode connected to the seventh node and a cathode electrode to which a cathode voltage is applied, and
wherein the second light-emitting element includes an anode electrode connected to the eighth node and a cathode electrode to which the cathode voltage is applied.

5. The display panel of claim 4, wherein:
the emission signal swings between a gate-on voltage and a gate-off voltage,
each of the first switch element, the second switch element, the third switch element, the fourth switch element, the fifth switch element, the sixth switch element, and the seventh switch element is turned on in response to the gate-on voltage and turned off in response to the gate-off voltage,
a voltage of the first scan signal in each of the first mode and the second mode is the gate-off voltage during a first period, the gate-on voltage during a second period after the first period, and the gate-off voltage during a third period after the second period,
a voltage of the second scan signal in each of the first mode and the second mode is the gate-on voltage during the first period and the second period, and the gate-off voltage during the third period,
a voltage of the emission signal in each of the first mode and the second mode is the gate-on voltage during the first period, the gate-off voltage during the second period, and the gate-on voltage during the third period,
a voltage of the first mode selection signal is the gate-on voltage in the first period, the second period, and the third period of the first mode, and the gate-off voltage in the first period, the second period, and the third period of the second mode,
a voltage of the second mode selection signal is the gate-on voltage in the first period, the second period, and the third period of the second mode, and the gate-off voltage in the first period, the second period, and the third period of the first mode,
in the first mode, a voltage of the first mode signal applied to the first node is the voltage of the emission signal, and a voltage of the second mode signal applied to the second node is the gate-off voltage, and
in the second mode, a voltage of the first mode signal applied to the first node is the gate-off voltage, and a voltage of the second mode signal applied to the second node is the voltage of the emission signal.

6. The display panel of claim 2, wherein the pixel circuit further includes:
a capacitor connected between a fourth node and a fifth node;
a third switch element including a first electrode to which the data voltage is applied, a gate electrode to which a first scan signal is applied, and a second electrode electrically connected to the fifth node;
a fourth switch element including a first electrode electrically connected to the third node, a gate electrode to which a second scan signal is applied, and a second electrode connected to the fourth node;
a fifth switch element including a first electrode electrically connected to a sixth node to which a reference voltage is applied, a gate electrode to which the second scan signal is applied, and a second electrode connected to a seventh node;
a sixth switch element including a first electrode connected to the sixth node, a gate electrode to which the second scan signal is applied, and a second electrode electrically connected to an eighth node;
a seventh-first switch element including a first electrode connected to the fifth node, a gate electrode connected to the first node, and a second electrode connected to the sixth node; and
a seventh-second switch element including a first electrode connected to the fifth node, a gate electrode connected to the second node, and a second electrode connected to the sixth node,
wherein a gate electrode of the driving element is electrically connected to the fourth node,
wherein the first light-emitting element includes an anode electrode connected to the seventh node and a cathode electrode to which a cathode voltage is applied, and
wherein the second light-emitting element includes an anode electrode connected to the eighth node and a cathode electrode to which the cathode voltage is applied.

7. The display panel of claim 6, wherein:
the emission signal swings between a gate-on voltage and a gate-off voltage,
each of the first switch element, the second switch element, the third switch element, the fourth switch element, the fifth switch element, the sixth switch element, the seventh-first switch element, and the seventh-second switch element is turned on in response to the gate-on voltage, and is turned off in response to the gate-off voltage,
a voltage of the first scan signal in each of the first mode and the second mode is the gate-off voltage during a first period, the gate-on voltage during a second period after the first period, and the gate-off voltage during a third period after the second period,
a voltage of the second scan signal in each of the first mode and the second mode is the gate-on voltage during the first period and the second period, and the gate-off voltage during the third period,
a voltage of the emission signal in each of the first mode and the second mode is the gate-on voltage during the first period, the gate-off voltage during the second period, and the gate-on voltage during the third period,
a voltage of the first mode selection signal is the gate-on voltage in the first period, the second period, and the third period of the first mode, and the gate-off voltage in the first period, the second period, and the third period of the second mode,
a voltage of the second mode selection signal is the gate-on voltage in the first period, the second period, and the third period of the second mode, and is the gate-off voltage in the first period, the second period, and the third period of the first mode,
in the first mode, a voltage of the first mode signal applied to the first node is the voltage of the emission signal, and a voltage of the second mode signal applied to the second node is the gate-off voltage, and
in the second mode, the voltage of the first mode signal applied to the first node is the gate-off voltage, and the voltage of the second mode signal applied to the second node is the voltage of the emission signal.

8. The display panel of claim 2, wherein the mode selection circuit includes:
a first mode switch element including a first electrode to which the emission signal is applied, a gate electrode to which the first mode selection signal is applied, and a second electrode electrically connected to the first node;
a second mode switch element including a first electrode to which a gate high voltage is applied, a gate electrode to which the second mode selection signal is applied, and a second electrode electrically connected to the first node;
a third mode switch element including a first electrode to which the emission signal is applied, a gate electrode to which the second mode selection signal is applied, and a second electrode electrically connected to the second node; and
a fourth mode switch element including a first electrode to which the gate high voltage is applied, a gate electrode to which the first mode selection signal is applied, and a second electrode electrically connected to the second node,
wherein the emission signal swings between the gate high voltage and a gate low voltage,
wherein the first switch element is turned on in response to the gate low voltage applied to the first node and turned off in response to the gate high voltage applied to the first node, and
wherein the second switch element is turned on in response to the gate low voltage applied to the second node and turned off in response to the gate high voltage applied to the second node.

9. The display panel of claim 8, wherein the pixel circuit further includes:
a capacitor connected between a VDD node to which the pixel driving voltage is applied and a fourth node;
a third switch element including a first electrode to which the data voltage is applied, a gate electrode to which a second scan signal is applied, and a second electrode electrically connected to a fifth node;
a fourth switch element including a first electrode electrically connected to the third node, a gate electrode to which a first scan signal is applied, and a second electrode connected to the fourth node;
a fifth switch element including a first electrode connected to which a second compensation voltage is applied, a gate electrode to which a third scan signal is applied, and a second electrode connected to a sixth node;
a sixth switch element including a first electrode connected to which the second compensation voltage is applied, a gate electrode to which the third scan signal is applied, and a second electrode connected to a seventh node;
a seventh switch element including a first electrode connected to an INI node to which an initialization voltage is applied, a gate electrode to which a fourth scan signal is applied, and a second electrode connected to the fourth node;
an eighth switch element including a first electrode to which a first compensation voltage is applied, a gate electrode to which the third scan signal is applied, and a second electrode connected to the fifth node; and
a ninth switch element including a first electrode connected to the VDD node, a gate electrode to which the emission signal is applied, and a second electrode connected to the fifth node,
wherein a gate electrode of the driving element is electrically connected to the fourth node,
wherein the first light-emitting element includes an anode electrode connected to the sixth node and a cathode electrode to which a cathode voltage is applied,
wherein the second light-emitting element includes an anode electrode connected to the seventh node and a cathode electrode to which the cathode voltage is applied,
wherein each of the first mode switch element, the second mode switch element, the third mode switch element, the fourth mode switch element, the first switch element, the second switch element, the third switch element, the fifth switch element, the sixth switch element, the eighth switch element, and the ninth switch element is turned on in response to a gate low voltage applied to a corresponding gate electrode, and is turned off in response to a gate high voltage applied to the corresponding gate electrode, and
wherein each of the fourth switch element and the seventh switch element is turned on in response to a gate high voltage applied to a corresponding gate electrode and is turned off in response to a gate low voltage applied to the corresponding gate electrode.

10. The display panel of claim 8, wherein the pixel circuit further includes:
a capacitor connected between a VDD node to which the pixel driving voltage is applied and a fourth node;
a third switch element including a first electrode to which the data voltage is applied, a gate electrode to which a second scan signal is applied, and a second electrode electrically connected to a fifth node;
a fourth switch element including a first electrode electrically connected to the third node, a gate electrode to which a first scan signal is applied, and a second electrode connected to the fourth node;
a fifth switch element including a first electrode connected to which a second compensation voltage is applied, a gate electrode to which a third scan signal is applied, and a second electrode connected to a sixth node;
a sixth switch element including a first electrode connected to which the second compensation voltage is applied, a gate electrode to which the third scan signal is applied, and a second electrode connected to a seventh node;
a seventh switch element including a first electrode connected to an INI node to which an initialization voltage is applied, a gate electrode to which a fourth scan signal is applied, and a second electrode connected to the fourth node;
an eighth switch element including a first electrode to which a first compensation voltage is applied, a gate electrode to which the third scan signal is applied, and a second electrode connected to the fifth node;
a ninth-first switch element including a first electrode connected to the VDD node, a gate electrode connected to the first node, and a second electrode connected to the fifth node; and
a ninth-second switch element including a first electrode connected to the VDD node, a gate electrode connected to the second node, and a second electrode connected to the fifth node,
wherein a gate electrode of the driving element is electrically connected to the fourth node,
wherein the first light-emitting element includes an anode electrode connected to the sixth node and a cathode electrode to which a cathode voltage is applied,
wherein the second light-emitting element includes an anode electrode connected to the seventh node and a cathode electrode to which the cathode voltage is applied,
wherein each of the first mode switch element, the second mode switch element, the third mode switch element, the fourth mode switch element, the first switch element, the second switch element, the third switch element, the fifth switch element, the sixth switch element, the eighth switch element, the ninth-first switch element, and the ninth-second switch element is turned on in response to a gate low voltage applied to a corresponding gate electrode, and is turned off in response to a gate high voltage applied to the corresponding gate electrode, and
wherein each of the fourth switch element and the seventh switch element is turned on in response to a gate high voltage applied to a corresponding gate electrode and is turned off in response to a gate low voltage applied to the corresponding gate electrode.

11. The display panel of claim 9, wherein:
a voltage of the first scan signal in each of the first mode and the second mode is the gate low voltage during a first period, the gate high voltage during a second period after the first period, the gate high voltage during a third period after the second period, the gate low voltage during a fourth period after the third period, and the gate low voltage during a fifth period after the fourth period,
a voltage of the second scan signal in each of the first mode and the second mode is the gate high voltage during the first period, the second period, the fourth period, and the fifth period, and the gate low voltage during the third period,
a voltage of the third scan signal in each of the first mode and the second mode is the gate low voltage during the first period and the fourth period, and the gate high voltage during the second period, the third period and the fifth period,
a voltage of the fourth scan signal in each of the first mode and the second mode is the gate low voltage during the first period, the third period, the fourth period, and the fifth period, and the gate high voltage during the second period,
a voltage of the emission signal in each of the first mode and the second mode is the gate high voltage during the first period, the second period, the third period, and the fourth period, and the gate low voltage during the fifth period,
a voltage of the first mode selection signal is the gate low voltage during the first period, the second period, the third period, the fourth period, and the fifth period of the first mode, and the gate high voltage during the first period, the second period, the third period, the fourth period, and the fifth period of the second mode,
a voltage of the second mode selection signal is the gate low voltage during the first period, the second period, the third period, the fourth period, and the fifth period of the second mode, and the gate high voltage during the first period, the second period, the third period, the fourth period, and the fifth period of the first mode,
in the first mode, a voltage of the first mode signal applied to the first node is a voltage of the emission signal, and a voltage of the second mode signal applied to the second node is the gate high voltage, and
in the second mode, the voltage of the first mode signal applied to the first node is the gate high voltage, and the voltage of the second mode signal applied to the second node is the voltage of the emission signal.

12. The display panel of claim 3, wherein the pixel circuit further includes:
a capacitor connected between a VDD node to which the pixel driving voltage is applied and a fourth node;
a third switch element including a first electrode to which the data voltage is applied, a gate electrode to which an N^{th} scan signal is applied, and a second electrode electrically connected to a fifth node, where N is a natural number;
a fourth switch element including a first electrode electrically connected to the third node, a gate electrode to which the N^{th} scan signal is applied, and a second electrode connected to the fourth node;
a fifth switch element including a first electrode connected to an INI node to which an initialization voltage is applied, a gate electrode to which an (N−1)^{th} scan signal is applied, and a second electrode connected to a sixth node;
a sixth switch element including a first electrode connected to the INI node, a gate electrode to which the (N−1)^{th} scan signal is applied, and a second electrode electrically connected to a seventh node;
a seventh switch element including a first electrode connected to the INI node, a gate electrode to which the (N−1)^{th} scan signal is applied, and a second electrode connected to the fourth node; and
an eighth switch element including a first electrode connected to the VDD node, a gate electrode to which the emission signal is applied, and a second electrode connected to the fifth node,
wherein a gate electrode of the driving element is electrically connected to the fourth node,
wherein the first light-emitting element includes an anode electrode connected to the sixth node and a cathode electrode to which a cathode voltage is applied, and
wherein the second light-emitting element includes an anode electrode connected to the seventh node and a cathode electrode to which the cathode voltage is applied.

13. The display panel of claim 3, wherein the pixel circuit further includes:
a capacitor connected between a VDD node to which the pixel driving voltage is applied and a fourth node;
a third switch element including a first electrode to which the data voltage is applied, a gate electrode to which an Nth scan signal is applied, and a second electrode electrically connected to a fifth node, where N is a natural number;
a fourth switch element including a first electrode electrically connected to the third node, a gate electrode to which the N^{th} scan signal is applied, and a second electrode connected to the fourth node;
a fifth switch element including a first electrode connected to an INI node to which an initialization voltage is applied, a gate electrode to which an (N−1)^{th} scan signal is applied, and a second electrode connected to a sixth node;
a sixth switch element including a first electrode connected to the INI node, a gate electrode to which the (N−1)^{th} scan signal is applied, and a second electrode electrically connected to a seventh node;
a seventh switch element including a first electrode connected to the INT node, a gate electrode to which the (N−1)^{th} scan signal is applied, and a second electrode connected to the fourth node;
an eighth-first switch element including a first electrode connected to the VDD node, a gate electrode connected to the first node, and a second electrode connected to the fifth node; and
an eighth-second switch element including a first electrode connected to the VDD node, a gate electrode connected to the second node, and a second electrode connected to the fifth node,
wherein a gate electrode of the driving element is electrically connected to the fourth node,
wherein the first light-emitting element includes an anode electrode connected to the sixth node and a cathode electrode to which a cathode voltage is applied, and
wherein the second light-emitting element includes an anode electrode connected to the seventh node and a cathode electrode to which the cathode voltage is applied.

14. The display panel of claim 3, wherein the pixel circuit further includes:
a capacitor connected between a fourth node and an eighth node;
a third switch element including a first electrode to which the data voltage is applied, a gate electrode to which an N^{th} scan signal is applied, and a second electrode electrically connected to a fifth node, where N is a natural number;
a fourth switch element including a first electrode electrically connected to the third node, a gate electrode to which the N^{th} scan signal is applied, and a second electrode connected to the fourth node;
a fifth switch element including a first electrode connected to an INI node to which an initialization voltage is applied, a gate electrode to which an (N−1)th scan signal is applied, and a second electrode connected to a sixth node;
a sixth switch element including a first electrode connected to the INI node, a gate electrode to which the (N−1)^{th} scan signal is applied, and a second electrode electrically connected to a seventh node;
a seventh switch element including a first electrode connected to the INI node, a gate electrode to which the (N−1)^{th} scan signal is applied, and a second electrode connected to the fourth node;
an eighth switch element including a first electrode connected to a VDD node to which the pixel driving voltage is applied, a gate electrode to which the emission signal is applied, and a second electrode connected to the eighth node;
a ninth switch element including a first electrode connected to the fifth node, a gate electrode to which the emission signal is applied, and a second electrode connected to the eighth node;
a tenth switch element including a first electrode connected to an REF node to which a reference voltage is applied, a gate electrode to which the (N−1)^{th} scan signal is applied, and a second electrode connected to the eighth node; and
an eleventh switch element including a first electrode connected to the REF node, a gate electrode to which the N^{th} scan signal is applied, and a second electrode connected to the eighth node,
wherein a gate electrode of the driving element is electrically connected to the fourth node,
wherein the first light-emitting element includes an anode electrode connected to the sixth node and a cathode electrode to which a cathode voltage is applied, and
wherein the second light-emitting element includes an anode electrode connected to the seventh node and a cathode electrode to which the cathode voltage is applied.

15. The display panel of claim 3, wherein the pixel circuit further includes:
a capacitor connected between a fourth node and an eighth node;
a third switch element including a first electrode to which the data voltage is applied, a gate electrode to which an N^{th} scan signal is applied, and a second electrode electrically connected to a fifth node, where N is a natural number;
a fourth switch element including a first electrode electrically connected to the third node, a gate electrode to which the N^{th} scan signal is applied, and a second electrode connected to the fourth node;
a fifth switch element including a first electrode connected to an INI node to which an initialization voltage is applied, a gate electrode to which an (N−1)th scan signal is applied, and a second electrode connected to a sixth node;
a sixth switch element including a first electrode connected to the INI node, a gate electrode to which the (N−1)^{th} scan signal is applied, and a second electrode electrically connected to a seventh node;
a seventh switch element including a first electrode connected to the INI node, a gate electrode to which the (N−1)^{th} scan signal is applied, and a second electrode connected to the fourth node;
an eighth-first switch element including a first electrode connected to a VDD node to which a pixel driving voltage is applied, a gate electrode connected to the first node, and a second electrode connected to the eighth node;
an eighth-second switch element including a first electrode connected to the VDD node, a gate electrode connected to the second node, and a second electrode connected to the eighth node;
a ninth-first switch element including a first electrode connected to the fifth node, a gate electrode connected to the first node, and a second electrode connected to the eighth node;
a ninth-second switch element including a first electrode connected to the fifth node, a gate electrode connected to the second node, and a second electrode connected to the eighth node;
a tenth switch element including a first electrode connected to an REF node to which a reference voltage is applied, a gate electrode to which the (N−1)^{th} scan signal is applied, and a second electrode connected to the eighth node; and
an eleventh switch element including a first electrode connected to the REF node, a gate electrode to which the N^{th} scan signal is applied, and a second electrode connected to the eighth node,
wherein a gate electrode of the driving element is electrically connected to the fourth node,
wherein the first light-emitting element includes an anode electrode connected to the sixth node and a cathode electrode to which a cathode voltage is applied, and
wherein the second light-emitting element includes an anode electrode connected to the seventh node and a cathode electrode to which the cathode voltage is applied.

16. The display panel of claim 12, wherein
a voltage of the (N−1)^{th} scan signal is the gate-on voltage during a first period, the gate-off voltage during a second period after the first period, and the gate-off voltage during a third period after the second period, in each of the first mode and the second mode,
a voltage of the N^{th} scan signal is the gate-off voltage during the first period and the third period, and the gate-on voltage during the second period, in each of the first mode and the second mode,
a voltage of the light emission signal is the gate-off voltage during the first period and the second period and the gate-on voltage during the third period, in each of the first mode and the second mode,
a voltage of the first mode selection signal is the gate-on voltage during the first period, the second period, and the third period of the first mode, and the gate-off voltage during the first period, the second period, and the third period of the second mode,
a voltage of the second mode selection signal is the gate-off voltage during the first period, the second period, and the third period of the first mode, and the gate-on voltage during the first period, the second period, and the third period of the second mode,
in the first mode, a voltage of the first mode signal applied to the first node is the voltage of the emission signal, and a voltage of the second mode signal applied to the second node is the gate-off voltage, and
in the second mode, the voltage of the first mode signal applied to the first node is the gate-off voltage, and the voltage of the second mode signal applied to the second node is the voltage of the emission signal.

17. A display device comprising:
a display panel including data lines, gate lines, power lines, and pixel circuits;
a data driver configured to supply data voltages to the data lines;
a gate driver configured to receive a gate timing signal and supply a scan signal and an emission signal to the gate lines;
a level shifter configured to output a first mode selection signal, a second mode selection signal, and the gate timing signal; and
a mode selection circuit configured to output the emission signal to a first node in response to the first mode selection signal, and output the emission signal to a second node in response to the second mode selection signal,
wherein each of the sub-pixels configured to:
drive a first light-emitting element in response to a voltage of the first node in a first mode, and drive a second light-emitting element in response to a voltage of the second node in a second mode.

18. The display device of claim 17, wherein each of the sub-pixels includes:
a driving element including a first electrode to which a pixel driving voltage is applied, a gate electrode to which a data voltage of pixel data is applied, and a second electrode connected to a third node;
a first switch element including a first electrode connected to the third node, a gate electrode electrically connected to the first node, and a second electrode electrically connected to an anode electrode of the first light-emitting element; and
a second switch element including a first electrode connected to the third node, a gate electrode electrically connected to the second node, a second electrode connected to an anode electrode of the second light-emitting element.

19. The display device of claim 18, wherein:
the emission signal swings between a gate-on voltage and a gate-off voltage, and
each of the first switch element and the second switch element is turned on in response to the gate-on voltage and is turned off in response to the gate-off voltage.

20. The display device of claim 19, wherein the mode selection circuit includes:
a first mode switch element including a first electrode to which the emission signal is applied, a gate electrode to which the first mode selection signal is applied, and a second electrode electrically connected to the first node;
a second mode switch element including a first electrode to which a separate gate-off voltage is applied, a gate electrode to which the second mode selection signal is applied, and a second electrode electrically connected to the first node;
a third mode switch element including a first electrode to which the emission signal is applied, a gate electrode to which the second mode selection signal is applied, and a second electrode electrically connected to the second node; and
a fourth mode switch element including a first electrode to which the separate gate-off voltage is applied, a gate electrode to which the first mode selection signal is applied, and a second electrode electrically connected to the second node.
